(19) United States
(12) Patent Application Publication
(10) Pub. No.: US 2011/0035287 A1
(43) Pub. Date: Feb. 10, 2011

(54) Apparatus and method for providing media commerce platform

(76) Inventor: Barbara Ann Fox, Palm Beach Gardens, FL (US)

Correspondence Address: Barbara Ann Fox, 394 Isle Court, Palm Beach Gardens, FL, 33418, US

(21) Appl. No.: 12/804,486

(22) Filed: Jul. 22, 2010

Related U.S. Application Data
(60) Provisional application No. 61/271,841, filed on Jul. 27, 2009.

(51) Int. Cl. G06Q 30/00; G06F 15/16

(52) U.S. Cl. 705/14.69; 705/26.1; 709/217

(57) ABSTRACT

The apparatus and method of the present invention provides a system and/or platform to perform media commerce in a digital environment by which digital media creators and/or developers, and/or digital media commerce service providers, and/or digital media publishers and/or managers and/or intermediaries, and/or consumers of the digital media products and/or services may create, develop, process, fulfill, publish, manage, consume, and/or otherwise engage in media commerce in a digital environment.

### FIELD OF THE INVENTION

The present invention pertains to an apparatus and method for creating, managing, commercially transacting, and publishing media content in a digital environment, and in particular, an apparatus and method for creating, managing, commercially transacting, and publishing media content in a digital environment, which provides enhanced products and/or services for media creators, designers, developers, publishers, marketers, and other industries and individuals who or which utilize same.

### BACKGROUND OF THE INVENTION

The ability for content and media creators, designers, developers, publishers, and marketers to effectively and efficiently collaborate on creative and commercial endeavors is a fundamental challenge facing the media ecosystem. These increasingly complex business and technical interactions, as well as the growing potential opportunities for these entities to offer new and improved services to media consumers, has rendered the current state of the industry as operating at a sub-optimal level.

To illustrate the point, due to the increasing prevalence of digital media technologies the creative talent who create media content are increasingly finding employment in a wider variety of contexts including large vertically integrated media organizations and also through work as independent producers of content. Such creative digital media content producers include writers, photographers, videographers, graphic artists, musicians, filmmakers and the like. Likewise, more publication is being conducted through independent media outlets that cross both traditional print and increasingly digital formats. Yet among all of these groups, business and technical interactions for connecting suppliers of digital content and/or digital media with the promoters, publishers, and marketers, and even their customers, is desperately out of synchronization with the potential for creating highly valuable digital media offerings as might be enabled by improvements to the current state of linkages of production, business, and consumer digital media technologies.

The product in this industry is the creative work and the ability to develop and commercialize the creative works in an increasingly dynamic environment by the likes of the content or media creators, intermediaries, and media companies, is the basis for success and enables the media industry to flourish. Furthermore, the end consumer increasingly interacts with and consumes creative works and media in a more dynamic fashion, with more delivery options, and consumption and/or presentation variables, such as online, on-demand, multiple devices, mash-ups, movie theaters, book stores, media computer enabled and/or network enabled media commerce computers, media websites, digital media displays, billboards, radio broadcasts, podcasts, theater displays, screens, speakers, satellite, broadcast, wireless, and the like. Similarly, marketers of media products and services wish to identify publishers, as well as consumers of media content and media which they can use to promote their products and services. Further, consumers increasingly desire to consume these services in a shorter cycle of time from production to consumption and/or presentation.

With ever increasingly complex avenues of contribution, publication, and promotion afforded by the digital age, the challenge to optimize these multi-party interactions and transactions becomes ever more difficult. The subject of the invention is a media creation, management, publication, and commercial computer-implemented system to facilitate an efficient and effective media commercial ecosystem.

The ability to effectively and efficiently create, manage, publish, and transact commerce for media can lead to the development of products and services in the United States and throughout the rest of the world that would benefit industry and individuals. Throughout past decades, innovations in media technologies have enabled the founding and growth of industries and improved lives of an increasing number of individuals due to the ability to improve the information, understanding, knowledge, entertainment, and commercial benefits associated with improvements in computer-implemented system technologies, collaboration tools, commercial environments, while mitigating the unnecessary, wasteful processes associated with traditional commercial and creative media practices.

In the modern media industry there are potentially new digital media service offerings which are limited by traditional industry practices, and potentially new technologies which remain undeveloped due to the inertia of traditional industry business and technology practices. While it is typical to see creators and publishers independently using various new technologies, the limitation to explosive growth of new products and services is mired in how the various constituencies collectively utilize information technology. Therefore, the intelligent linking through a technological and commercial computer-implemented system which can be utilized by media creators, designers, developers, publishers, and marketers will result in a more fluidly operating media marketplace and a more comprehensive and valuable set of media products and services being offered.

An improved apparatus and method for creating, managing, commercially transacting, and publishing media content in a digital environment would make the benefits of media creation, management, and commerce more widely available to creators, marketers, and publishers of media related products and services. The result being that many more people would benefit from improved access, management, commercial opportunities, and performance improvements of associated products and services, as well as reductions in transaction costs and time.

The shortcomings associated with the solutions for digital media creation, commercialization, and management may be characterized by the lack of a comprehensive computer-implemented system for media business related technologies, management, and commercialization. These shortcomings severely limit the effectiveness of delivering optimal value to these constituencies.

A computer-implemented system for media development, production, commercialization, publication, and/or management can readily facilitate a plethora of media industry applications that will enable the benefits of media development, management, publication, consumption and/or presentation and/or commerce to be achieved by many more individuals and entities in the content creation and media publication ecosystem. The net benefit would accrue in terms of improved access, management, commercial opportunities, and performance improvements of associated products and services, as well as reductions in transaction costs and time.

### SUMMARY OF THE INVENTION

The present invention provides an apparatus and method for creating, managing, commercially transacting, and publishing media content in a digital environment.

The present invention pertains to an apparatus and method for enabling media commerce in a digital environment, and in particular, the present invention pertains to an apparatus and method for media commerce computer-implemented system, which provides enhanced products and/or services for media creators, designers, developers, publishers, marketers, and other individuals and industries who or which utilize same.

The present invention provides an apparatus and method of use by which media development, management, publication, consumption and/or presentation and/or commerce can be effectuated with a digital, controllable, and multi-user, and/or massively parallel functional computer-implemented system.

Any number of computer-implemented systems can be utilized in the apparatus and method of the present invention so as to perform the operations and/or functions described herein as being provided by the apparatus of the present invent. The computer-implemented system can be linked to any other computer-implemented system or may be a stand-alone system.

The present invention may be constructed as an apparatus or method that in that is intended to perform as a media development, management, publication, consumption and/or presentation and/or commerce apparatus and method so as to create a digital environment enabled by a computer-implemented system where media creation, management, and commerce can be conducted and/or transacted.

The present invention may be constructed as an apparatus and method that may be utilized to provide a comprehensive media development, management, publication, consumption and/or presentation and/or commerce computer-implemented system and/or service by which individuals, subscribers, registrants, and/or agents thereof, producers, directors, publishers, and/or those in the media industry may elect to, and participate in the creation, management, and/or commercial transaction of content and/or media.

The present invention provides an apparatus and a method for enabling for the creation, development, processing, fulfillment, publication, management, and/or consumption and/or presentation pertaining to a commercial relationship between content creators, content intermediaries, content publishers, content buyers, content sellers, content consumers, marketers of products, marketers of services, and any and all parties to the creation, management, and commercial transactions of media, or any other service for media content, and/or any other digital content and/or any other good and/or services provided pursuant to a media content transaction, contractual and/or otherwise, which provides for a regular transaction between the parties and/or facilitated by an intermediary. The present invention can be utilized in fashioning an efficient manner for creating, managing, disseminating, and transacting digital content and/or information to content creators, content intermediaries, content publishers, content buyers, content sellers, content consumers, marketers of products, marketers of services related to of any digital product and service which can be provided in commerce.

The present invention provides an apparatus and a method for creating, managing, and commercially transacting relating to content and/or media for the purpose of licensing, buying, selling, creating, publishing, and managing media, including, but not limited to, audio, video, photos, drawings, text, holographs, images, data, information, hyper-links, programs, applications, applets, code, scripts, files, avatars, pixel content and/or digital media, clear gifs, web beacons, games, movies, television, broadcasts, podcasts, blogs, tweets, posts, narrowcasts, voice, text, signals, warnings, prompts, advertisements, offers, solicitations, promotions, confirmations, tickets, receipts, content, digital content, aggregated information, media and/or digital media commerce products and/or services, notifications, controls, communications, and/or an embodiment of information, and/or an embodiment of control functionality, (hereinafter which may be referred to collectively as “media and/or digital media commerce products and/or services” or “media and/or digital media commerce products and/or services”).

The present invention provides an apparatus and a method for creating, managing, and commercially transacting relating to content and/or media, including but not limited to, trading, auctions, barter, reverse-auctions, auctions, and offers to buy and sell with a multitude of variations including bid types, offer types, usage rights, payment structures, fee schedules, use limitations, use restrictions, use permissions, and various known bidding and/or licensing and/or sale functions.

The present invention provides an apparatus and a method for creating, managing, and commercially transacting relating to content and/or media, including but not limited to, standardized commercial terms, standardized commercial templates, standardized creative templates, standardized media templates, standardized media formats, customizable commercial terms, customizable commercial templates, customizable creative templates, customizable media templates, and customizable media formats.

The present invention provides an apparatus and a method for the creation, management, and commercial transactions related to content and/or media, including but not limited to, a computer-implemented media commerce system for creation, conveyance, distribution, management, buying, selling, licensing, promotional activities, and/or promotional activities and/or commercial activities concerning third-party goods and/or services, offers to sell, offers to buy, offers to license, offers to distribute, offers to convey, offers to create, offers to publish, and/or offers to distribute.

The present invention provides an apparatus and a method for the creation, management, and commercial transactions related to content and/or media, including but not limited to, a secure and/or secured computer-implemented system for creation, conveyance, distribution, management, buying, selling, licensing, promotional activities, and/or promotional activities and/or commercial activities concerning third-party goods and/or services, offers to sell, offers to buy, offers to license, offers to distribute, offers to convey, offers to create, offers to publish, and/or offers to distribute.

The present invention provides an apparatus and a method for the creation, management, and commercial transactions related to content and/or media, including but not limited to, a notification enabled computer-implemented system for creation, conveyance, distribution, management, buying, selling, licensing, promotional activities, and/or promotional activities and/or commercial activities concerning third-party goods and/or services, offers to sell, offers to buy, offers to license, offers to distribute, offers to convey, offers to create, offers to publish, and/or offers to distribute.

The present invention provides an apparatus and a method for creating, managing, and commercially transacting relating to content and/or media, including but not limited to, a computer-implemented system for publication and/or distribution, to individuals, end users, commercial entities, non-commercial entities, for resale, and for consumption and/or presentation.

The present invention provides an apparatus and a method for creating, managing, and commercially transacting relating to content and/or media, including but not limited to, a secure computer-implemented system for creation, conveyance, distribution, management, buying, selling, licensing, promotional activities, promotional activities concerning third-party goods and/or services in either digital form, online, print, or other commercial and/or non-commercial distribution methodologies.

The present invention provides an apparatus and a method for creating, managing, and commercially transacting relating to content and/or media, including but not limited to, a computer-implemented system with ratings functionality so as to enable parties to the media crating, management and commercial transactions to rate and review one another on parameters including but not limited to past history, financial information, independent assessments, creative assessments, relevance, quality, and ease of doing business.

The present invention provides an apparatus and a method for creating, managing, and commercially transacting relating to content and/or media, including but not limited to, a computer-implemented system for creation, conveyance, distribution, management, buying, selling, licensing, promotional activities, promotional activities concerning third-party goods and/or services, wherein any of the aforementioned parties may have as part of the computer-implemented system unique accounts, unique presence pages, unique public pages, unique presence identification, unique commercial presence existing within the computer-implemented system, existing on other computer-implemented systems and linked to the herein reference media computer-implemented system, and/or linked between various computer-implemented systems with all or some of the attributes of the presence, pages, and/or accounts residing on one, all, or some of the computer-implemented systems.

The present invention provides an apparatus and a method for creating, managing, and commercially transacting relating to content and/or media, including but not limited to, a computer-implemented system for creation, conveyance, distribution, management, buying, selling, licensing, promotional activities, promotional activities concerning third-party goods and/or services that can interoperate with other digital media computer-implemented systems including but not limited to virtual reality environments, virtual worlds, digital games, digital gaming computer-implemented systems, networked gaming computer-implemented systems, cinema, networked video production, networked video consumption and/or presentation, networked audio production, networked audio consumption and/or presentation, networked image production, networked image consumption and/or presentation, networked text production, networked text consumption and/or presentation, networked data production, networked data consumption and/or presentation, networked television production, networked television consumption and/or presentation, cable network content production, cable network content consumption and/or presentation, digital media production, digital media consumption and/or presentation, and communications networks.

The present invention provides an apparatus and a method for creating, managing, and commercially transacting relating to content and/or media, including but not limited to, applications for managing and conducting commercial transactions including accounting, reporting, customer relationship management, enterprise resource management, business intelligence, billing systems, e-commerce systems, and other related computer-implemented media commerce systems.

The present invention provides an apparatus and a method for creating, managing, and commercially transacting relating to content and/or media, including but not limited to, a means for multiple business models for operating the computer-implemented system including but not limited to usage fees, transaction fees, storage fees, infrastructure fees, management fees, services fees, application fees, and/or other related commercial consideration, systems, content, products and/or services.

The present invention provides an apparatus and a method for creating, managing, and commercially transacting relating to content and/or media, including but not limited to, a customizable end-user and/or consumer and/or publisher media templates so as to enable the efficient production of customized and/or personalized digital media products and services.

The present invention provides an apparatus and a method for creating, managing, and commercially transacting relating to content and/or media, including but not limited to, standardized and customizable commercial terms for end-user and/or consumer and/or publisher media consumption and/or presentation so as to enable the efficient and effective publication and distribution media products and services.

The present invention provides an apparatus and a method for creating, managing, and commercially transacting relating to content and/or media, including but not limited to, an open computer-implemented system whereby third-party publishing tools, commercial tools, media tools, creative tools, marketing tools can be integrated, affiliated, linked, or caused to be interoperable.

The present invention provides an apparatus and a method for creating, managing, and commercially transacting relating to content and/or media, including but not limited to, a service for advertisers to publish advertising in conjunction with media and/or link advertising with content prior to publication.

The present invention provides an apparatus and a method for creating, managing, and commercially transacting relating to content and/or media, including but not limited to, providing a catalogue of existing, past, planned, and future periodicals and media publications to which individuals, organizations, and end-users may subscribe and or purchase.

The present invention provides an apparatus and a method for creating, managing, and commercially transacting relating to content and/or media, including but not limited to, providing consumers of media to create accounts and profiles by which advertisers can be demographically and/or interest-wise pair advertisements.

The present invention may be constructed as an apparatus or method that in that such types of media related products, services, and computer-implemented systems may include, but are not limited to, media content storage, media content publication, media content creation, media content sale, media content licensing, media content buying, media content management, and further functionality regarding media creation, management and commercial transacting, including but not limited to notifications, controls, communications, data, hyper-links, warnings, prompts, requests, restrictions, limitations, monitoring, management, advertisements, rules, policies, practices, aggregation, implementations, dissolutions, disallowances, activations, authorizations, authentications, audio, video, photos, drawings, text, holographs, images, data, information, hyper-links, programs, applications, applets, code, scripts, files, avatars, pixel content and/or digital media, clear gifs, web beacons, games, movies, television, broadcasts, podcasts, blogs, tweets, posts, narrowcasts, voice, text, signals, warnings, prompts, advertisements, offers, solicitations, promotions, confirmations, tickets, receipts, content, digital content, aggregated information, media and/or digital media commerce products and/or services, notifications, controls, communications, and/or an embodiment of information, and/or an embodiment of control functionality, (hereinafter which may be referred to collectively as “media and/or digital media commerce products and/or services” or “media and/or digital media commerce products and/or services”).

The present invention may be constructed as an apparatus or method that in that such types of media and other commercial products, services, and computer-implemented systems may be constituted in the following forms, but are not limited to, digital and/or electronic and/or audio and/or video and/or voice and/or tactile and/or image and/or gestation and/or olfacaction and/or equilibrioception and/or thermoception and/or proprioception and/or nociception and/or interoception and/or echolocation and/or electroception and/or magnetoception and/or pressure detection and/or current detection and/or polarized light direction detection and/or slit sensillae and/or vibratory and/or radiation and/or energy waves and/or particles, programs, applications, code, images, video, audio, sights, sounds, noises, signals, touches, tastes, smells, movements, actions, reactions, holographs, and text.

The present invention may be constructed as an apparatus or method that such types of media, and other commercial products, services may occur at temporal contexts that include, but are not limited to, pre-communication and/or transaction, during communication and/or transaction, real-time communication and/or transaction, and post-communication and/or transaction.

The present invention may be constructed as an apparatus or method that is utilized in either the form of any one and/or several of the following technical systems including, but not limited to, network based, cloud computing based, client based, client-server based, quantum computing based, quantum storage based, network computer based, communications network based, terrestrial network based, mobile network based, satellite network based, mesh network based, Internet based, world wide web based, closed circuit based, open network based, radio based, light based, radiation based, energy wave based, and/or particle based.

The apparatus and method of present invention may be consist of a multitude of various network, transmission, hardware, and/or software configurations and/or, complexities, including but not limited to multiple types of communications, transmissions, computing applications, states of development, versions, correspondences, single-party communications, single-party computations, one-way communications, two-way communications, multi-party communications, machine communications, machine-to-human communications, machine-to-machine, multi-party machine communications, peer-to-peer communications, simplex communications, duplex communications, two-way duplex communications, and/or support systems and/or network configurations so as to enable a multitude of both supply side and demand side receiver controlled media development, management, publication, consumption and/or presentation and/or commerce. Moreover, the format and/or encoding used in the creation, dissemination, transmission, transfer, and/or reception of such media development, management, publication, consumption and/or presentation and/or commerce may vary, and/or be in one or more forms and/or be in multiple-forms at a single instance, so as to ensure that a certain type of media development, management, publication, consumption and/or presentation and/or commerce is effectuated for a particular purpose.

The present invention may be constructed as an apparatus and method that is controlled, managed, monitored, in any combination of a network, client, server, network computer, computing and/or communications mechanism, and/or device, in such a way that the media development, management, publication, consumption and/or presentation and/or commerce of media content is effectuated.

The present invention may be constructed as an apparatus and method that provides notifications to parties to the media relationship regarding all aspects of a commercial and/or technical nature of any one or more of stages including before, during, and/or following the formal commercial transaction and/or relationship.

The present invention may be constructed as an apparatus and method in various scales so as to enable a multitude of uses. By example, the device may be constructed to operate for a single entity acting as both the sender and receiver of the media creation, management, and commercial transaction and the associated media development, management, publication, consumption and/or presentation and/or commerce. Or, it may be the case that the apparatus and method are two entities with one or both acting as the senders and/or receivers of the media creation, management, and commercial transaction and the associated media development, management, publication, consumption and/or presentation and/or commerce. Or, it may be the case that the apparatus and method are multiple greater than two entities, any one, several, or all may be acting as the senders and/or receivers of the media creation, management, and commercial transaction and the associated media development, management, publication, consumption and/or presentation and/or commerce.

The present invention may be constructed as an apparatus and method with varying quantities of content and/or media and associated media development, management, publication, consumption and/or presentation and/or commerce elements in any one transmission, series of transmissions, parallel transmissions, identical transmissions, customized transmissions, and/or unique transmissions. Or, it may be the case that the apparatus and method are configured in a manner that permits reactive, proactive, or dynamic changes to its quantities of media and associated media development, management, publication, consumption and/or presentation and/or commerce related products and/or services.

The present invention may be constructed as an apparatus and method with various technologies so as to effectuate a multitude of media development, management, publication, consumption and/or presentation and/or commerce effects, such as but not limited to its media development, management, publication, consumption and/or presentation and/or commerce effects in response to any one or any combination of varying criteria or parameters identified by the content development, commercialization, and/or publication of media, media assets, management thereof, and commerce related thereto, which may include but is not limited to status or changes associated with systems, networks, accounts, demographics, politics, economics, individual status, sociological, demographical, geological, environmental, psychological, physiological, medical, systems, security, and/or financial criteria.

The present invention may be constructed as an apparatus and method to automatically generate, and/or configure, and/or transmit, and/or receive a single media creation, management, and commercial transaction and associated media development, management, publication, consumption and/or presentation and/or commerce or multitude of media content and associated media development, management, publication, consumption and/or presentation and/or commerce effects, such as but not limited to its media development, management, publication, consumption and/or presentation and/or commerce effects in response to any one or any combination of varying criteria or parameters identified by the supply side and/or demand side of the associated media development, management, publication, consumption and/or presentation and/or commerce, which may include but is not limited to status or changes in status or in response to changes associated with systems, network, account, demographic, political, economic, individual, sociological, demographical, geological, environmental, psychological, physiological, medical, systems, security, and/or financial criteria.

The present invention may be constructed as an apparatus and method composed of multiple media development, management, publication, consumption and/or presentation and/or commerce functions acting either in concert and/or independently so as to effectuate a multitude of media development, management, publication, consumption and/or presentation and/or commerce effects, such as but not limited to its media development, management, publication, consumption and/or presentation and/or commerce effects in defined groups, random samplings, algorithmically defined sets, geographic, and/or demographic segments.

The present invention also provides for an improved apparatus and a method for facilitating, managing, transacting, and processing applications and/or requests of an informative and/or commercial nature between users, account holders, and service providers and other commercial and/or non-commercial entities.

The apparatus includes a central user account, user session, and/or registration processing computer which processes subscriptions and/or registration orders and/or user account, user session, and/or registration requests and establishes media creation, management, commercial transactions, publications, fulfillment, subscriptions and/or registrations and/or user account, user session, and/or registration accounts for the respective subscribers to any of the respective media commerce described herein. The apparatus can also include a central user account, user session, and/or registration fulfillment processing computer which processes data and/or information regarding and/or involving processing and/or fulfillment services for the respective media creation, management, commercial transactions, publications, fulfillment, subscriptions and/or registrations.

The apparatus also includes a communication device which can be utilized so as to communicate with each of the central computer(s) for creation, management, commercial transaction, publication, distribution, subscription, registration, and/or fulfillment.

The communication device can be utilized so as to communicate with the central computer(s) for creation, management, commercial transaction, publication, distribution, subscription, registration, and/or fulfillment. The communication device can transmit signals to, as well as receive signals from, each of the central computer(s) for creation, management, commercial transaction, publication, distribution, subscription, registration, and/or fulfillment.

The apparatus also includes at least one or more receiving devices which receive the respective media described herein.

The apparatus also includes at least one or more receiving devices which receive the respective media described herein that also can transmit signals to, and receive signals from, a separate communication device. In this manner, any of the parameters and/or instructions and/or communicated to the central user account, user session, and/or registration processing computer, the central user account, user session, and/or registration fulfillment processing computer, and/or the user account, user session, and/or registration communication device, may communicate, update, and coordinate with each other.

A plurality of communication devices can be utilized, with each device being utilized at and for a separate function and/or location. A plurality of communication devices can be utilized with each communication device being associated with a subscriber, and/or more than one communications device with each subscriber and/or registrant. The communication device can also be located at a public location and may be a public kiosk, billboard, display, speaker, microphone, point-of-sale device, computer, telephone, and/or similar communications and/or computing device enabling digital media commerce transmissions.

The central user account, user session, and/or registration processing computer may be a single computer and/or computer system and/or may include a plurality of computers and/or computer systems. Similarly, the central user account, user session, and/or registration fulfillment processing computer may be a single computer and/or computer system and/or may include a plurality of computers and/or computer systems.

The apparatus of the present invention can be utilized over any suitable communication network and/or system. The communications networks and/or systems on, or over, which the present invention may be utilized, can include any one or combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, as well as in, or on any internets and/or intranets, the Internet, the World Wide Web, and any other suitable communication network or system.

The apparatus of the present invention can also be utilized on, or over, the Internet and/or the World Wide Web, and/or on, or over, any other suitable communication network or combination of communication networks.

The apparatus and method of present invention can be utilized so as to order and/or to initiate media creation, management, commercial transactions, publications, fulfillment, subscriptions and/or registrations, to renew media creation, management, commercial transactions, publications, fulfillment, subscriptions and/or registrations, to extend the term of media creation, management, commercial transactions, publications, fulfillment, subscriptions and/or registrations, and/or to cancel and/or to terminate media creation, management, commercial transactions, publications, fulfillment, subscriptions and/or registrations, and/or to service and/or to fulfill media creation, management, commercial transactions, publications, fulfillment, subscriptions and/or registrations, for any of the user account, user session, and/or registration, and for any of the media content and/or media commerce which can be the subject of the respective media creation, management, commercial transactions, publications, fulfillment, subscriptions and/or registrations.

The apparatus and method of the present invention can facilitate the initiation and/or creation and/or development and/or processing and/or fulfillment and/or publication and/or management and/or consumption and/or presentation of media creation, management, commercial transactions, publications, fulfillment, subscriptions and/or registrations in a network environment. The apparatus and method of the present invention can also facilitate providing media creation, management, commercial transactions, publications, fulfillment, subscriptions and/or registrations which have flexibility in the initiation and/or creation and/or development and/or processing and/or fulfillment and/or publication and/or management and/or consumption and/or presentation of same, as well as being able to facilitate providing subscriptions which have flexibility in the length and/or the duration of the user account, user session, and/or registration.

The apparatus and method of the present invention can also provide a centralized user account, user session, and/or registration processing and/or service and/or fulfillment apparatus or system and/or a user account, user session, processing and/or user account, user session, and/or registration fulfillment clearinghouse. The apparatus and method of the present invention can also provide notification to subscribers and/or other parties regarding media, subscription, and/or registration offers, changes and/or information regarding an event, occurrence and/or happening regarding any of the subscriptions and/or any of the services described herein.

The present invention can be utilized in conjunction with subscriptions, and/or registrations involving digital communications, data, information, digital content, and/or any other informational and/or digital entertainment content.

The media content described herein may be associated with periodicals in electronic form or “e-periodicals”, and/or periodicals in any other form. The present invention can be utilized in conjunction with any digital good and/or service which can be the subject of commerce. In this regard, the media content described herein can involve, but not be limited to, media content for and/or regarding offers to sell, offers to buy, offers to barter, offers to trade, solicitations, event tickets, digital content, digital information, physical goods, commercial goods, merchandise, industrial goods, consumer goods, digital services, physical services, commercial services, industrial services, movie rentals, video rentals, movie tickets, albums, music, audio files, video files, electronic books, electronic periodicals, electronic and/or digital media, digital content, show tickets, airline tickets, bus tickets, gasoline purchases, postage stamps and/or postage, meals tickets, tickets to sporting events, tickets to entertainment events, tickets to theater performances, professional services, contracted for services, and/or any other good and/or service which can be the subject of commerce.

Any of the communications which occur and/or which transpire between any of the computers and/or devices, and/or which occurs between any individual subscribers, and/or offering parties, and/or contracting parties, and/or media parties, and/or operators and/or administrators of any of the computers and/or devices, can be effected by or via electronic communications, digital communications, telecommunications, electronic mail (e-mail), electronic media creation, management, and commercial transaction transmission, telephone media and/or digital media commerce products and/or services, voice mail media and/or digital media commerce products and/or services, pager media and/or digital media commerce products and/or services, beeper media and/or digital media commerce products and/or services, conventional mail letter or media and/or digital media commerce products and/or services, letter, telephone call, and/or any other manner and/or mode of communication.

The present invention can provide for, and can perform digital media processing and/or fulfillment services for, and regarding, media content which have flexibility in when issues can be obtained and/or skipped while still providing the individual media creator, manager, commercial party, publisher, promoter, subscriber and/or registrant with the value of, and/or with the number of media content for which the individual media creator, manager, commercial party, publisher, promoter, subscriber and/or registrant has contracted. The amount of user account, user session, flexibility can be dictated by any party to the user account, user session, and/or registration.

The computer-implemented media commerce creation and/or development, processing and/or fulfillment, and/or publication and/or management system can provide processing for any number and/or type of media content. The computer-implemented media commerce creation and/or development, processing and/or fulfillment, and/or publication and/or management system can administer, manage, service, and/or provide processing, for any number and/or types of media content.

The apparatus and method of the present invention can provide for media creation, management, commercial transactions, publications, fulfillment, subscriptions and/or registrations for media content which can be initiated and/or created via any communication device and/or any computer enabled and/or network enabled transaction device.

The media creation, management, and commercial transaction delivery can be fulfilled and/or serviced by any communications entity and/or other communications and/or media facility. In this manner, an individual media creator, manager, commercial party, publisher, promoter, subscriber and/or registrant may initiate a user account, user session, for a media creation, management, and commercial transaction and/or media content from any location and/or device associated with that individual, subscriber, registrant, agent thereof, and/or any device associated with individual, subscriber, registrant, and/or agent thereof at a single point of time, such as but not limited to, an internet access device and/or computer enabled and/or network enabled machine at a commercial location, either before, during, or after the transaction at the commercial location. In this manner, flexibility is provided regarding the issue of media creation, management, and commercial transaction deliver.

The individual, subscriber, registrant, and/or agent thereof, and/or other third party intermediary, can access the central user account, user session, and/or computer-implemented media commerce creation and/or development, processing and/or fulfillment, and/or publication and/or management system, via one of the herein referenced communication devices and/or via the computer enabled and/or network enabled transaction device so as to ascertain the status of a user account, user session, such as, but not limited to, whether the user account, user session, is active or inactive, and/or the fulfillment status of the user account, user session, and/or registration, such as, but not limited to, the number of media content remaining, type of media content remaining, time for next media and/or digital media commerce products and/or services, content associated with the parties to the media transaction.

The computer-implemented media commerce creation and/or development, processing and/or fulfillment, and/or publication and/or management system can also notify individual subscribers via any means, method and/or manner of communication, via the communication device and/or the computer enabled and/or network enabled transaction device, of available media content, of media creation, management, and commercial transaction promotions, of renewal notices, extension notices, termination notices, media creation, management, and commercial transaction creation and/or initiation notices, media creation, management, and commercial transaction delivery, and/or of any other information which may be of interest to an using entity and/or individual user and/or subscriber and/or registrant.

The apparatus and method of the present invention can be utilized as a media clearinghouse, to match individual subscribers with media content, wherein information regarding any number of, and types of, media content can be stored in the database associated with the computer-implemented system providing the digital media commercial service and/or registration processing computer and/or the central media fulfillment processing computer. Any individual media creator, manager, commercial party, publisher, promoter, subscriber and/or registrant can access the respective central user account, user session, and/or registration processing computer and/or central user account, user session, and/or registration fulfillment processing computer and search for a desired media creation, management, and commercial transaction and/or media content. The individual media creator, manager, commercial party, publisher, promoter, subscriber and/or registrant may then apply for, and/or receive payment for, and/or receive consideration for, and/or purchase a media and/or digital media commerce products and/or services.

The apparatus and method of the present invention allows for the content and/or media creator, manager, commercial party, publisher, promoter, subscriber and/or registrant to place a request and/or an order for a media creation, management, and commercial transaction and/or media content, with information regarding the request and/or order being stored in the database associated with the computer-implemented system providing the digital media commercial service and/or computer-implemented media commerce creation and/or development, processing and/or fulfillment, and/or publication and/or management system. The computer-implemented media commerce creation and/or development, processing and/or fulfillment, and/or publication and/or management system can thereafter process the order or order and notify the individual via the communication device and/or the computer enabled and/or network enabled transaction device if and when the ordered media creation, management, and commercial transaction is available.

The apparatus and method of the present invention enables the content and/or media creator, manager, commercial party, publisher, promoter, subscriber and/or registrant and/or agent thereof may be notified via electronic communications, telecommunications, digital communications, e-mail, electronic transmission, pager media and/or digital media commerce products and/or services, beeper media and/or digital media commerce products and/or services, telephone call, telephone media and/or digital media commerce products and/or services, letter, voice media and/or digital media commerce products and/or services, physical mail delivery, and/or via any other appropriate means, method and/or technique.

In the apparatus and method of the present invention any of the computer-implemented media commerce creation and/or development, processing and/or fulfillment, and/or publication and/or management system, the communication device(s), and/or the computer enabled and/or network enabled transaction device(s), can be programmed for automatic operation, self-activation, and/or programmed operation. The computer-implemented media commerce creation and/or development, processing and/or fulfillment, and/or publication and/or management system can be programmed to automatically generate and/or to transmit media content and/or notices to any of the user and/or operators, computer enabled and/or network enabled media commerce computers, goods and/or services providers, or the like, regarding subscriptions, user account, user session, fulfillment, the availability of media content, availability of goods and/or services which are the subject of a media and/or digital media commerce products and/or services.

Intelligent agents, software agents, and/or mobile agents, can be utilized in the apparatus and method of the present invention so as to act on behalf of any of the parties and/or any of the respective computers and/or devices described herein.

Accordingly, it is an object of the present invention to provide an apparatus and a method for enabling for the creation, development, processing, fulfillment, publication, management, and/or consumption and/or presentation pertaining to media commerce.

It is another object of the present invention to provide an apparatus and a method for enabling for the creation, development, processing, fulfillment, publication, management, and/or consumption and/or presentation pertaining to media commerce, in a network environment.

It is still another object of the present invention to provide an apparatus and a method for enabling for the creation, development, processing, fulfillment, publication, management, and/or consumption and/or presentation pertaining to media commerce which allows an using entity and/or individual user and/or subscriber and/or registrant, and/or agent thereof to control the manner in which the user account, user session, and/or registration for media is fulfilled.

It is yet another object of the present invention to provide an apparatus and a method for enabling for the creation, development, processing, fulfillment, publication, management, and/or consumption and/or presentation pertaining to media commerce which provides for flexibility, as to time, location, and/or good or service provider, in the operation execution and/or transmission of the media, user account, user session, and/or registration for media.

It is another object of the present invention to provide an apparatus and a method for enabling for the creation, development, processing, fulfillment, publication, management, and/or consumption and/or presentation pertaining to media commerce which provides for a media creation, management, and commercial transaction which is characterized by a user account, user session, period, term and/or duration, which allows an individual media creator, manager, commercial party, publisher, promoter, subscriber and/or registrant to skip media content, which are the subject of the user account, user session, and/or registration while still allowing the individual media creator, manager, commercial party, publisher, promoter, subscriber and/or registrant to obtain and/or to benefit from the value of the user account, user session, and/or registration.

It is still another object of the present invention to provide an apparatus and a method for enabling for the creation, development, processing, fulfillment, publication, management, and/or consumption and/or presentation pertaining to media commerce which facilitates an initiation of a user account, user session, and/or registration, a renewal of a user account, user session, and/or registration, an extension of a user account, user session, and/or registration, and/or the cancellation and/or termination of a user account, user session, and/or registration.

It is yet another object of the present invention to provide an apparatus and a method for enabling for the creation, development, processing, fulfillment, publication, management, and/or consumption and/or presentation pertaining to media commerce which provides notification to an individual media creator, manager, commercial party, publisher, manager, and/or consumer regarding the creation, development, processing, fulfillment, publication, management, and/or consumption and/or presentation pertaining to media commerce services, sessions, subscriptions and/or registrations, and/or information and/or status regarding such.

It is another object of the present invention to provide an apparatus and a method for enabling for the creation, development, processing, fulfillment, publication, management, and/or consumption and/or presentation pertaining to media commerce which provides for a flexible media creation, management, and commercial transaction user account, user session, and/or registration as well as a flexible media creation, management, and commercial transaction fulfillment.

It is yet another object of the present invention to provide an apparatus and a method for enabling for the creation, development, processing, fulfillment, publication, management, and/or consumption and/or presentation pertaining to media user account, user session, services which provides and/or processes media creation, management, and commercial transaction user account, user session, initiations, renewals, extensions, and/or terminations.

It is another object of the present invention to provide an apparatus and a method for enabling for the creation, development, processing, fulfillment, publication, management, and/or consumption and/or presentation pertaining to media commerce which can be utilized in conjunction with computer enabled and/or network enabled transaction devices, personal computers, computing workstations, server, network computers, electronics devices, video and/or audio recorders, personal communication devices, public communication devices and/or kiosk, billboard, display, speaker, microphone, point-of-sale device, computer, telephone, and/or similar communications and/or computing device enabling digital media commerce transmissions, movie screens, movie displays, video display, and/or systems and/or networks for digital television, cable television, broadcast television, Internet Protocol television, satellite television, broadband televisions, audio speakers, digital media computer enabled and/or network enabled media commerce computers, print computer enabled and/or network enabled media commerce computers who's printed content is created, developed, processed, fulfilled, published, and/or managed in a digital format, media websites, digital media displays, and/or billboards.

It is still another object of the present invention to provide an apparatus and a method for enabling for the creation, development, processing, fulfillment, publication, management, and/or consumption and/or presentation pertaining to media commerce which can be utilized on, over, and/or in conjunction with, any communication system.

It is yet another object of the present invention to provide an apparatus and a method for enabling for the creation, development, processing, fulfillment, publication, management, and/or consumption and/or presentation pertaining to media commerce which can be utilized on, over, and/or in conjunction with, the Internet and/or the World Wide Web.

It is another object of the present invention to provide an apparatus and a method for enabling for the creation, development, processing, fulfillment, publication, management, and/or consumption and/or presentation pertaining to media commerce which provides for a multitude of processing capabilities, including but not limited to, centralized media processing, de-centralized processing, network-based processing, client-server processing, device processing, related to the herein described service for any kind and/or type of media.

It is still another object of the present invention to provide an apparatus and a method for enabling for the creation, development, processing, fulfillment, publication, management, and/or consumption and/or presentation pertaining to media commerce which provides for processing of user account, user session, and/or registration payment information and/or settlement information.

It is another object of the present invention to provide an apparatus and a method for enabling for the creation, development, processing, fulfillment, publication, management, and/or consumption and/or presentation pertaining to media commerce which provides a clearinghouse for matching media consumers to media content.

It is still another object of the present invention to provide an apparatus and a method for enabling for the creation, development, processing, fulfillment, publication, management, and/or consumption and/or presentation pertaining to media commerce which provides for an apparatus which is programmed to provide any of the functionality described herein.

It is yet another object of the present invention to provide an apparatus and a method for enabling for the creation, development, processing, fulfillment, publication, management, and/or consumption and/or presentation pertaining to media commerce which can be utilized in conjunction with intelligent agents, software agents, and/or mobile agents.

The present invention pertains to an apparatus and method for enabling media commerce in a digital environment, and in particular, the present invention pertains to an apparatus and method for digital media commerce, which provides enhanced products and/or services for business, communications, entertainment, and other industries and individuals who or which utilize same.

The present invention provides an apparatus and method of use by which media commerce can be effectuated created and controlled on a multitude of sides of the media commerce transaction. The present invention can be readily implemented across a plethora of applications, computing environments, communications solutions will enable the benefits of media commerce to be achieved by many more individuals in the systems, devices, and products they use.

The apparatus and method of the present invention is to be utilized to provide a comprehensive digital media commerce computer-implemented system for the very many types of business, engineering, entertainment and other commercial products, services, communications and computing computer-implemented systems.

The apparatus and method of the present invention is to be utilized to provide a comprehensive media commerce computer-implemented system and/or service by which individuals, subscribers, registrants, agents, intermediaries, publishers, producers, directors, distributors, broadcasters, and/or other media industry participants may elect to create, develop, promote, publish, distribute, license, sell, buy, commercialize, merchandise, consume, and/or otherwise supply and/or utilize media commerce applications, services and/or products in a digital environment.

The apparatus and method of the present invention is to be utilized in such types of business, engineering, communicatory, entertainment, public service, and/or other commercial products, services, and computer-implemented systems may include, but are not limited to, audio, video, photos, drawings, text, holographs, images, data, information, hyper-links, programs, applications, applets, code, scripts, files, avatars, pixel content and/or digital media, clear gifs, web beacons, games, movies, television, broadcasts, podcasts, blogs, tweets, posts, narrowcasts, voice, text, signals, warnings, prompts, advertisements, offers, solicitations, promotions, confirmations, tickets, receipts, content, digital content, aggregated information, media and/or digital media commerce products and/or services, notifications, controls, communications, and/or an embodiment of information, and/or an embodiment of control functionality, (hereinafter which may be referred to collectively as “media and/or digital media commerce products and/or services” or “media and/or digital media commerce products and/or services”).

The apparatus and method of the present invention may be utilized in such types of business, engineering, communicatory, entertainment, public service, and/or other commercial services, products, and/or computer-implemented systems, using technologies of the following nature: digital and/or electronic and/or audio and/or video and/or voice and/or tactile and/or image and/or gestation and/or olfacaction and/or equilibrioception and/or thermoception and/or proprioception and/or nociception and/or interoception and/or echolocation and/or electroception and/or magnetoception and/or pressure detection and/or current detection and/or polarized light direction detection and/or slit sensillae and/or vibratory and/or radiation and/or energy waves and/or particles.

The apparatus and method of the present invention enables various types of business, engineering, communicatory, entertainment, and other commercial products, services to occur in a multitude of temporal contexts that include, but are not limited to, pre-communication and/or transaction, during communication and/or transaction, real-time communication and/or transaction, and post-communication and/or transaction.

The apparatus and method of the present invention, may be utilized in conjunction with, on, or over, a plurality of communications and/or computing networks, and/or systems, which may include, but are not limited to, any one or any combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, geo synchronous satellite systems, as well as in, or on any internets and/or intranets, computing networks, cloud computing systems, server, network computers, client devices, client-server based, quantum computing based, quantum storage based, network computer architectures, communications networks, terrestrial networks, undersea networks, mobile networks, satellite networks, mesh networks, the Internet, World Wide Web, WWW2, WWW3, Semantic Web, closed circuit networks, open networks, radio networks, optical networks, pulse networks, digital networks, wave networks, light networks, neural networks, chemical networks, materials networks, biological networks, radiation networks, energy wave networks, and/or particle based networks, and/or where it may occur in a supra-global network environment, global network environment, trans-national network environment, national network environment, wide area network environment, metropolitan area network environment, local area network environment, personal network area environment, inter-being network environment, intra-being network environment, human-to-machine network environment, machine-to-machine network environment, and/or human-to-non-human network environment, and any other suitable communication network or system.

The apparatus and method of the present invention, including its data, information, content and the like, can exist in various lengths, sizes, complexities, series, and/or in conjunction with series of communications, conversations, repeated communications, one-way communications, two-way communications, multi-party communications, machine communications, machine-to-human communications, machine-to-machine, multi-party machine communications, peer-to-peer communications, simplex communications, duplex communications, two-way duplex communications, and/or support systems and/or network configurations so as to enable a multitude of demand side, receiver and/or subscriber controlled media commerce. Moreover, the format and/or encoding used in the creation, dissemination, transmission, transfer, and/or reception of such media commerce may vary, and/or be in one or more forms and/or be in multiple-forms at a single instance, so as to ensure that a certain type of media commerce is effectuated for a particular purpose.

The apparatus and method of the present invention can be controlled, managed, monitored, in any combination of a network, client, server, network computer, communications tool, computing mechanism, and/or device, in such a way that the digital media commerce of media and/or digital media commerce products and/or services is effectuated.

The apparatus and method of the present invention can provide notifications to parties to the digital media commerce relationship regarding all aspects of a commercial and/or technical nature of any one or more stages including offering, counter-offering, acceptance, establishment, set-up, execution, management, status, dissolution, and/or confirmation of the media commerce relationship.

The apparatus and method of the present invention can exist in various scaling configurations so as to enable a multitude of uses. By example, the device may be constructed to operate in a one-to-one, one-to-few, one-to-many, many-to-one, many-to-few, many-to-many, few-to-one, few-to-few, few-to-many, wherein a single user can be a subset of a broader entity, and/or where multiple users can be massively multi-user in nature, and/or for a single entity acting as either and/or both the sender and receiver and/or subscriber of the media commerce services and/or products. Or, it may be the case that the apparatus and/or method are two entities with one or both acting as either and/or both the senders and/or receivers of the media commerce services and/or products. Or, it may be the case that the apparatus and method are multiple greater than two entities, any one, several, or all may be acting as either and/or both the senders and/or receivers of media commerce services and/or products.

The apparatus and method of the present invention can be constructed to accommodate a vast degree of varying volumes of media and associated media commerce in any one transmission, series of transmissions, parallel transmissions, identical transmissions, customized transmissions, and/or unique transmissions. Or, it may be the case that the apparatus and method are configured in a manner that permits reactive, proactive, or dynamic changes to its volumes of media commerce and associated media commerce parameters.

The apparatus and method of the present invention can be constructed with various technologies, algorithms, intelligent agents, code, instruction sets, and/or control functionalities, both statically and/or dynamically configurable, so as to effectuate a multitude of media commerce effects, such as but not limited to its media commerce effects in response to any one or any combination of varying criteria or parameters identified by the supply side and/or demand side of the media commerce and the associated media commerce, which may include but is not limited to status or changes associated with systems, networks, accounts, contexts, demographics, politics, economics, individual status, sociological, demographical, geological, environmental, psychological, physiological, medical, systems, security, and/or financial criteria.

The present invention may be constructed as an apparatus and/or method to automatically generate, and/or configure, and/or transmit, and/or receive a single piece of digital media and/or digital media commerce command and/or action, or a multitude digital media and/or digital media commerce commands and/or actions, such as but not limited to its media commerce effects in response to any one or any combination of varying criteria or parameters which may include but is not limited to status or changes in status or in response to changes associated with systems, network, account, demographic, political, economic, contextual, individual, sociological, geographical, geological, environmental, psychological, physiological, medical, systems, security, economic, and/or financial criteria.

The apparatus and method of the present invention can be constructed to enable multiple digital media commerce functions acting either in concert and/or independently so as to effectuate a multitude of media commerce effects, such as but not limited to its media commerce effects in defined groups, random samplings, algorithmically defined sets, contextual circumstances, geographic, and/or demographic segments.

The apparatus and method of the present invention can be constructed to enable the storing of data related to the creation and/or development, processing and/or fulfillment, publication and/or management of digital media commerce services based upon data and/or information regarding the digital media commerce user, including all histories of usage, commercial terms, payments, technical, and/or communications usage in conjunction with the digital media commerce service. This may include, but is not limited to, data and/or information regarding the user including all communications account information, financial account information, and a multitude of profiling information including, but not limited to, preferences, demographics, activity streams, behavioral targeting, data logging. digital footprint, lifelog, lifestreaming, profiling, runtime intelligence, social translucence, trace, trace evidence, genetic sequencing, psychographics, data represented in Attention Profiling Mark-up Language, subject and/or interest item information, communications, browsing histories, browsing patterns, documents, files, computational usage statistics, communications usage statistics, content created, content viewed, heard and/or read, content downloaded, applications used and/or downloaded, search queries, search results, click-through on search results, digital traces, activities, behaviors, login and logouts, visit of pages, documents accesses, items created, affiliation to groups, attention, social group, repetition, location, reputation, financial activities, investing activities, income data, spending data, consumption and/or presentation data, tax data, credit data, credit history data, reputational data, media related data, sensor discovered data, sensor recorded data, digital footprints, digital finger prints, life streams, social media linkages, social media activities, communications activities, computing activities, personal status, medical information, health information, personally identifiable information, volunteered information, collected information, rumored information, non-volunteered information, information capable of being stored in log files, information capable of being stored locally and/or or in a private and/or public cloud computing environment, information capable of being stored in databases, mined data, as well as the analytics associated with the aforementioned data and/or information, with respect to the services provided related to digital media commerce.

The apparatus and method of the present invention can be constructed to enable the storing of data related to the creation and/or development, processing and/or fulfillment, publication and/or management of digital media commerce services based upon data and/or information regarding the services provided by the digital media commerce service provider, and/or affiliated service providers, including services previously offered, currently offered, and/or prospectively offered, content, communications, and/or commercial information regarding digital media commerce including, but not limited to, data received by and/or from the digital media publisher and/or manager and/or intermediary, data received by and/or from the digital media creator and/or developer, and/or data generated by the digital media commerce service provider through activities associated with the providing of digital media commerce services, as well as the analytics associated with any of the aforementioned data and/or information, with respect to the services provided related to digital media commerce.

The apparatus and method of the present invention can be constructed to enable the storing of data related to the creation and/or development, processing and/or fulfillment, publication and/or management of digital media commerce services based upon data and/or information regarding the actual digital media and/or digital media commerce products and/or services provided and/or offered by the digital media creator and/or developers, including, but not limited to audio, video, photos, drawings, text, holographs, images, data, information, hyper-links, programs, applications, applets, code, scripts, files, avatars, pixel content and/or digital media, clear gifs, web beacons, games, movies, television, broadcasts, podcasts, blogs, tweets, posts, narrowcasts, voice, text, signals, warnings, prompts, advertisements, offers, solicitations, promotions, confirmations, tickets, receipts, content, digital content, aggregated information, media and/or digital media commerce products and/or services, notifications, controls, communications, signals, warnings, prompts, requests, restrictions, limitations, monitoring functions, management operations, advertisements, offers, solicitations, promotions, activations, authorizations, authentications, rules, policies, practices, aggregated information, implementations, dissolutions, disallowances, touches, tastes, smells, movements, actions, reactions, and/or an embodiment of information, and/or an embodiment of control functionality, (hereinafter which may be referred to collectively as “media and/or digital media commerce products and/or services” or “media and/or digital media commerce products and/or services”).

The apparatus and method of the present invention includes a computer-implemented system for digital media commerce creation and/or development, wherein the computer-implemented system provides enabling tools, systems, and services enabling the creation and/or development of digital media, and/or digital media products and/or services. The tools, systems, and services may be both static and persistent, such as lasting beyond the operation of a pre-defined media commerce and/or media creation action, or dynamic and temporary which ceases to exist after completing its pre-defined media commerce and/or media creation action. Further processing functions can include the assessment of the request to create and/or develop digital media, and/or to establish a commercial relationship made by the requestor, the collection of communication account information, financial account information, other personal identifiable information, credit information, personal financial information, demographic information, security information, information necessary to establish a legitimate commercial relationship between the requestor of the digital media commerce service, the provider of the digital media and/or digital media commerce products and/or services, and the digital media commerce service provider, as well as confirmations, consent, permissions, and links to third-party entities which may be required to establish the commercial and/or technical relationships needed to establish the commercial and technical functionality requested and agreed to by the digital media and/or digital media commerce products and/or services requestor, the digital media creator and/or developer, and the digital media commerce service provider.

The apparatus and method of the present invention includes a computer-implemented digital media commerce processing and/or fulfillment system of digital media commerce functions pursuant to the outcome of the processing function of the request for digital media commerce products and/or services, wherein the computer-implemented system fulfills agreed commercial and technical actions pursuant to the information and agreements of the processing function on behalf of digital media commerce service users of any of the respective digital media commerce services described herein and/or to the providers of the digital media commerce described herein. Further processing and/or fulfillment functions can include an assessment of inventory of digital media commerce that would meet the parameters of the requestor, an assessment of inventory of digital media commerce that would meet the parameters of the digital media creator and/or developer, a proposal for pairing the commercial and/or technical interests of the requestor, the digital media creator and/or developer, and the digital media commerce service provider.

The apparatus and method of the present invention includes a computer-implemented digital media commerce publication and/or management system of digital media, wherein the computer-implemented system manages the various commercial, technical, and operational aspects of the relationship established between the requestor of the digital media commerce service, the provider of the digital media and/or digital media commerce products and/or services, and the digital media commerce service provider. Such management capabilities can include, but are not limited to, systems inventory, systems service inventory, systems component inventory, installation management, service and systems availability monitoring and metrics, user activities monitoring and logging, capacity monitoring, security management, storage management, network capacity and utilization monitoring, fault management, troubleshooting, error logging and data recovery, configuration management, automatic updates, upgrades, repairs, system complexity assessments, system risk assessments, energy use, system reuse capabilities, licensing, license management, rights management, digital rights management, rights acquisition, rights payments, rights accounting, provisioning, forecasting, needs assessment, modeling, training, deployment, dependencies assessment, automation, accounting management, billing, statistics, performance management, usage metering, user monitoring, user account, user sessioning, user authentication, user authorization, use rights, tracking usage, assessing usage to rights, application of analysis to metrics, recommendations, application of algorithms, control, monitoring, limiting, application of intelligent agents, parameter setting, restriction, prevention, event monitoring, metric monitoring, reliability assessment, error tracking, software bug detection, software bug repair, trend assessment, failure assessment, life expectancy analysis, security management, identity management, policy management, business impact functions, business systems management, capacity management, real-time application relationship discovery, configuration management, security information, event management, workload scheduling, performance management, end-to-end performance measuring, infrastructure component measuring, operational intelligence, real-time monitoring of non-systems events that relate to systems processes, business activity monitoring, business transaction management, registration, fulfillment of secondary and/or derivative commercial orders and/or commercial service requests and/or purchase made in conjunction with and/or as a result of the herein described digital media commerce services, as well as subscriptions, subscribing, further fulfillment of additional registration and/or subscription requests for digital media commerce services and/or out-bound digital media commerce services, communications, data, and/or any other digital content and/or link to data or content and/or any other good and/or services provided pursuant to a relationship, contractual and/or otherwise, which provides for a regular transaction between the parties and/or facilitated by an intermediary.

The apparatus and method of the present invention can be utilized for disseminating digital content and/or information to a subscriber and/or registrant of any digital product and service which can be provided in commerce.

The apparatus and method of the present invention described herein as the computer-implemented digital media commerce processing and/or fulfillment system may also be able to provide for the registration and/or subscription processing of registrations and/or subscriptions and/or requests concerning registrations and/or subscriptions, wherein the computer-implemented system establishes registrations and/or subscriptions and/or accounts associated with registrations and/or subscriptions on behalf of registrants and/or subscribers to any of the respective digital media commerce services described herein. The registration and/or subscription may be both static and persistent, such as lasting beyond the operation of a pre-defined media commerce action, or dynamic and temporary which ceases to exist after completing its pre-defined media commerce action. Further processing functions can include the assessment of the request to establish an account, a subscription, and/or a commercial relationship made by the requestor, the collection of communication account information, financial account information, other personal identifiable information, credit information, personal financial information, demographic information, security information, information necessary to establish a legitimate commercial relationship between the requestor of the digital media commerce service, the provider of the digital media and/or digital media commerce products and/or services, and the digital media commerce service provider, as well as confirmations, consent, permissions, and links to third-party entities which may be required to establish the commercial and/or technical relationships needed to establish the commercial and technical functionality requested and agreed to by the digital media and/or digital media commerce products and/or services requestor, the digital media creator and/or developer, and the digital media commerce service provider.

The apparatus and method of the present invention described herein as the computer-implemented digital media commerce processing and/or fulfillment system may also be able to provide for the registration and/or subscription fulfillment of registrations and/or subscriptions pursuant to the outcome of the processing function of the request for registration and/or subscription, wherein the computer-implemented system fulfills agreed commercial and technical actions pursuant to the information and agreements of the processing function on behalf of registrants and/or subscribers to any of the respective digital media commerce services described herein and/or to the providers of the digital media commerce described herein. Further fulfillment functions can include an assessment of inventory of digital media commerce that would meet the parameters of the requestor, an assessment of inventory of digital media commerce that would meet the parameters of the digital media creator and/or developer, a proposal for pairing the commercial and/or technical interests of the requestor, the digital media creator and/or developer, and the digital media commerce service provider.

The computer-implemented digital media creation and/or development system, the computer-implemented digital media commerce processing and/or fulfillment system, and the computer-implemented digital media commerce publication and/or management system, are all systems that may exist in a multitude of hardware, software, and network configurations, wherein all and/or some components may be located in or at the same location, remote locations, in a network, on a server, network computer, on a client device, or in some combination of the above. Increasingly as more communications functionality is able to be performed by software, and increasingly communications and computing systems resources can be partitioned and used to execute functions which would have in the past required distinct systems, any and all of the functions described as being unique to either the computer-implemented digital media creation and/or development system, the computer-implemented digital media commerce processing and/or fulfillment system, and the computer-implemented digital media commerce publication and/or management system can also be seen as functions occurring in a single computer-implemented system.

The apparatus and method of the present invention also includes at least one or more receiving devices which function as a first receiving device to receive the request for digital media commerce described herein. This receiving device may be a single or multiple device configurations working in conjunction with the computer-implemented system media commerce creation and/or development, processing and/or fulfillment, publication and/or management which serves to receive information from the individual making the request for the digital media commerce services.

The apparatus and method of the present invention also includes at least one or more receiving devices which serve as the second receiving device to receive the actual digital media and/or digital media commerce products and/or services described herein. The receiving device and the aforementioned communication device may be the same device or different devices as is designated by the individual and/or entity making the request for the digital media and/or digital media commerce products and/or services. By example, the first device may be a smartphone, or similarly a personal computer, a computing workstation, a tablet personal computer, or other communications and/or computing device, wherein the request to receive digital media and/or digital media commerce products and/or service is sent by the individual and/or entity making the request for the digital media commerce service, who is also the account holder of the smart phone, and this same smartphone may in-fact be the same device that is then registered to be the receiving device for the digital media and/or digital media commerce products and/or services.

The apparatus and method of the present invention also includes at least one or more transmitting devices which function as a first transmitting device to enable the sending of the response to the request for digital media and/or digital media commerce services described herein. This transmitting device may be a single or multiple device configurations working in conjunction with the computer-implemented system which serves to transmit information to the individual making the request for the digital media commerce service.

The apparatus and method of the present invention also includes at least one or more transmitting devices which serve as the second transmitting device to transmit the commercial and/or technical information regarding the digital media commerce service described herein. The transmitting device and the aforementioned communication device may be the same device or different devices as is designated by the individual and/or entity making the transmission of the service request associated with the digital media commerce service. The transmitting and receiving device may be the same or separate devices. By example, the first receiving device may be a web browser on a personal computer wherein the request to receive digital media and/or digital media commerce products and/or services is sent by the individual and/or entity making the request for the digital media commerce service, who is also the account holder of a web-based email account accessed by the browser on that personal computer, while at the same time the individual user may make a request to have the digital media and/or digital media commerce products and/or services sent both to the said email account and also to a mobile phone account associated with that individual.

Concerning the apparatus and method of the present invention, collectively speaking, the first transceiver and first receiver of the digital media commerce system may be referred to as the first communications device, wherein the second transceiver and second receiver of the digital media commerce system may be referred to as the second communications device.

The apparatus and method of the present invention also includes a synching capability enabling the transmission of information regarding digital media commerce between user devices and accounts in instances where the digital media commerce user has multiple devices and/or communications accounts to which they would like to have the digital media commerce functionality replicated. This synching capability can include the transmission of signals to/from devices and/or accounts under the direction of the digital media commerce user, and receiving signals from a separate communication device and/or account. Such synching capabilities may occur in both a client-server based, quantum computing based, quantum storage based, network computer-client and/or client-to-client manner wherein information regarding the inbound media and/or digital media commerce products and/or services service, related code, content, rights, and parameters of the commercial and technical capabilities are transmitted in a fashion as to enable the addition and/or removal of various receiving and/or transmitting devices controlled by the user utilizing the digital media commerce service. In this manner, any of the parameters and/or instructions regarding creation and/or development, processing and/or fulfillment, publication and/or management computer-implemented systems, and/or the communication device, and/or receiver, and/or transmitter are communicated, updated, and coordinate digital media commerce functions with each other.

A plurality of communication devices can be utilized in conjunction with the apparatus and method of the invention, with each device being utilized for similar and/or for separate functions related to digital media commerce, and may exist at the same or a multitude of locations. The digital media commerce system is designed to so as to serve a multitude of concurrent users and thus a plurality of communication devices can be utilized with each communication device being associated with a subscriber and/or registrant, and more than one communications device may be registered with each subscriber and/or registrant. The communication device can be a privately owned, leased rented, borrowed, or shared device, and may also be located at a public location and may be a public kiosk, billboard, display, speaker, microphone, point-of-sale device, computer, telephone, and/or similar communications and/or computing device enabling digital media commerce transmissions.

The digital media commerce computer-implemented systems described herein for subscription and/or registration creation and/or development, processing and/or fulfillment, publication and/or management may be a single computer and/or computer system and/or may include a plurality of computers and/or computer systems. Similarly, any of the components of each of these systems may in itself be a single system and/or computer or set of multiple computers or computer-implemented systems.

The apparatus and method of the present invention may be utilized in conjunction with, on, or over, a plurality of communications and/or computing networks, and/or systems, which may include, but are not limited to, any one or any combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, geo synchronous satellite systems, as well as in, or on any internets and/or intranets, computing networks, cloud computing systems, server, network computers, client devices, client-server based, quantum computing based, quantum storage based, network computer architectures, communications networks, terrestrial networks, undersea networks, mobile networks, satellite networks, mesh networks, the Internet, World Wide Web, WWW2, WWW3, Semantic Web, closed circuit networks, open networks, radio networks, optical networks, pulse networks, digital networks, wave networks, light networks, neural networks, chemical networks, materials networks, biological networks, radiation networks, energy wave networks, and/or particle based networks, and/or where it may occur in a supra-global network environment, global network environment, trans-national network environment, national network environment, wide area network environment, metropolitan area network environment, local area network environment, personal network area environment, inter-being network environment, intra-being network environment, human-to-machine network environment, machine-to-machine network environment, and/or human-to-non-human network environment, and any other suitable communication network or system.

The apparatus and method of the present invention can also be utilized on, or over, any other suitable communication combination of communication and/or computing networks.

The apparatus and method of present invention can be utilized to request, process, provision, fulfill, and manage digital media commerce services, sessions, subscriptions and/or registrations. This functionality pertains to new, renewed, extended, terminated, and cancelled services, sessions, subscriptions and/or registrations.

The apparatus and method of the present invention can facilitate the provisioning, fulfillment, and/or management of services, and/or subscriptions and/or registrations related to digital media commerce in a network environment in a manner affording flexibility in the length and/or the duration of the service, subscription and/or registration.

The apparatus and method of the present invention can also provide a fulfillment clearinghouse function, wherein, the apparatus and method of the present invention can also provide notification to subscribers and/or other parties regarding digital media commerce offers, events, occurrences, promotions, happenings, discounting, incentives, and/or benefits regarding digital media commerce and/or services and/or products related to and/or derived from the service of and/or associated with enabling media commerce in a digital environment services.

The apparatus and method of the present invention can be utilized in conjunction with subscriptions, and/or registrations involving digital communications, the transmission of data, information, digital content, and/or any other information, and/or digital entertainment content, and/or data, information, and/or content which can be transmitted over any of the herein described networks, and/or provisioned in conjunction with any of the herein described networks and delivered outside any of the herein described networks.

The media and/or digital media commerce products and/or services described herein which are associated with digital media commerce may themselves be, or be associated with, or be of the nature of, media and/or digital media commerce products and/or services in digital form or electronic media and/or digital media commerce products and/or services, and/or media and/or digital media commerce products and/or services in any other form suited to carry digital media and/or digital media commerce products and/or services, can be utilized in conjunction with any digital good and/or service which can be the subject of commerce, and can involve, but not be limited to, media and/or digital media commerce products and/or services for and/or regarding offers to sell, offers to buy, offers to license, offers to barter, offers to trade, solicitations, promotions, advertisements, digital content, digital information, physical goods, commercial goods, merchandise, industrial goods, consumer goods, digital services, physical services, commercial services, industrial services, movie rentals, video rentals, tickets, event tickets, program tickets, permissions, movie tickets, show tickets, airline tickets, bus tickets, postage stamps and/or postage, meals tickets, tickets to sporting events, tickets to entertainment events, tickets to theater performances, statements, reports, transaction reports, confirmations, status updates, communications, services, professional services, contracted for services, and/or any other good and/or service which can be the subject of commerce.

Any of the communications which occur and/or which transpire between any of the computers and/or devices, and/or which occurs between any digital media publisher and/or manager and/or intermediaries and/or registrants, and/or offering parties, and/or contracting parties, and/or media commerce parties, and/or operators and/or administrators of any of the computers and/or devices, can be effectuated by or via electronic communications, digital communications, telecommunications, electronic mail (e-mail), electronic media and/or digital media commerce products and/or services transmission, digital displays, digital speakers, digital instrumentation, electronic data transfer, electronic payment system, digital payment system, digital communications system, digital communications service, telephone media and/or digital media commerce products and/or services, voice mail media and/or digital media commerce products and/or services, pager media and/or digital media commerce products and/or services, beeper media and/or digital media commerce products and/or services, conventional mail letter or media and/or digital media commerce products and/or services, letter, telephone call, and/or any other manner and/or mode of communication.

The present invention can provide for, and can perform digital media commerce processing and/or fulfillment services for, and regarding, media and/or digital media commerce products and/or services and/or digital media commerce which have flexibility as to when digital media commerce products and/or services are obtained and/or skipped while still providing the using entity and/or individual user and/or subscriber and/or registrant with the value of, and/or with the number of digital media commerce products and/or services for which the using entity and/or individual user and/or subscriber and/or registrant has contracted. The amount of usage rights and/or consumption and/or presentation rights and/or subscription flexibility can be dictated by any party to the usage rights and/or consumption and/or presentation rights and/or subscription and/or registration as part of the process of processing, fulfilling, and/or managing the usage rights and/or consumption and/or presentation rights and/or subscription and/or registration.

The creation and/or development, processing and/or fulfillment, publication and/or management computer-implemented system can provide digital media commerce services for any number and/or type of media and/or digital media commerce products and/or services, in succession and/or in parallel, to any one or more individuals, communication devices, and/or communication accounts.

The apparatus and method of the present invention can provide for usage rights and/or consumption and/or presentation rights and/or subscriptions and/or registrations for media and/or digital media commerce products and/or services which can be initiated and/or created via any type of communication device and/or any type of computer enabled and/or network enabled transaction device, or e-commerce computer enabled and/or network enabled device.

The apparatus and method of the present invention can provide for services, operations, and/or functions regarding digital media commerce to be processed, fulfilled, and/or managed by a plurality of communications devices, and/or computer enabled and/or network enabled devices, of which such communications and computer enabled and/or network enabled devices may be one in the same.

In the apparatus and method of the present invention, the delivery of the media and/or digital media commerce products and/or services associated with the digital media and/or digital media commerce products and/or services can be delivered, provided, transmitted, and/or serviced by any communications enabled system, and/or any communications entity, and/or other communications and/or media commerce facility. In this manner, an using entity and/or individual user and/or subscriber and/or registrant may initiate a usage rights and/or consumption and/or presentation rights and/or subscription and/or registration for digital media and/or digital media commerce products and/or services and associate that digital media and/or digital media commerce products and/or services with any and all types of media and/or digital media commerce products and/or services which can be transmitted either directly from one entity and/or individual and/or location and/or device to another, in any permutations of plurality of individuals, entities, locations, and/or devices, and/or either indirectly over a communications and/or computing network from one entity and/or individual and/or location to another, in a any permutations of plurality of individuals, entities, locations, and/or devices.

In the apparatus and method of the present invention can effectuate digital media commerce a single point of time, over a period of time, prior to a scheduled event, during a scheduled event, following a scheduled event, with a time delay, and/or at a predetermined time, and/or a random time. By example, digital media commerce may occur in such a manner, but is not limited to such media commerce activities associated with transactions, transactions associated with online commerce, in-store commerce, computer enabled and/or network enabled machine transactions, e-commerce computer enabled and/or network enabled devices and/or systems, occurring at a commercial locations, and/or occurring either before, during, and/or after the transaction. In this manner, flexibility is provided regarding the timing of the digital media commerce delivery.

The entity and/or individual user and/or subscriber, registrant, and/or agent thereof, and/or other third party intermediary, can access the computer-implemented content and/or digital media creation and/or development, processing and/or fulfillment, publication and/or management system, via one of the herein referenced communication devices and/or via the computer enabled and/or network enabled transaction device so as to ascertain the status of usage rights and/or consumption and/or presentation rights and/or subscription and/or registration such as, but not limited to, whether the usage rights and/or consumption and/or presentation rights and/or subscription is active or inactive, and/or the fulfillment status of the usage rights and/or consumption and/or presentation rights and/or subscription and/or registration, such as, but not limited to, the number of media and/or digital media commerce products and/or services remaining, type of media and/or digital media commerce products and/or services remaining, time for next utilization of media and/or digital media commerce products and/or services, and/or content associated with the parties to the media commerce transaction.

The computer-implemented content and/or digital media creation and/or development, processing and/or fulfillment, publication and/or management system can also notify digital media publisher and/or manager and/or intermediaries and/or registrants via any means, method and/or manner of communication, via the communication device and/or the computer enabled and/or network enabled transaction device, of available digital media commerce, of digital media and/or digital media commerce products and/or services promotions, of renewal notices, extension notices, termination notices, digital media and/or digital media commerce products and/or services creation and/or initiation notices, media and/or digital media commerce products and/or services and/or digital media and/or digital media commerce products and/or services delivery, and/or of any other information related to digital media commerce which may be of interest to a using entity and/or individual user and/or subscriber and/or registrant.

The apparatus and method of the present invention can be utilized as a media commerce clearinghouse, to match digital media creators and/or developers, digital media publisher and/or manager and/or intermediaries, and/or digital media commerce service and/or product providers, and/or digital media commerce products and/or services, wherein information regarding any number of, and types of, media and/or digital media commerce products and/or services can be stored in the computer-implemented content and/or digital media creation and/or development, processing and/or fulfillment, publication and/or management system. An entity and/or individual user and/or subscriber and/or registrant to the digital media commerce service can access the respective computer-implemented content and/or digital media creation and/or development, processing and/or fulfillment, publication and/or management system and search for a desired digital media and/or digital media commerce products and/or services, brand, offer, promotion, incentive, company, organization, and/or entity offering digital media commerce, digital media and/or digital media commerce products and/or services content, data, information, and/or related digital media and/or digital media commerce products and/or services and/or products. The entity and/or individual user and/or subscriber and/or registrant may then request, apply for, offer, counter-offer, and/or receive the digital media and/or digital media commerce products and/or services, and pursuant to the commercial terms between the parties, receive and/or make payment for, and/or receive and/or give consideration for, and/or purchase and/or sell digital media and/or digital media commerce products and/or services and any and all associated data, information, and/or content as described herein. Similarly, digital media commerce provider of data, information, and/or content as described herein can access the respective computer-implemented content and/or digital media creation and/or development, processing and/or fulfillment, publication and/or management system and search for a desired recipient of digital media and/or digital media commerce products and/or services, content, data, information, brand, offer, promotion, incentive, company, organization, and/or entity offering digital media commerce, digital media and/or digital media commerce products and/or services content, data, information, and/or related digital media and/or digital media commerce products and/or services and/or products. The digital media commerce provider may then offer, counter-offer, deliver, and/or receive the digital media and/or digital media commerce products and/or services, and pursuant to the commercial terms between the parties, receive and/or make payment for, and/or receive and/or give consideration for, and/or purchase and/or sell, and/or license digital media and/or digital media commerce products and/or services and any and all associated data, information, and/or content as described herein. Furthermore, an entity and/or individual user and/or subscriber and/or registrant can list a request and/or place an order for digital media and/or digital media commerce products and/or services over the computer-implemented content and/or digital media creation and/or development, processing and/or fulfillment, publication and/or management system, and/or have it stored there, and/or have it paired, and/or designate criteria for having the request met. The computer-implemented content and/or digital media creation and/or development, processing and/or fulfillment, publication and/or management system can thereafter process the order and/or request, and/or execute the request, and/or notify the entity and/or individual user and/or subscriber by any designated means including the entity and/or individual user and/or subscriber's and/or registrant's communication device and/or the computer enabled and/or network enabled transaction device if, when, and under which terms the requested digital media and/or digital media commerce products and/or services is available. Similarly, digital media creator and/or developer can list a request and/or place an offer for digital media and/or digital media commerce products and/or services over the computer-implemented content and/or digital media creation and/or development, processing and/or fulfillment, publication and/or management system, and/or have it stored there, and/or have it paired, and/or designate criteria for having the request met. The computer-implemented content and/or digital media creation and/or development, processing and/or fulfillment, publication and/or management system can thereafter process the order and/or request, and/or execute the request, and/or notify the digital media creator and/or developer by any designated means including the digital media creator and/or developers communication device and/or the computer enabled and/or network enabled transaction device if, when, and under which terms the requested digital media and/or digital media commerce products and/or services is being made available.

The apparatus and method of the present invention can be utilized in conjunction with a bidding service to match digital media creators and/or developers, digital media publisher and/or manager and/or intermediaries, and/or digital media commerce service and/or product providers, and/or digital media commerce products and/or services, wherein information regarding any number of, and types of, media and/or digital media commerce products and/or services can be stored in the computer-implemented content and/or digital media creation and/or development, processing and/or fulfillment, publication and/or management system. An entity and/or individual user and/or subscriber and/or registrant, and/or digital media creator and/or developer, and/or digital media commerce service provider, and/or provider of affiliated digital media commerce services can access the respective computer-implemented content and/or digital media creation and/or development, processing and/or fulfillment, publication and/or management system and place a bid on digital media and/or digital media commerce products and/or services, and/or digital media commerce service, and/or an affiliated digital media commerce service and/or good. Similarly, the bidding service may also be used in conjunction with the search service. Likewise, digital media publisher and/or manager and/or intermediary, digital media creator and/or developer, and/or digital media commerce service provider, and/or digital media creator and/or developer of affiliated services, can list and/or submit a bid for digital media and/or digital media commerce products and/or services and/or digital media and/or digital media commerce products and/or services related service, over the computer-implemented subscription processing, computer-implemented subscription fulfillment, and computer-implemented content and/or digital media publication and/or management system, and/or have it stored there, and/or have it paired, and/or designate criteria for having the bid accepted, the bid fulfilled, and/or the request met. The computer-implemented content and/or digital media creation and/or development, processing and/or fulfillment, publication and/or management system can thereafter process the order and/or request associated with the bid, and/or execute the request, and/or notify the digital media creator and/or developer by any designated means including the digital media creator and/or developers communication device and/or the computer enabled and/or network enabled transaction device if, when, and under which terms the requested digital media and/or digital media commerce products and/or services and/or digital media and/or digital media commerce products and/or services service is being made available.

The digital media commerce entity and/or individual user and/or subscriber and/or registrant, and/or the digital media and/or digital media commerce products and/or services provider, and/or agent thereof, may be notified via electronic communications, telecommunications, digital communications, network based communications, instant media and/or digital media commerce products and/or services, blog, tweet, e-mail, electronic transmission, pager media and/or digital media commerce products and/or services, beeper media and/or digital media commerce products and/or services, telephone call, telephone media and/or digital media commerce products and/or services, letter, voice media and/or digital media commerce products and/or services, physical mail delivery, and/or via any other appropriate means, method and/or technique.

Any of the computer-implemented content and/or digital media creation and/or development, processing and/or fulfillment, publication and/or management system elements, the communication devices, and/or including the computer enabled and/or network enabled transaction device, and/or including the e-commerce enabled computer and/or network enabled device and/or system can be programmed for automatic operation, self-activation, and/or programmed operation, and as well may be done so remotely over a network. The computer-implemented content and/or digital media creation and/or development, processing and/or fulfillment, publication and/or management system and/or the central subscription and/or registration fulfillment processing computer can be programmed to automatically generate and/or to transmit media and/or digital media commerce products and/or services and/or notices to any of the digital media commerce entity and/or individual user and/or subscribers, registrants, providers, service providers, commercial entities being represent by and/or affiliated with the digital media commerce, computer enabled and/or network enabled media commerce computers, wholesalers, sellers and/or buyers of commercial goods and/or services, goods and/or services providers, regarding subscriptions and/or registrations, subscription and/or registration fulfillment, provisioning, and/or management functions and/or states, the availability of digital media commerce, media and/or digital media commerce products and/or services available for media commerce, forecasts of media and/or digital media commerce products and/or services available for media commerce, calculations and/or analysis concerning digital media commerce and/or media and/or digital media commerce products and/or services being tagged, having been tagged, and/or potentially available for media commerce, availability of goods and/or services which are the subject of digital media and/or digital media commerce products and/or services.

It is another object of the present invention to provide for intelligent agents, software agents, algorithms, computer code, applications, applets, and/or mobile agents, which can be utilized so as to act on behalf of any of the parties and/or any of the respective computers and/or devices described herein.

Accordingly, it is another object of the present invention to provide when necessary an apparatus and a method for enabling for the creation, development, processing, fulfillment, publication, management, and/or consumption and/or presentation pertaining to actual media commerce services, including the actual transmission of media and/or digital media commerce products and/or services, in conjunction with the enablement of the offering, provisioning, processing, fulfillment, and/or management of service related to the delivery and management of digital media commerce.

It is another object of the present invention to provide an apparatus and a method for enabling media commerce in a digital environment services in a network environment.

It is still another object of the present invention to provide an apparatus and a method for enabling for the creation, development, processing, fulfillment, publication, management, and/or consumption and/or presentation pertaining to digital media commerce services which allows an entity and/or individual user and/or subscriber and/or registrant, and/or agent thereof to control the manner in which the digital media and/or digital media commerce products and/or services are delivered.

It is yet another object of the present invention to provide an apparatus and a method for providing, fulfilling, and/or managing digital media commerce services which provide for flexibility, as to time, location, and/or goods, and/or product, and/or services provider, and/or communications services provider, in the operation execution and/or transmission of the transaction of the digital media commerce services.

It is another object of the present invention to provide an apparatus and a method for providing, fulfilling, and/or managing digital media commerce services which provides for digital media and/or digital media commerce products and/or services which is/are characterized by a session and/or subscription and/or registration period, term and/or duration, which allows an using entity and/or individual user and/or subscriber and/or registrant to skip media and/or digital media commerce products and/or services, which are the subject of the session, and/or the subscription, and/or the registration while still allowing the using entity and/or individual user and/or subscriber and/or registrant to obtain and/or to benefit from the value of the session, and/or the subscription, and/or the registration.

It is still another object of the present invention to provide an apparatus and a method for providing, fulfilling, and/or managing digital media commerce services which facilitates an initiation of a session and/or subscription and/or registration, a renewal of a session and/or subscription and/or registration, an extension of a session and/or subscription and/or registration, and/or the cancellation and/or termination of a session and/or subscription and/or registration.

It is yet another object of the present invention to provide an apparatus and a method for providing, fulfilling, and/or managing digital media commerce services which provides notification to an entity and/or individual user and/or subscriber and/or registrant regarding media and/or digital media commerce products and/or services, status of their media and/or digital media commerce products and/or services, sessions, subscriptions and/or registrations, information regarding fulfillment of digital media commerce services and/or subscriptions and/or registrations, and/or status of fulfillment of their media and/or digital media commerce products and/or services, sessions, subscriptions and/or media and/or digital media commerce products and/or services registrations.

It is another object of the present invention to provide an apparatus and a method for providing, fulfilling, and/or managing digital media commerce services which provides for a flexible media and/or digital media commerce products and/or services, sessions, subscription and/or registration as well as a flexible media and/or digital media commerce products and/or services fulfillment.

It is yet another object of the present invention to provide an apparatus and a method for providing, fulfilling, and/or managing digital media commerce services, sessions, subscription and/or registration services which provides and/or processes media and/or digital media commerce products and/or services, sessions, subscription initiations, renewals, extensions, and/or terminations.

It is another object of the present invention to provide an apparatus and a method for providing, fulfilling, and/or managing digital media commerce services which can be utilized in conjunction with computer enabled and/or network enabled transaction devices, personal computers, computing workstations, server, network computers, electronics devices, video and/or audio recorders, personal communication devices, public communication devices and/or kiosk, billboard, display, speaker, microphone, point-of-sale device, computer, telephone, and/or similar communications and/or computing device enabling digital media commerce transmissions.

It is still another object of the present invention to provide an apparatus and a method for providing, fulfilling, and/or managing digital media commerce services which can be utilized on, over, and/or in conjunction with, any communication system.

It is yet another object of the present invention to provide an apparatus and a method for providing, fulfilling, and/or managing digital media commerce services which can be utilized on, over, and/or in conjunction with, the Internet and/or the World Wide Web, and/or other communications and/or computing networks and/or systems described herein, and/or network linking communications devices and/or computing devices.

It is another object of the present invention to provide an apparatus and a method for providing, fulfilling, and/or managing digital media commerce services which provides for a computer-implemented method for processing, fulfilling, and managing digital media commerce related to any kind and/or type of media commerce.

It is still another object of the present invention to provide an apparatus and a method for providing, fulfilling, and/or managing digital media commerce services which provides for processing of service, session, and/or subscription, and/or registration payment information, and/or payments, and/or settlement information, and/or settlements.

It is another object of the present invention to provide an apparatus and a method for providing, fulfilling, and/or managing digital media commerce services which provides a clearinghouse for matching digital media commerce entity and/or individual user and/or subscribers to digital media commerce, and/or offers for digital media commerce.

It is another object of the present invention to provide an apparatus and a method for providing, fulfilling, and/or managing digital media commerce services which provides a clearinghouse for matching digital media creators and/or developers to/with other entities and/or individual users and/or subscribers of/for digital media commerce, and/or offers for digital media commerce.

It is still another object of the present invention to provide an apparatus and a method for providing, fulfilling, and/or managing digital media commerce services which provides for an apparatus which is programmed to provide any of the functionality described herein.

It is yet another object of the present invention to provide an apparatus and a method for providing, fulfilling, and/or managing digital media commerce services which can be utilized in conjunction with intelligent agents, software agents, algorithms, computer code, applications, applets, and/or mobile agents, which can be utilized so as to act on behalf of any of the parties and/or any of the respective computers and/or devices described herein.

In the apparatus and method of the present invention any number of computer-implemented systems can be utilized so as to perform the operations and/or functions described herein. The computer-implemented system can be linked to any other computer implemented system or may be a stand-alone system.

The apparatus of the present invention can also include a programming input, such as a live feed, which can be connected or linked with the computer-implemented system and which can transit live content and/or digital media to the computer-implemented system for digital media commerce to be executed in conjunction with communication devices, computing devices, and/or transaction devices which can include, but which are not limited to, a television, a personal computer, mobile telephone, personal digital assistant, netbook, smartphone, public display device for video and/or audio, or any other suitable communication and/or display device. The programming input, and/or live feed system can, for example include a video camera, a microphone, or any other video and/or audio and/or signal transmission and/or recording device or system, and any other attendant systems and/or devices, and can be located at any location, at or in any type of premises, and/or at or in any type of vehicle.

The apparatus and method of the present invention can also include a ratings computer which is connected to or linked with the computer-implemented system. The ratings computer can include a database which stores information regarding various ratings and viewership information for various pieces of content and/or media which may be subject to commerce in a digital environment. Ratings information can be transmitted to the ratings computer from a ratings provider communication device and/or from the computer-implemented system, and may be utilized by any ratings reporting service, organization, agency, station, network, service provider, and/or search provider. Ratings information can also be input into the ratings computer via any number of input devices. Any number of ratings computers can be utilized in the apparatus and method of the present invention.

The apparatus and method of the present invention can also include an advertisement/marketing computer which is connected to or linked with the computer-implemented system. The advertisement/marketing computer can include a database which stores advertisements, commercials, links, hyperlinks, video, audio, banners, buttons, clips, URL's content and/or digital media, frames, logos, icons, surveys, questionnaires, market research tools, promotions, offers, and/or other marketing content, code, and/or related promotional and/or research functionality. The information described herein as being stored in the database of the advertisement/marketing computer can be transmitted to/from the advertisement/marketing provider communication device which can be connected to and/or linked with the advertisement/marketing computer and/or the transmitted to/from the computer-implemented system. The advertising/marketing computer can be connected to or linked with the other devices and/or systems via any communication network described herein.

The apparatus and method of the present invention can also include a print publishing computer which is connected to or linked with the computer-implemented system. The print publishing computer can include a database which stores content and/or digital media, advertisements, images, text, commercials, links, hyperlinks, video, audio, banners, buttons, clips, URL's content and/or digital media, frames, logos, icons, surveys, questionnaires, market research tools, promotions, offers, and/or other print publishing content, code, and/or related promotional and/or functionality which is suitable for either physical printing, such as but not limited to paper printing, and/or digital printing, such as but not limited to digital billboards. The information described herein as being stored in the database of the print publishing computer can be transmitted to/from the print publishing provider communication device which can be connected to and/or linked with the print publishing computer and/or the transmitted to/from the computer-implemented system. The print publishing computer can be connected to or linked with the other devices and/or systems via any communication network described herein.

In the apparatus and method of the present invention, a real-time and/or immediate alert can also be provided to a user as a function of the computer-implemented system. The herein described alert feature can be used to provide information about content and/or digital media availability, and/or information concerning the commercial transaction related to content and/or digital media.

The apparatus and method of the present invention enables the consumer of the content and/or digital media to either dynamically, and/or manually, assemble the content and/or digital media which the user would like to consume as a computational function of the computer-implemented system. This personal assemblage of content and/or digital media may contain any single or multitude of types or elements of content, digital media, advertisements, ratings, and the like, as described herein. Further, this personal assemblage of content and/or digital media may be consumed in any single or multitude of communications, computing, display, and/or print elements described herein. The information comprising the personal assemblage of content and/or digital media described herein can be stored in the database of a device associated with the user, and/or in the database of the computer-implemented system. It may likewise be transmitted to/from the various communication devices described herein and in conjunction with any of the communication network described herein.

The apparatus and method of the present invention can also be utilized to allow an advertiser, such as a vendor of any product, service, and/or good, or an agent thereof, or a third-party acting on behalf of a advertisers and vendors to purchase, in an on-line and/or in a real-time environment, and advertisement placement where that advertisement, and/or offering, may be inserted into the content and/or digital media pursuant to the terms identified by the parties with a commercial interest in the content and/or digital media.

In the apparatus and method of the present invention, descriptive and/or identifying meta-data regarding the content and/or digital media may be linked to, embedded into, and/or attached to the actual content and/or digital media asset.

In the apparatus and method of the present invention, usage parameters, such as but not limited to, metering may be used to provide the content and/or digital media transacting parties with a value measurement related to usage of content and/or digital media for the purpose of establishing rights and costs. Such usage parameters may be linked to, embedded into, and/or attached to the actual content and/or digital media asset, and/or an account related to the buying, selling, usage, and/or licensing transaction for the content and/or digital media.

Other objects and advantages of the present invention will be apparent to those skilled in the art upon a review of the Description of the Preferred Embodiment taken in conjunction with the Drawings which will follow.

### BRIEF DESCRIPTION OF THE DRAWINGS

In the Drawings:

FIG. 1 illustrates the apparatus of the present invention, in block diagram form;

FIG. 2 illustrates the computer-implemented content and/or digital media creation and/or development system of FIG. 1, in block diagram form;

FIG. 3 illustrates the computer-implemented content and/or digital media processing and/or fulfillment system of FIG. 1, in block diagram form;

FIG. 4 illustrates the communication device of FIG. 1, in block diagram form;

FIG. 5 illustrates the computer enabled and/or network enabled transaction device of FIG. 1, in block diagram form;

FIG. 6 illustrates a flow diagram of a preferred embodiment operation of the present invention in initiating a session/operation/subscription/consumption request;

FIGS. 7A and 7B illustrate a flow diagram of a preferred embodiment operation of the present invention in providing execution and/or transmission services for content and/or digital media services and/or transactions;

FIGS. 8A and 8B illustrate a flow diagram of another preferred embodiment operation of the present invention in providing execution and/or transmission services for content and/or digital media services and/or transactions;

FIG. 9 illustrates the computer-implemented content and/or digital media publication and/or management system of FIG. 1, in block diagram form;

FIGS. 10A, 10B, and 10C illustrate a flow diagram of a preferred embodiment operation of the present invention in providing content and/or digital media publication and/or management and/or third-party derivative services;

FIG. 11 illustrates a flow diagram of a preferred embodiment operation of the present invention processing and/or fulfillment for digital media and/or digital media commerce products and/or services;

FIG. 12 illustrates the computer-implemented content and/or digital media consumption and/or presentation system of FIG. 1, in block diagram form.

### DESCRIPTION OF THE PREFERRED EMBODIMENTS

The present invention pertains to an apparatus and method for enabling media commerce in a digital environment that overcomes the shortcomings of the prior art. The present invention pertains to an apparatus and method for media commerce computer-implemented system, which provides enhanced products and/or services for business, communications, entertainment, and other industries and individuals who or which utilize same.

The apparatus and method of the present invention, in a preferred embodiment, provides a system and/or platform to perform media commerce in a digital environment by which digital media creators and/or developers, and/or digital media commerce service providers, and/or digital media publishers and/or managers and/or intermediaries, and/or consumers of the digital media products and/or services may create, develop, process, fulfill, publish, manage, consume, and/or otherwise engage in media commerce in a digital environment.

The apparatus and method of the present invention, in a preferred embodiment, provides a computer-implemented system, comprising: receiving a request to collaborate through a computer-implemented system for creating and/or developing, and/or processing and/or fulfilling, and/or publishing and/or managing, and/or consuming, in regard to one or more of content, digital content, media, digital media, data, information, digital content transaction applications, digital content transaction services, digital content computing applications, digital content computing services, digital content communications applications, digital content communications services, periodicals, files, video, audio, images, avatars, pixel content and/or digital media, clear gifs, web beacons, voice, text, signals, hyper-links, programs, applications, applets, code, scripts, alerts, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, media and/or digital media commerce products and/or services, notifications, controls, communications, and/or an embodiment of information, and/or an embodiment of control functionality, (hereinafter which may be referred to collectively as “media and/or digital media commerce products and/or services” or “media and/or digital media commerce products and/or services”).

The apparatus and method of the present invention, in a preferred embodiment, provides a computer-implemented system, wherein the request for the media and/or digital media commerce products and/or services is transmitted in conjunction with, on, or over, a plurality of communications and/or computing networks, and/or systems, which may include, but are not limited to, any one or any combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, geo synchronous satellite systems, as well as in, or on any internets and/or intranets, computing networks, cloud computing systems, server, network computers, client devices, client-server based, quantum computing based, quantum storage based, network computer architectures, communications networks, terrestrial networks, undersea networks, mobile networks, satellite networks, mesh networks, the Internet, World Wide Web, WWW2, WWW3, Semantic Web, closed circuit networks, open networks, radio networks, optical networks, pulse networks, digital networks, wave networks, light networks, neural networks, chemical networks, materials networks, biological networks, radiation networks, energy wave networks, and/or particle based networks, and/or where it may occur in a supra-global network environment, global network environment, trans-national network environment, national network environment, wide area network environment, metropolitan area network environment, local area network environment, personal network area environment, inter-being network environment, intra-being network environment, human-to-machine network environment, machine-to-machine network environment, and/or human-to-non-human network environment, and any other suitable communication network or system.

The apparatus and method of the present invention, in a preferred embodiment, provides a computer-implemented system, wherein the request for the media and/or digital media commerce products and/or services is sent across the same network or at some point in the communication sent across different networks.

The apparatus and method of the present invention, in a preferred embodiment, provides a computer-implemented system, wherein the request for the media and/or digital media commerce products and/or services is sent as one or more of unsecured or secured by means of encryption.

The apparatus and method of the present invention, in a preferred embodiment, provides a computer-implemented system, wherein the device or devices associated with the requestor contain decryption software.

The apparatus and method of the present invention, in a preferred embodiment, provides a computer-implemented system, wherein the request for the media and/or digital media commerce products and/or services is made sent either directly from the initiating party and/or via a third party to the entity and/or individual user and/or subscriber and/or requestor.

The apparatus and method of the present invention, in a preferred embodiment, provides a computer-implemented system for processing information for creating or initiating a session and/or subscription and/or registration account for the requestor of and/or entity and/or individual user and/or subscriber to the second media and/or digital media commerce products and/or services or media and/or digital media commerce products and/or services, and/or media and/or digital media commerce products and/or services or digital media commerce, and further enabling the control, monitoring, management, policies, practices, aggregation, dissolution, implementation, disallowance, restriction, and limitation functionality with respect to the media and/or digital media commerce products and/or services communications and/or transactions via the session, and/or the subscription, and/or the registration account, and further where such control, monitoring, management, policies, practices, aggregation, dissolution, implementation, disallowance, restriction, and limitation may be executed either under the direct control of the parties to the media and/or digital media commerce products and/or services or by intelligent agents, software agents, computer code, applications, applets, and/or mobile agents that may act on behalf of any of the parties and/or any of the respective computers and/or devices described herein.

The apparatus and method of the present invention, in a preferred embodiment, provides a computer-implemented system for storing one or more of the inventory of content, digital content, media, digital media, data, information, digital content transaction applications, digital content transaction services, digital content computing applications, digital content computing services, digital content communications applications, digital content communications services, periodicals, files, video, audio, images, avatars, pixel content and/or digital media, clear gifs, web beacons, voice, text, signals, hyper-links, programs, applications, applets, code, scripts, alerts, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, media and/or digital media commerce products and/or services, notifications, controls, communications, and/or an embodiment of information, and/or an embodiment of control functionality, device and/or devices information associated with an entity and/or individual user and/or subscriber and/or registrant, the contact information, account information, third-party account information, identification information of the entity and/or individual user and/or subscriber and/or registrant, transaction information, requests, histories, and/or aggregated transaction data, of entity and/or individual user and/or subscribers, and/or digital media creator and/or developers, and/or media and/or digital media commerce products and/or services service providers, and/or third-party communications and/or computing entities facilitating the delivery of digital media commerce, (hereinafter which may be referred to collectively as “media and/or digital media commerce products and/or services” or “media and/or digital media commerce products and/or services”).

The apparatus and method of the present invention, in a preferred embodiment, provides a computer-implemented system, wherein the session and/or subscription and/or registration is for a specified amount of functionality, time, content, and/or other usage and/or consumption and/or presentation parameters. Or, is for a specified time period, and further wherein media and/or digital media commerce products and/or services can be skipped or foregone in or during the specified time period while allowing an entity and/or individual user and/or subscriber and/or registrant to be able to control the quantity, remaining time, and/or frequency remaining pursuant to the parameters of the parties to the enabling media commerce system.

The apparatus and method of the present invention, in a preferred embodiment, provides a computer-implemented system, wherein the request contains one or more of an access code, a password, a personal identification number or code, email address, uniform resource locator, telephone number, mobile telephone number, contact digital address, digital contact information, digital place of receipt, unique identifying information, a bar code, an optical code, a code for scanning, a biometric code, an avatar, an avatar identification, representative identification, third-party identification related to requestor, postal contact, and information obtained from a magnetic strip of an account card, information obtained from a microprocessor of an account card, or information from a subscriber identity module card, or information obtained from an electronic account previously associated with the entity and/or individual user and/or subscriber and/or registrant.

The apparatus and method of the present invention, in a preferred embodiment, provides a computer-implemented system for processing information regarding a search for subject matter, subject matter of digital media and/or digital media commerce products and/or services, and/or digital media creator and/or developer, media commerce entity, identity, brand, category, product, service, and/or identifying information associated with either the entity and/or individual user and/or subscriber and/or receiver.

The apparatus and method of the present invention, in a preferred embodiment, provides a computer-implemented system for processing information regarding the pairing of offers for digital media commerce products and/or services with requests to receive digital media commerce products and/or services based on parameters set by the digital media creator and/or developer, the digital media publisher and/or manager and/or intermediary and/or the requestor, and/or consumer, and/or the digital media commerce service provider.

The apparatus and method of the present invention, in a preferred embodiment, provides a computer-implemented system for a bidding system for sellers and buyers, and/or senders and recipients, and/or parties to the transacting related to the digital media commerce, to reach a commercial agreement for transacting related to digital media commerce.

The apparatus and method of the present invention, in a preferred embodiment, provides a computer-implemented system further comprising a payment method or methods for settlement of accepted offers for receiving and/or transmitting digital media commerce related products and/or services.

The apparatus and method of the present invention, in a preferred embodiment, provides a computer-implemented system for further determining that the session, and/or the subscription, and/or the registration is not active; and processing information for re-opening or renewing the session, and/or the subscription, and/or the registration.

The apparatus and method of the present invention, in a preferred embodiment, provides a computer-implemented system for generating a notification pursuant to any one or more of a session and/or subscription and/or registration request, a session and/or subscription and/or registration, subscription and/or notification rejection, a search, a query, a status, a payment, an acceptance, a conveyance, a counter-offer, a rejection, dynamically generated offer, dynamically generated acceptance, dynamically generated set of terms, and/or information and/or actions related to the processing, fulfillment, and/or management of digital media commerce services.

The apparatus and method of the present invention, in a preferred embodiment, provides a computer-implemented system for a processor, wherein the processor process a request to perform at least one action of enabling the creation and/or development, and/or processing and/or fulfillment, and/or publication and/or management, and/or consumption and/or presentation of content and/or digital media related to t digital media commerce.

The apparatus and method of the present invention, in a preferred embodiment, provides a computer-implemented system for a processor, wherein the processor process a request to perform at least one action of register, subscribe, assess, communicate, attach a communication, attach a media and/or digital media commerce products and/or services to a communication, pair a communication and a media and/or digital media commerce products and/or services, forward a communication, forward a communication and a media and/or digital media commerce products and/or services, wherein the processor determines at least of one of authorization, authentication, whether to accept, reject, further qualify, and/or to facilitate a communication and/or multiple communications.

The apparatus and method of the present invention, in a preferred embodiment, provides a computer-implemented system for a processor, wherein the processor generates a notification to the requestor of approval, rejection, a query, or an offer pursuant to the requested digital media and/or digital media commerce products and/or services, and/or inventory status, pricing status, availability status.

The apparatus and method of the present invention, in a preferred embodiment, provides a computer-implemented system for a processor, wherein the processor process a request to perform the inclusion of a programming input, such as a live feed, which can be connected or linked with the computer-implemented system and which can transmit live content and/or digital media to the computer-implemented system for digital media commerce to be executed in conjunction with communication devices, computing devices, and/or transaction devices.

The apparatus and method of the present invention, in a preferred embodiment, provides a computer-implemented system for a processor, wherein the processor process an access request to a ratings computer which is connected to or linked with the computer-implemented system. The ratings computer can include a database which stores information regarding various ratings and viewership information for various pieces of content and/or media which may be subject to commerce in a digital environment. Ratings information can be transmitted to the ratings computer from a ratings provider communication device and/or from the computer-implemented system, and may be utilized by any ratings reporting service, organization, agency, station, network, service provider, and/or search provider.

The apparatus and method of the present invention, in a preferred embodiment, provides a computer-implemented system for a processor, wherein the processor process a request to enable an advertisement/marketing computer which is connected to or linked with the computer-implemented system. The advertisement/marketing computer can include a database which stores advertisements, commercials, links, hyperlinks, video, audio, banners, buttons, clips, URL's content and/or digital media, frames, logos, icons, surveys, questionnaires, market research tools, promotions, offers, and/or other marketing content, code, and/or related promotional and/or research functionality, wherein the information described herein is stored in the database of the advertisement/marketing computer can be transmitted to/from the advertisement/marketing provider communication device which can be connected to and/or linked with the advertisement/marketing computer and/or the transmitted to/from the computer-implemented system, wherein the advertising/marketing computer can be connected to or linked with the other devices and/or systems via any communication network described herein.

The apparatus and method of the present invention, in a preferred embodiment, provides a computer-implemented system for a processor, wherein the processor process a request to enable a print publishing computer which is connected to or linked with the computer-implemented system. The print publishing computer can include a database which stores content and/or digital media, advertisements, images, text, commercials, links, hyperlinks, video, audio, banners, buttons, clips, URL's content and/or digital media, frames, logos, icons, surveys, questionnaires, market research tools, promotions, offers, and/or other print publishing content, code, and/or related promotional and/or functionality which is suitable for either physical printing, such as but not limited to paper printing, and/or digital printing, such as but not limited to digital billboards, wherein the information described herein is stored in the database of the print publishing computer and can be transmitted to/from the print publishing provider communication device which can be connected to and/or linked with the print publishing computer and/or the transmitted to/from the computer-implemented system, wherein the print publishing computer can be connected to or linked with the other devices and/or systems via any communication network described herein.

The apparatus and method of the present invention, in a preferred embodiment, provides a computer-implemented system for a processor, wherein the processor process a request to receive a real-time and/or immediate alert can also be provided to a user as a function of the computer-implemented system. The herein described alert feature can be used to provide information about content and/or digital media availability, and/or information concerning the commercial transaction related to content and/or digital media.

The apparatus and method of the present invention, in a preferred embodiment, provides a computer-implemented system for a processor, wherein the processor process a request to enable either dynamically, and/or manually, assemble the content and/or digital media which the user would like to consume as a computational function of the computer-implemented system. This personal assemblage of content and/or digital media may contain any single or multitude of types or elements of content, digital media, advertisements, ratings, and the like, as described herein. Further, this personal assemblage of content and/or digital media may be consumed in any single or multitude of communications, computing, display, and/or print elements described herein. The information comprising the personal assemblage of content and/or digital media described herein can be stored in the database of a device associated with the user, and/or in the database of the computer-implemented system. It may likewise be transmitted to/from the various communication devices described herein and in conjunction with any of the communication network described herein.

The apparatus and method of the present invention, in a preferred embodiment, provides a computer-implemented system for a processor, wherein the processor process a request to enable an advertiser, such as a vendor of any product, service, and/or good, or an agent thereof, or a third-party acting on behalf of a advertisers and vendors to purchase, in an on-line and/or in a real-time environment, to place an advertisement placement where that advertisement, and/or offering, may be inserted into the content and/or digital media pursuant to the terms identified by the parties with a commercial interest in the content and/or digital media.

The apparatus and method of the present invention, in a preferred embodiment, provides a computer-implemented system for a processor, wherein the processor process a request to attach and/or access descriptive and/or identifying meta-data regarding the content and/or digital media which may be linked to, embedded into, and/or attached to the actual content and/or digital media asset.

The apparatus and method of the present invention, in a preferred embodiment, provides a computer-implemented system for a processor, wherein the processor process a request to establish and/or access usage parameters, such as but not limited to, metering which may be used to provide the content and/or digital media transacting parties with a value measurement related to usage of content and/or digital media for the purpose of establishing rights and costs, wherein such usage parameters may be linked to, embedded into, and/or attached to the actual content and/or digital media asset, and/or an account related to the buying, selling, usage, and/or licensing transaction for the content and/or digital media.

The apparatus and method of the present invention, in a preferred embodiment, provides a computer-implemented system for a processor, wherein the processor processes a session request, and/or registration and/or subscription to digital media commerce service.

The apparatus and method of the present invention, in a preferred embodiment, provides a computer-implemented system for a processor, wherein the processor processes the communications associated with the request to one or more of the requestor, and/or a third party media commerce entity, and further wherein the processor facilitates the search, matches a buy and sell offers, and facilitates a transaction associated with the request to receive digital media and/or digital media commerce products and/or services and/or digital media commerce.

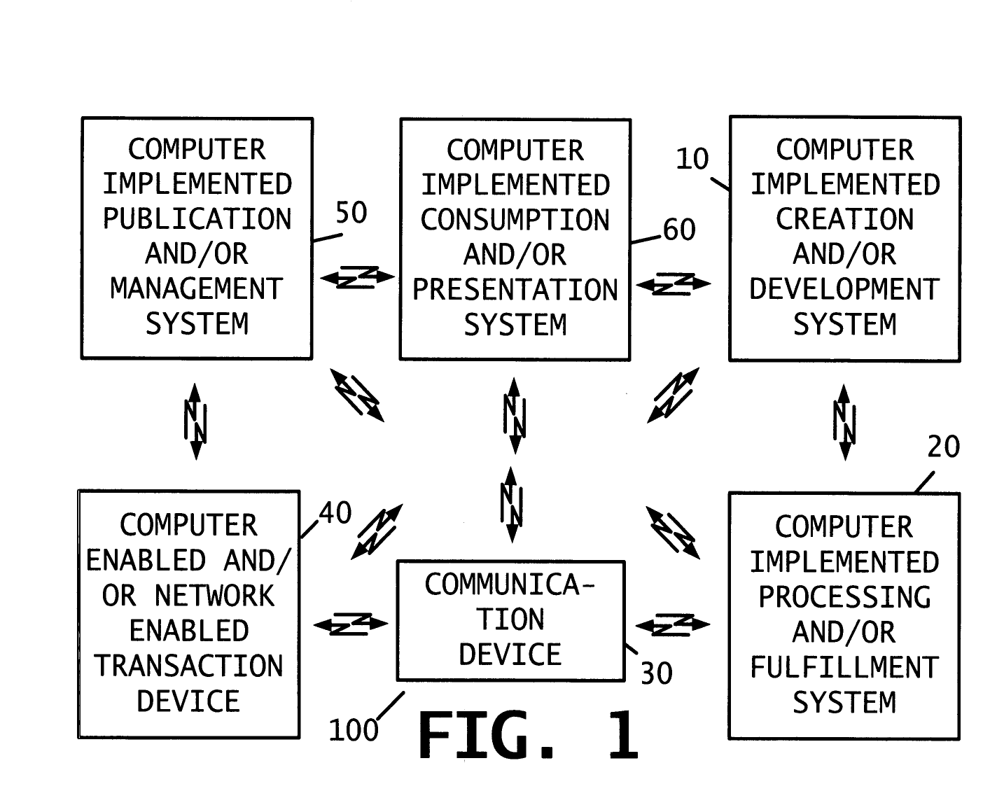

FIG. 1 illustrates the apparatus of the present invention in block diagram form. The apparatus is generally denoted by the reference numeral 100. The apparatus 1 includes a computer-implemented content and/or digital media creation and/or development system 10. The computer-implemented content and/or digital media creation and/or development system 10 processes session, application, commerce, and/or subscription requests and establishes sessions, application instances, commerce, and/or subscriptions for the respective entity and/or individual user and/or subscribers to any of the respective digital media commerce services, described herein.

The apparatus 1 also includes a computer-implemented content and/or digital media processing and/or fulfillment system 20 which processes data and/or information regarding and/or involving processing and/or fulfillment services for the respective sessions, application instances, commerce, and/or subscriptions.

The apparatus 1 also includes a computer-implemented content and/or digital media publication and/or management system 50 which processes data and/or information regarding and/or involving publication and/or management services for the respective sessions, application instances, commerce, and/or subscriptions.

The apparatus 1 also includes a computer-implemented content and/or digital media consumption and/or presentation system 60 which processes data and/or information regarding and/or involving consuming content and/or digital media in the context of engaging in media commerce.

In the preferred embodiment, each of the computer-implemented content and/or digital media creation and/or development system 10, and the computer-implemented content and/or digital media processing and/or fulfillment system 20, and the computer-implemented content and/or digital media publication and/or management system 50, and the computer-implemented content and/or digital media consumption and/or presentation system 60, are computers and/or computer systems and may be any suitable server, network computer, mainframe computer, mini-computer, personal computer, a microcomputer, a computer on a chip, a nano computer, a quantum computer, a website, a blog, a SMS, an instant message, a tweet, a posting, an application, an applet, and/or any other computer and/or computer system which is suitable for performing the respective processing functions of the respective computers in a network environment.

The apparatus 1 also includes a communication device 30 which, in the preferred embodiment, is utilized so as to communicate with each of the computer-implemented content and/or digital media creation and/or development system 10, and the computer-implemented content and/or digital media processing and/or fulfillment system 20, and the computer-implemented content and/or digital media publication and/or management system 50, and the computer-implemented content and/or digital media consumption and/or presentation system 60. In the preferred embodiment, the communication device can be a personal computer, a home computer, a microcomputer, a computer on a chip, a nano computer, a quantum computer, a website, a blog, a SMS, an instant message, a tweet, a posting, an application, an applet, a personal digital assistant, a mobile communications device, a telephone, a wireless telephone, a cellular telephone, a hand-held computer, a palm-top computer, and/or any other computer and/or communication device.

The communication device 30 is utilized, in the manner described herein, so as to communicate with the computer-implemented content and/or digital media creation and/or development system 10 and the computer-implemented content and/or digital media processing and/or fulfillment system 20. In this regard, the communication device 30 can transmit signals to, as well as receive signals from, each of the computer-implemented content and/or digital media creation and/or development system 10, and the computer-implemented content and/or digital media processing and/or fulfillment system 20, and the computer-implemented content and/or digital media publication and/or management system 50, and the computer-implemented content and/or digital media consumption and/or presentation system 60.

The apparatus also includes an internet access device and/or computer enabled and/or network enabled transaction device 40. The computer enabled and/or network enabled transaction device 40 processes computer enabled and/or network enabled transactions and/or computer enabled and/or network enabled media commerce transactions involving the respective digital media commerce services, which are the subject of the respective digital media commerce session, use session, time of operation, and/or subscription. The computer enabled and/or network enabled transaction device 40 communicates with each of the computer-implemented content and/or digital media creation and/or development system 10, and the computer-implemented content and/or digital media processing and/or fulfillment system 20, and the computer-implemented content and/or digital media publication and/or management system 50, and the computer-implemented content and/or digital media consumption and/or presentation system 60. In this regard, the computer enabled and/or network enabled transaction device 40 can transmit signals to, as well as receive signals from, each of the computer-implemented content and/or digital media creation and/or development system 10, and the computer-implemented content and/or digital media processing and/or fulfillment system 20, and the computer-implemented content and/or digital media publication and/or management system 50, and the computer-implemented content and/or digital media consumption and/or presentation system 60.

In the preferred embodiment, the computer enabled and/or network enabled transaction device 40 can transmit signals to, and receive signals from, the communication device 30. In this manner, any of the computer-implemented content and/or digital media creation and/or development system 10, the computer-implemented content and/or digital media processing and/or fulfillment system 20, communication device 30, the computer enabled and/or network enabled transaction device 40, and/or the computer-implemented content and/or digital media publication and/or management system 50, and the computer-implemented content and/or digital media consumption and/or presentation system 60 may communicate with each other.

In the preferred embodiment, a plurality of computer enabled and/or network enabled devices 40 can be utilized, with each device 40 being utilized at and for a separate computer enabled and/or network enabled media commerce location or at a separate computer enabled and/or network enabled media commerce site at a computer enabled and/or network enabled media commerce location. The computer enabled and/or network enabled device 40 may be a communications and/or computing enabled kiosk, billboard, display, speaker, microphone, point-of-sale device, computer, telephone, and/or similar communications and/or computing device enabling digital media commerce transmissions. In the preferred embodiment, a plurality of communication devices 30 can be utilized with each communication device 30 being associated with an entity and/or individual user and/or subscriber. The communication device 30 may also be a communications and/or computer enabled kiosk, billboard, display, speaker, microphone, point-of-sale device, computer, telephone, and/or similar communications and/or computing device enabling digital media commerce transmissions.

In yet another preferred embodiment, the computer enabled and/or network enabled devices 40 can be utilized in an online, and/or digital environment, with each device 40 being an e-commerce enabled computer and/or network enabled device and/or system, and/or an e-commerce enabled network and/or computer-implemented system, and/or an e-commerce enabled communications network and/or computer-implemented system. The e-commerce enabled computer and/or network enabled device 40 may be digitally located at and for a separate computer enabled and/or network enabled media commerce location or at a separate computer enabled and/or network enabled media commerce site at a computer enabled and/or network enabled media commerce location.

In yet another preferred embodiment, the communications device 30 and the computer enabled and/or network enabled device 40 may be one in the same.

The computer-implemented content and/or digital media creation and/or development system 10 may be a single computer and/or computer system and/or may include a plurality of computers and/or computer systems. In the same manner, the computer-implemented content and/or digital media processing and/or fulfillment system 20 may be a single computer and/or computer system and/or may include a plurality of computers and/or computer systems. In the same manner, the computer-implemented content and/or digital media publication and/or management system 50 may be a single computer and/or computer system and/or may include a plurality of computers and/or computer systems. In the same manner, the computer-implemented content and/or digital media consumption and/or presentation system 60 may be a single computer and/or computer system and/or may include a plurality of computers and/or computer systems.

The apparatus 1 of the present invention, in the preferred embodiment, is utilized over any suitable communication network and/or system.

In a preferred embodiment, the apparatus 1 is utilized in conjunction with, on, or over, a plurality of communications and/or computing networks, and/or systems, which may include, but are not limited to, any one or any combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, geo synchronous satellite systems, as well as in, or on any internets and/or intranets, computing networks, cloud computing systems, server, network computers, client devices, client-server based, quantum computing based, quantum storage based, network computer architectures, communications networks, terrestrial networks, undersea networks, mobile networks, satellite networks, mesh networks, the Internet, World Wide Web, WWW2, WWW3, Semantic Web, closed circuit networks, open networks, radio networks, optical networks, pulse networks, digital networks, wave networks, light networks, neural networks, chemical networks, materials networks, biological networks, radiation networks, energy wave networks, and/or particle based networks, and/or where it may occur in a supra-global network environment, global network environment, trans-national network environment, national network environment, wide area network environment, metropolitan area network environment, local area network environment, personal network area environment, inter-being network environment, intra-being network environment, human-to-machine network environment, machine-to-machine network environment, and/or human-to-non-human network environment, and any other suitable communication network or system.

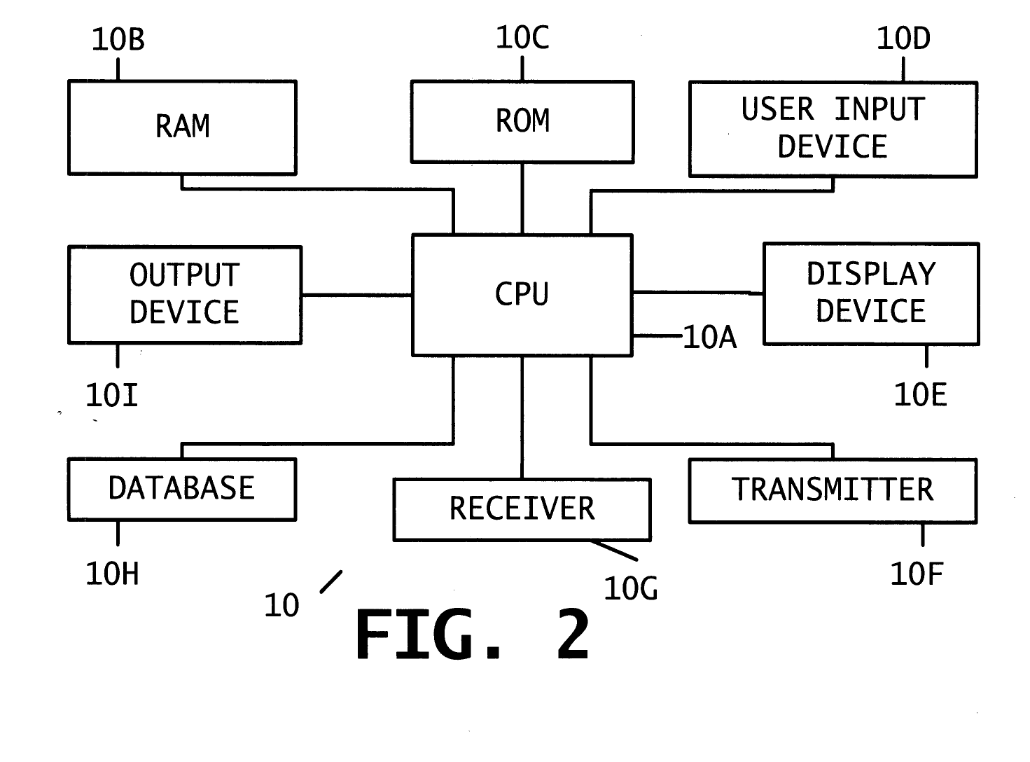

FIG. 2 illustrates the computer-implemented content and/or digital media creation and/or development system 10, in block diagram form. The computer-implemented content and/or digital media creation and/or development system 10, in the preferred embodiment, is a network computer or computer system which is utilized as a computer-implemented content and/or digital media creation and/or development system such as a server, network computer, server, network computers in a datacenter, a web server, network computer, an Internet server, network computer, an e-commerce server, network computer, a communications server, network computer, a database server, network computer, a mobile computer, and/or any similar computer or computer system.

The computer-implemented content and/or digital media creation and/or development system 10 can also be any other computer or computer system which can be utilized in any computing and/or communication network. In the preferred embodiment, the computer-implemented content and/or digital media creation and/or development system 10 includes a central processing unit or CPU 10A, which in the preferred embodiment, is a microprocessor. The CPU 10A may also be a microcomputer, a minicomputer, a macro-computer, a computer on a chip, a nano computer, a quantum computer, a website, a blog, a SMS, an instant message, a tweet, a posting, an application, an applet, a synthetic computer, a biological computer, a multi-core computer, a multi-component computer, a physical computer, a virtualized computer, a single computer, a combination of computers, a computer system, a networked computer system, and/or a mainframe computer, depending upon the application.

The computer-implemented content and/or digital media creation and/or development system 10 also includes a random access memory device(s) 10B (RAM) and a read only memory device(s) 10C (ROM), each of which is connected to the CPU 10A, a user input device 10D, for entering data and/or commands into the computer-implemented content and/or digital media creation and/or development system 10, which includes any one or more of a key pad, a keyboard, a scanner, a touch pad, a signature pad, a card reader, a magnetic strip card reader, a biometric scanner, a subscriber identity module reader, a chip reader, a signal scanner, a camera, a video camera, a microphone, a graphic image and/or video signal generator, an audio signal and/or audio image generator, a user pointing device, such as, for example, a mouse, a touch pad, and/or an audio input device and/or a video input device, or the like, if desired, which input device(s) is also connected to the CPU 10A.

The computer-implemented content and/or digital media creation and/or development system 10 also includes a display device 10E for displaying data and/or information to a user or operator.

The computer-implemented content and/or digital media creation and/or development system 10 also includes a transmitter(s) 10F, for transmitting signals and/or data and/or information to any one or more of the computer-implemented content and/or digital media creation and/or development system 10, the computer-implemented content and/or digital media processing and/or fulfillment system 20, the computer-implemented content and/or digital media publication and/or management system 50, the computer-implemented content and/or digital media consumption and/or presentation system 60, the computer enabled and/or network enabled transaction devices 40, and the communication devices 30, which may be utilized in conjunction with the present invention. The computer-implemented content and/or digital media creation and/or development system 10 also includes a receiver 10G, for receiving signals and/or data and/or information from to any one or more of the computer-implemented content and/or digital media creation and/or development system 10, the computer-implemented content and/or digital media processing and/or fulfillment system 20, the computer-implemented content and/or digital media publication and/or management system 50, the computer-implemented content and/or digital media consumption and/or presentation system 60, the computer enabled and/or network enabled transaction devices 40, and the communication devices 30, which may be utilized in conjunction with the present invention.

The computer-implemented content and/or digital media creation and/or development system 10 also includes a database 10H. The database can include data and/or information regarding digital media creator and/or developer, or entity which provides data and/or information and/or functionality which may be either attached to, embedded in, and/or associated with the digital media commerce, for which sessions, application instances, commerce, and/or subscriptions are provided and/or available via the apparatus of the present invention. The database 10H can also include data and/or information regarding the services and/or products that may be provided in association with, and/or derived from, the digital media commerce services.

The database 10H can also include data and/or information regarding the entity and/or individual user and/or subscriber, including all histories of usage, commercial terms, payments, technical, and/or communications usage in conjunction with the digital media commerce service. The database 10H can also include all data and/or information regarding the entity and/or individual user and/or subscriber including all communications account information, financial account information, and a multitude of profiling information including, but not limited to, preferences, demographics, activity streams, behavioral targeting, data logging. digital footprint, lifelog, lifestreaming, profiling, runtime intelligence, social translucence, trace, trace evidence, genetic sequencing, psychographics, data represented in Attention Profiling Mark-up Language, subject and/or interest item information, communications, browsing histories, browsing patterns, documents, files, computational usage statistics, communications usage statistics, content created, content viewed, heard and/or read, content downloaded, applications used and/or downloaded, search queries, search results, click-through on search results, digital traces, activities, behaviors, login and logouts, visit of pages, documents accesses, items created, affiliation to groups, attention, social group, repetition, location, reputation, financial activities, investing activities, income data, spending data, consumption and/or presentation data, tax data, credit data, credit history data, reputational data, media related data, sensor discovered data, sensor recorded data, digital footprints, digital finger prints, life streams, social media linkages, social media activities, communications activities, computing activities, personal status, medical information, health information, personally identifiable information, volunteered information, collected information, rumored information, non-volunteered information, information capable of being stored in log files, information capable of being stored locally and/or or in a private and/or public cloud computing environment, information capable of being stored in databases, mined data, as well as the analytics associated with the aforementioned data and/or information, with respect to the services provided related to digital media commerce.

The database 10H can also include data and/or information regarding the services provided by the digital media commerce service provider, and/or affiliated service providers, including services previously offered, currently offered, and/or prospectively offered, content, communications, and/or commercial information regarding digital media commerce including, but not limited to, data received by and/or from the digital media publisher and/or manager and/or intermediary, data received by and/or from the digital media creator and/or developer, and/or data generated by the digital media commerce service provider through activities associated with the providing of digital media commerce services, as well as the analytics associated with any of the aforementioned data and/or information, with respect to the services provided related to digital media commerce.

The database 10H can also include data and/or information regarding the actual content and/or digital media provided and/or offered by the digital media creator and/or developers, including, but not limited to content, digital content, media, digital media, data, information, digital content transaction applications, digital content transaction services, digital content computing applications, digital content computing services, digital content communications applications, digital content communications services, periodicals, files, video, audio, images, avatars, pixel content and/or digital media, clear gifs, web beacons, voice, text, signals, hyper-links, programs, applications, applets, code, scripts, alerts, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, media and/or digital media commerce products and/or services, notifications, controls, communications, and/or an embodiment of information, and/or an embodiment of control functionality, as well as the analytics associated with any of the aforementioned data and/or information (hereinafter which may be referred to collectively as “media and/or digital media commerce products and/or services” or “media and/or digital media commerce products and/or services”), with respect to the services provided related to digital media commerce.

The database 10H also includes information regarding the digital media commerce products and/or services, and/or sessions, application instances, commerce, and/or subscriptions which each entity and/or individual user and/or subscriber has initiated, is using, is/was engaged in, and/or subscribed to, type of subscription, subscription length or duration, subscription cost, subscription renewals, subscription extensions, digital media commerce received and/or offered, status of subscription agreement, remaining subscription agreement commitments, and/or any other relevant information regarding the respective digital media commerce products and/or services, and/or sessions, application instances, commerce, and/or subscriptions and/or the operation execution and/or transmission of the respective digital media commerce products and/or services, and/or sessions, application instances, commerce, and/or subscriptions.

The database 10H also includes information regarding the date the respective digital media commerce products and/or services, and/or sessions, application instances, commerce, and/or subscriptions were ordered, became effective, date/time of the start of the session and/or subscription, date/time of session and/or subscription termination, computer enabled and/or network enabled media commerce computer and/or session and/or subscription origination agent from who the session and/or subscription originated, and the computer enabled and/or network enabled media commerce computer, goods provider, and/or services provider, session application provider, subscription service entity, and/or service, session, and/or subscription fulfillment entity and/or agent from whom the entity and/or individual user and/or subscriber will obtain the respective digital media commerce products and/or services, which are be the subject of the digital media commerce products and/or services, and/or sessions, application instances, commerce, and/or subscriptions. The database 10H also includes information regarding customer service agents and/or entities for providing customer services for, and/or regarding, any of the respective digital media commerce products and/or services, and/or sessions, application instances, commerce, and/or subscriptions.

The database 10H may also contain any other information which may be relevant, pertinent, useful, and/or desired, for facilitating the operation of the apparatus and method of the present invention as described herein and/or as related thereto.

The database 10H, in the preferred embodiment, is a database which may include individual databases or collections of databases, with each database being designated to store any and all of the data and/or information described herein. Applicant hereby incorporates by reference herein the teachings of Basic Business Statistics Concepts and Applications, Mark L. Berenson and David M. Levine, 6.sup.th Edition, Prentice Hall 1996.

The database 10H, or collection of databases, may be updated by each of the respective individual entity and/or individual user and/or subscribers, computer-implemented content and/or digital media creation and/or development system operator or administrator, computer-implemented content and/or digital media processing and/or fulfillment system operator or administrator, computer-implemented content and/or digital media publication and/or management system operator or administrator, computer-implemented content and/or digital media consumption and/or presentation operator or administrator, computer enabled and/or network enabled transaction device operator, communication device operator or administrator, via any of their respective computers and/or devices, and/or by any other third party, in real-time, and/or via dynamically linked database management techniques.

The data and/or information stored in the database 10H can also be updated by external sources. The database 10H will contain any and all information deemed necessary and/or desirable for providing all of the processing and/or services and/or functions described herein. Applicant hereby incorporates by reference herein the subject matter of Fundamentals of Database Systems, by Ramez Elmasri and Shamkant B. Navathe, 2.sup.nd Ed., Addison-Wesley Publishing Company, 1994.

The database 10H can also include any contact information for any of the entities and/or individual users and/or subscribers, content providers, digital media providers, application providers, content and/or digital media product and/or service providers, subscription providers, subscription fulfillment providers, computer enabled and/or network enabled media commerce computers, computer enabled and/or network enabled entities, or the like, such as, but not limited to, names, addresses, telephone numbers, fax numbers, e-mail addresses, URL's, websites, hyper-links, XML data, personal identification information, business identification information, SIC codes, links to third-party and/or government sponsored identification information, and/or any other contact information, for the respective party. The database 10H also includes any of the above-described contact information regarding any intermediaries, third parties, agents, and/or brokers, who utilize the apparatus of the present invention.

The database 10H can also include any other data and/or information needed and/or desired for facilitating the functions and operation of the present invention as described herein.

With reference once again to FIG. 2, the computer-implemented content and/or digital media creation and/or development system 10 also includes an output device 10I such as a printer, a presentation, a display, an audio signal, a video signal, a text signal, a graphical signal, a read-out, a presenter, a 3-dimensional printer, a router, a modem, a networking device, a fax/modem, a transmitting device, or other output device, for providing data and/or information to the operator or user of the computer-implemented content and/or digital media creation and/or development system 10 or to a third party or third party entity.

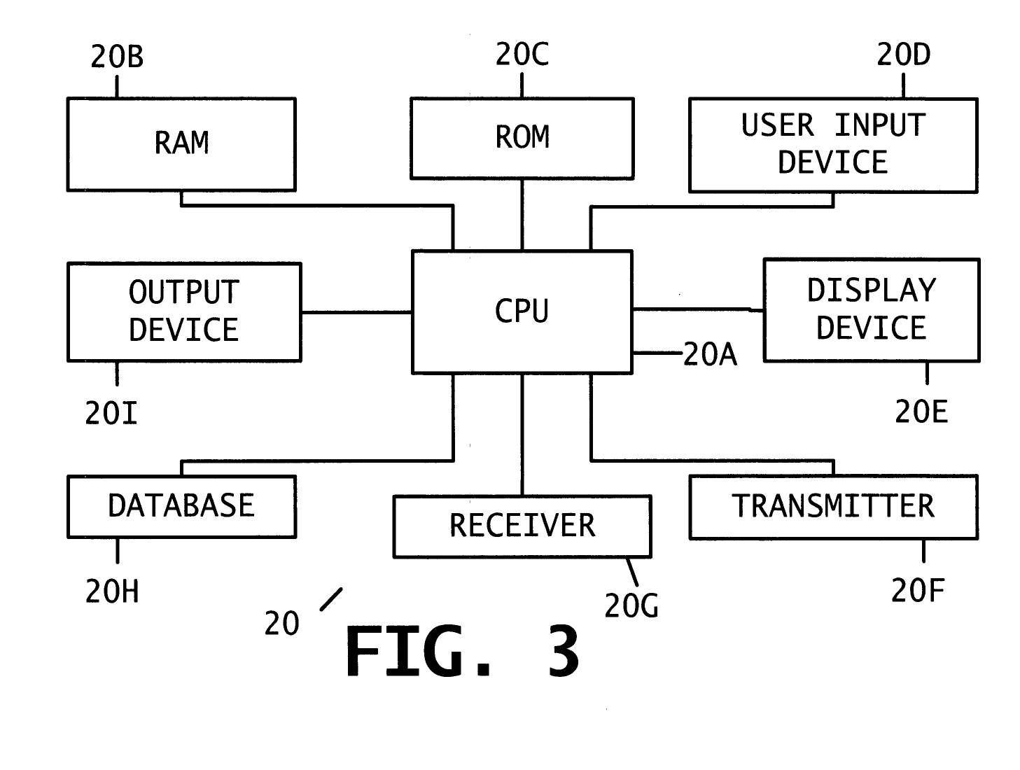

FIG. 3 illustrates the computer-implemented content and/or digital media processing and/or fulfillment system 20, in block diagram form. The computer-implemented content and/or digital media processing and/or fulfillment system 20, in the preferred embodiment, is a network computer or computer system which is utilized as a computer-implemented content and/or digital media processing and/or fulfillment system such as a server, network computer, server, network computers in a datacenter, a web server, network computer, an Internet server, network computer, an e-commerce server, network computer, a communications server, network computer, a database server, network computer, a mobile computer, and/or any similar computer or computer system.

The computer-implemented content and/or digital media processing and/or fulfillment system 20 can also be any other computer or computer system which can be utilized in any computing and/or communication network. In the preferred embodiment, the computer-implemented content and/or digital media processing and/or fulfillment system 20 includes a central processing unit or CPU 20A, which in the preferred embodiment, is a microprocessor. The CPU 20A may also be a microcomputer, a minicomputer, a macro-computer, a computer on a chip, a nano computer, a quantum computer, a website, a blog, a SMS, an instant message, a tweet, a posting, an application, an applet, a synthetic computer, a biological computer, a multi-core computer, a multi-component computer, a physical computer, a virtualized computer, a single computer, a combination of computers, a computer system, a networked computer system, and/or a mainframe computer, depending upon the application.

The computer-implemented content and/or digital media processing and/or fulfillment system 20 also includes a random access memory device(s) 20B (RAM) and a read only memory device(s) 20C (ROM), each of which is connected to the CPU 20A, a user input device 20D, for entering data and/or commands into the computer-implemented content and/or digital media processing and/or fulfillment system 20, which includes any one or more of a key pad, a keyboard, a scanner, a touch pad, a signature pad, a card reader, a magnetic strip card reader, a user pointing device, such as, for example, a mouse, a touch pad, and/or an audio input device and/or a video input device, or the like, if desired, which input device(s) is also connected to the CPU 20A.

The computer-implemented content and/or digital media processing and/or fulfillment system 20 also includes a display device 20E for displaying data and/or information to a user or operator.

The computer-implemented content and/or digital media processing and/or fulfillment system 20 also includes a transmitter(s) 20F, for transmitting signals and/or data and/or information to any one or more of the computer-implemented content and/or digital media processing and/or fulfillment system 20, the computer-implemented content and/or digital media creation and/or development system 10, the computer-implemented content and/or digital media publication and/or management system 50, the computer-implemented content and/or digital media consumption and/or presentation system 60, the computer enabled and/or network enabled transaction devices 40, and the communication devices 30, which may be utilized in conjunction with the present invention. The computer-implemented content and/or digital media processing and/or fulfillment system 20 also includes a receiver 20G, for receiving signals and/or data and/or information from to any one or more of the computer-implemented content and/or digital media processing and/or fulfillment system 20, the computer-implemented content and/or digital media creation and/or development system 10, the computer-implemented content and/or digital media publication and/or management system 50, the computer-implemented content and/or digital media consumption and/or presentation system 60, the computer enabled and/or network enabled transaction devices 40, and the communication devices 30, which may be utilized in conjunction with the present invention.

The computer-implemented content and/or digital media processing and/or fulfillment system 20 also includes a database 20H. The database can include data and/or information regarding digital media creator and/or developer, or entity which provides data and/or information and/or functionality which may be either attached to, embedded in, and/or associated with the digital media commerce, for which digital media commerce products and/or services, and/or sessions, application instances, commerce, and/or subscriptions are provided and/or available via the apparatus of the present invention. The database 20H can also include data and/or information regarding the services and/or products that may be provided in association with, and/or derived from, the digital media commerce services.

The database 20H can also include data and/or information regarding the entity and/or individual user and/or subscriber, including all histories of usage, commercial terms, payments, technical, and/or communications usage in conjunction with the digital media commerce service. The database 20H can also include all data and/or information regarding the entity and/or individual user and/or subscriber including all communications account information, financial account information, and a multitude of profiling information including, but not limited to, preferences, demographics, activity streams, behavioral targeting, data logging. digital footprint, lifelog, lifestreaming, profiling, runtime intelligence, social translucence, trace, trace evidence, genetic sequencing, psychographics, data represented in Attention Profiling Mark-up Language, subject and/or interest item information, communications, browsing histories, browsing patterns, documents, files, computational usage statistics, communications usage statistics, content created, content viewed, heard and/or read, content downloaded, applications used and/or downloaded, search queries, search results, click-through on search results, digital traces, activities, behaviors, login and logouts, visit of pages, documents accesses, items created, affiliation to groups, attention, social group, repetition, location, reputation, financial activities, investing activities, income data, spending data, consumption and/or presentation data, tax data, credit data, credit history data, reputational data, media related data, sensor discovered data, sensor recorded data, digital footprints, digital finger prints, life streams, social media linkages, social media activities, communications activities, computing activities, personal status, medical information, health information, personally identifiable information, volunteered information, collected information, rumored information, non-volunteered information, information capable of being stored in log files, information capable of being stored locally and/or or in a private and/or public cloud computing environment, information capable of being stored in databases, mined data, as well as the analytics associated with the aforementioned data and/or information, with respect to the services provided related to digital media commerce.

The database 20H can also include data and/or information regarding the services provided by the digital media commerce service provider, and/or affiliated service providers, including services previously offered, currently offered, and/or prospectively offered, content, communications, and/or commercial information regarding digital media commerce including, but not limited to, data received by and/or from the digital media publisher and/or manager and/or intermediary, data received by and/or from the digital media creator and/or developer, and/or data generated by the digital media commerce service provider through activities associated with the providing of digital media commerce services, as well as the analytics associated with any of the aforementioned data and/or information, with respect to the services provided related to digital media commerce.

The database 20H can also include data and/or information regarding the actual content and/or digital media provided and/or offered by the digital media creator and/or developers, including, but not limited to content, digital content, media, digital media, data, information, digital content transaction applications, digital content transaction services, digital content computing applications, digital content computing services, digital content communications applications, digital content communications services, periodicals, files, video, audio, images, avatars, pixel content and/or digital media, clear gifs, web beacons, voice, text, signals, hyper-links, programs, applications, applets, code, scripts, alerts, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, media and/or digital media commerce products and/or services, notifications, controls, communications, and/or an embodiment of information, and/or an embodiment of control functionality, as well as the analytics associated with any of the aforementioned data and/or information (hereinafter which may be referred to collectively as “media and/or digital media commerce products and/or services” or “media and/or digital media commerce products and/or services”), with respect to the services provided related to digital media commerce.

The database 20H also includes data and/or information regarding the name of the respective digital media commerce products and/or services, which can be the subject of the digital media commerce products and/or services, and/or sessions, application instances, commerce, and/or subscriptions. The database 20H also includes data and/or information regarding the types of subscription available for the respective digital media commerce products and/or services, the length and/or duration of the respective digital media commerce products and/or services, and/or sessions, application instances, commerce, and/or subscriptions, the prices of the respective digital media commerce products and/or services, and/or sessions, application instances, commerce, and/or subscriptions, any conditions and/or miscellaneous information regarding the digital media commerce products and/or services, and/or sessions, application instances, commerce, and/or subscriptions available.

The database 20H also includes data and/or information regarding the individual entity and/or individual user and/or subscribers, individuals, businesses, business entities, institutions, and/or others, who subscribe to any digital media commerce products and/or services, and/or sessions, application instances, commerce, and/or subscriptions via the apparatus of the present invention. The individual data and/or information can contain any pertinent information regarding the entity and/or individual user and/or subscribers, such as sex, gender, age, educational level, occupation, marital status, and information regarding the entity and/or individual user and/or subscriber's credit card(s), charge card(s), debit card(s), bank accounts, and/or other financial information for allowing the entity and/or individual user and/or subscriber to pay for the respective digital media commerce products and/or services, and/or sessions, application instances, commerce, and/or subscriptions.

The database 20H also includes information regarding the digital media commerce products and/or services, and/or sessions, application instances, commerce, and/or subscriptions which each entity and/or individual user and/or subscriber has initiated, is using, is/was engaged in, and/or subscribed to, type of subscription, subscription length or duration, subscription cost, subscription renewals, subscription extensions, digital media commerce or portions of digital media commerce products and/or services, and/or sessions, application instances, commerce, and/or subscriptions used and still available, any/or any other relevant information regarding the respective digital media commerce products and/or services, and/or sessions, application instances, commerce, and/or subscriptions and/or the operation execution and/or transmission of the respective digital media commerce products and/or services, and/or sessions, application instances, commerce, and/or subscriptions.

The database 20H also includes information regarding the digital media commerce products and/or services, and/or sessions, application instances, commerce, and/or subscriptions which each business subscriber has initiated, is using, is/was engaged in, and/or subscribed to, type of subscription, subscription length or duration, subscription cost, subscription renewals, subscription extensions, digital media commerce or portions of digital media commerce products and/or services, and/or sessions, application instances, commerce, and/or subscriptions used and still available, any/or any other relevant information regarding the respective digital media commerce products and/or services, and/or sessions, application instances, commerce, and/or subscriptions and/or the operation execution and/or transmission of the respective digital media commerce products and/or services, and/or sessions, application instances, commerce, and/or subscriptions.

The database 20H also includes information regarding the date the respective digital media commerce products and/or services, and/or sessions, application instances, commerce, and/or subscriptions were ordered, became effective, date/time of the start of the session and/or subscription, date/time of session and/or subscription termination, computer enabled and/or network enabled media commerce computer and/or session and/or subscription origination agent from who the session and/or subscription originated, and the computer enabled and/or network enabled media commerce computer, goods provider, and/or services provider, session application provider, subscription service entity, and/or service, session, and/or subscription fulfillment entity and/or agent from whom the entity and/or individual user and/or subscriber will obtain the respective digital media commerce products and/or services, which are be the subject of the digital media commerce products and/or services, and/or sessions, application instances, commerce, and/or subscriptions. The database 20H also includes information regarding customer service agents and/or entities for providing customer services for, and/or regarding, any of the respective digital media commerce products and/or services, and/or sessions, application instances, commerce, and/or subscriptions.

The database 20H may also contain any other information which may be relevant, pertinent, useful, and/or desired, for facilitating the operation of the apparatus and method of the present invention as described herein and/or as related thereto.

The database 20H, in the preferred embodiment, is a database which may include individual databases or collections of databases, with each database being designated to store any and all of the data and/or information described herein.

The database 20H, or collection of databases, may be updated by each of the respective individual subscribers, computer-implemented content and/or digital media creation and/or development system operator or administrator, computer-implemented content and/or digital media processing and/or fulfillment system operator or administrator, computer-implemented content and/or digital media publication and/or management system operator or administrator, computer-implemented content and/or digital media consumption and/or presentation operator or administrator, computer enabled and/or network enabled transaction device operator, communication device operator or administrator, via any of their respective computers and/or devices, and/or by any other third party, in real-time, and/or via dynamically linked database management techniques.

The data and/or information stored in the database 20H can also be updated by external sources. The database 20H will contain any and all information deemed necessary and/or desirable for providing all of the processing and/or services and/or functions described herein.

The database 20H can also include any contact information for any of the subscribers, subscription providers, subscription fulfillment providers, computer enabled and/or network enabled media commerce computers, computer enabled and/or network enabled entities, or the like, such as, but not limited to, names, addresses, telephone numbers, fax numbers, e-mail addresses, URL's, websites, hyper-links, XML data, personal identification information, business identification information, SIC codes, links to third-party and/or government sponsored identification information, and/or any other contact information, for the respective party. The database 20H also includes any of the above-described contact information regarding any intermediaries, third parties, agents, and/or brokers, who utilize the apparatus of the present invention.

The database 20H can also include any other data and/or information needed and/or desired for facilitating the functions and operation of the present invention as described herein.

With reference once again to FIG. 3, the computer-implemented content and/or digital media processing and/or fulfillment system 20 also includes an output device 20I such as a printer, a presentation, a display, an audio signal, a video signal, a text signal, a graphical signal, a read-out, a presenter, a 3-dimensional printer, a router, a modem, a networking device, a fax/modem, a transmitting device, or other output device, for providing data and/or information to the operator or user of the computer-implemented content and/or digital media processing and/or fulfillment system 20 or to a third party or third party entity.

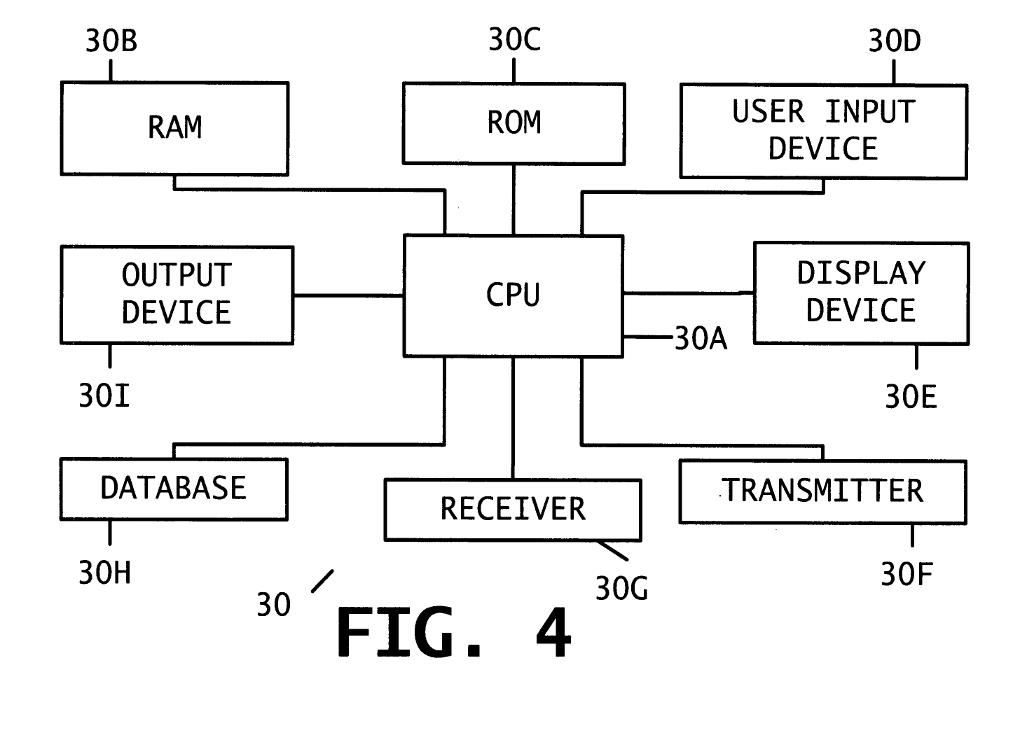

FIG. 4 illustrates the communication device 30, in block diagram form. The communication device 30, in the preferred embodiment, is a personal computer, a mobile phone, a smart phone, a mobile entertainment unit, a game console, a video terminal, an audio terminal, a digital communications system, digital media screening room, a communications enabled garment, a communications enabled vehicle, a communications enabled premise, a communications enabled object, a communications enabled item, a communications enabled avatar, a communications enabled virtual being, a communications enabled virtual premise, a communications enabled virtual event, a communications enabled virtual vehicle, a communications enabled virtual object, a pager, a monitor, a control device, a personal digital assistant, a communication device, and/or any other suitable computer or communication device which can be utilized to access and/or to communicate with any of the computer-implemented content and/or digital media creation and/or development system 10, computer-implemented content and/or digital media processing and/or fulfillment system 20, and/or any of the computer enabled and/or network enabled transaction devices 40, described herein. In the preferred embodiment, the communication device 30 includes a central processing unit or CPU 30A, which in the preferred embodiment, is a microprocessor. The CPU 30A may also be a microcomputer, a minicomputer, a macro-computer, a computer on a chip, a nano computer, a quantum computer, a website, a blog, a SMS, an instant message, a tweet, a posting, an application, an applet, a synthetic computer, a biological computer, a multi-core computer, a multi-component computer, a physical computer, a virtualized computer, a single computer, a combination of computers, a computer system, a networked computer system, and/or a mainframe computer, depending upon the application.

The communication device 30 also includes a random access memory device(s) 30B (RAM) and a read only memory device(s) 30C (ROM), each of which is connected to the CPU 30A, a user input device 30D, for entering data and/or commands into the communication device 30, which includes any one or more of a microphone, video camera, sensor, motion sensor, touch sensors of for the purpose of sensing such signals as, but not limited to, digital and/or electronic and/or audio and/or video and/or voice and/or tactile and/or image and/or gestation and/or olfacaction and/or equilibrioception and/or thermoception and/or proprioception and/or nociception and/or interoception and/or echolocation and/or electroception and/or magnetoception and/or pressure detection and/or current detection and/or polarized light direction detection and/or slit sensillae and/or vibratory and/or radiation and/or energy waves and/or particles, and as well may include a key pad, a keyboard, a scanner, a touch pad, a signature pad, a card reader, a magnetic strip card reader, a user pointing device, such as, for example, a mouse, a touch pad, and/or an audio input device and/or a video input device, or the like, if desired, which input device(s) is also connected to the CPU 30A. The communication device 30 also includes a display device 30E for displaying data and/or information to an individual user or operator.

The communication device 30 also includes a transmitter 30F, for transmitting signals and/or data and/or information to any one or more of the computer-implemented content and/or digital media creation and/or development system 10, the computer-implemented content and/or digital media processing and/or fulfillment system 20, the computer-implemented content and/or digital media publication and/or management system 50, and/or to any of the computer enabled and/or network enabled transaction devices 40, which may be utilized in conjunction with the present invention. The communication device 30 also includes a receiver 30G, for receiving signals and/or data and/or information from any one or more of the computer-implemented content and/or digital media creation and/or development system 10, the computer-implemented content and/or digital media processing and/or fulfillment system 20, the computer-implemented content and/or digital media publication and/or management system 50, and/or to any of the computer enabled and/or network enabled transaction devices 40, which may be utilized in conjunction with the present invention.

The communication device 30 also includes a database(s) 30H which can contain any and/or all of the data and/or information described herein as being stored in the databases of computer-implemented content and/or digital media creation and/or development system 10, the computer-implemented content and/or digital media processing and/or fulfillment system 20, the computer-implemented content and/or digital media publication and/or management system, and/or any of the computer enabled and/or network enabled transaction devices 40, described herein.

With reference once again to FIG. 4, the communication device 30 also includes an output device 30I such as a printer, a presentation, a display, an audio signal, a video signal, a text signal, a graphical signal, a read-out, a presenter, a 3-dimensional printer, a router, a modem, a networking device, a fax/modem, a transmitting device, or other output device, for providing data and/or information to the operator or user of the communication device 30 or to a third party or third party entity.

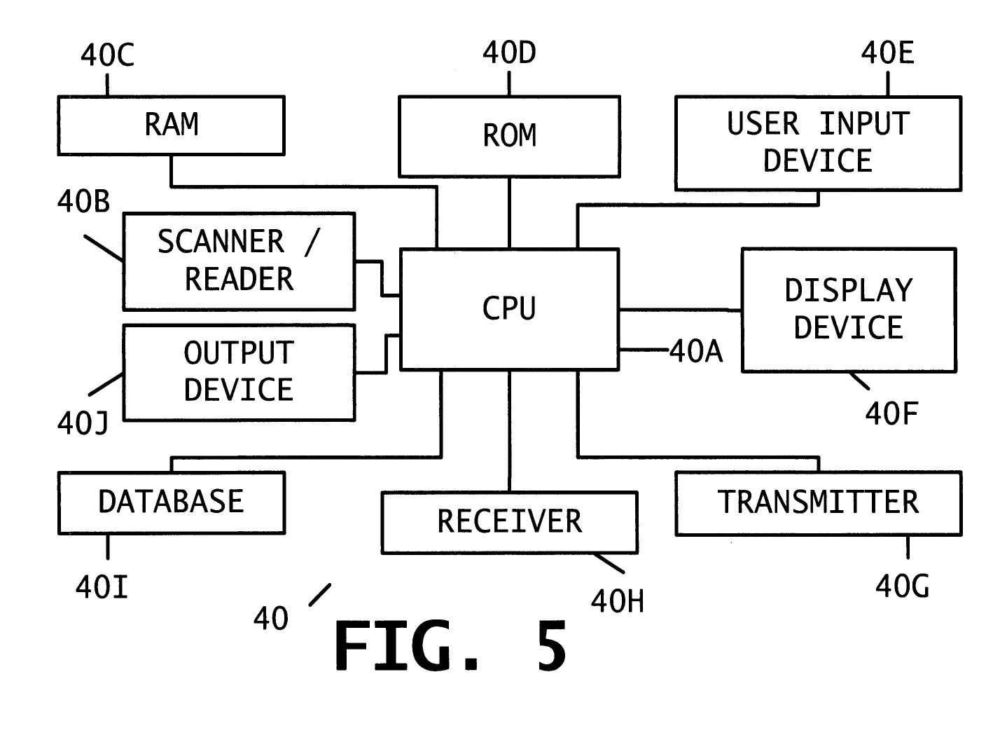

FIG. 5 illustrates the computer enabled and/or network enabled transaction device of FIG. 1, in block diagram form. In FIG. 5, the computer enabled and/or network enabled transaction device 40, in the preferred embodiment, includes a central processing unit or CPU 40A, a scanner/reader 40B, for scanning and/or reading any of the credit cards, charge cards, debit cards, value cards, smart cards, etc, which may be utilized in conjunction with the present invention. The scanner/reader 40A is connected to the CPU 40A. The computer enabled and/or network enabled transaction device 40 also includes associated random access memory 40C (RAM) and read only memory 40D (ROM) devices, which are also connected to the CPU 40A, a user input device 40E, which is typically any one or more of a key pad, a keyboard, a scanner, a touch pad, a signature pad, a card reader, a magnetic strip card reader, a user pointing device, such as, for example, a mouse, a touch pad, and/or an audio input device and/or a video input device, or the like, if desired, or other suitable input device for inputting data into the computer enabled and/or network enabled transaction device 40 and which is also connected to the CPU 40A, and a display device 40F for displaying information and/or data to a user or operator, which display device 40F is also connected to the CPU 40A.

The computer enabled and/or network enabled transaction device 40 also includes a transmitter 40G for transmitting signals and/or data to the computer-implemented content and/or digital media creation and/or development system 10, the computer-implemented content and/or digital media processing and/or fulfillment system 20, and/or the communication device 30 and/or to any other device associated with any of the subscription providers, the subscription fulfillment providers, and/or the subscribers described herein. The transmitter 40G is also connected to the CPU 40A. The computer enabled and/or network enabled transaction device 40 also includes a receiver 40H for receiving signals and/or data from any of the computer-implemented content and/or digital media creation and/or development system 10, the computer-implemented content and/or digital media processing and/or fulfillment system 20, 20, and the computer-implemented content and/or digital media publication and/or management system 50, and the computer-implemented content and/or digital media consumption and/or presentation system 60, and/or the communication device 30, and/or to any other device associated with any of the subscription providers, the subscription fulfillment providers, and/or the subscribers described herein. The receiver 40H is also connected to the CPU 40A.

The computer enabled and/or network enabled transaction device 40 also includes a database 40I. The database 40I can include any of the data and/or information described herein as being stored and/or which can be stored in the databases 10H, 20H, 50H, 60H and/or 30H, of the respective computer-implemented content and/or digital media creation and/or development system 10, the computer-implemented content and/or digital media processing and/or fulfillment system 20, the computer-implemented content and/or digital media publication and/or management system 50, and/or the computer-implemented content and/or digital media consumption and/or presentation system 60, and/or the communication device(s) 30, described herein.

The computer enabled and/or network enabled transaction device 40 also includes a printer 40J or other appropriate output device for outputting data to the operator and/or user and/or consumer. The printer 40J is also connected to the CPU 40A. In the preferred embodiment, the printer 40J prints documents and/or publications and/or receipts and/or tickets and/or similar authorizations and/or authentications and/or confirmations corresponding to any of the content and/or digital media transactions described herein as capable of being performed by the present invention.

The apparatus and method of present invention can be utilized so as to order and/or to initiate digital media commerce products and/or services, and/or sessions, application instances, commerce, and/or subscriptions, to renew digital media commerce products and/or services, and/or sessions, application instances, commerce, and/or subscriptions, to extend digital media commerce products and/or services, and/or sessions, application instances, commerce, and/or subscriptions, to cancel and/or to terminate digital media commerce products and/or services, and/or sessions, application instances, commerce, and/or subscriptions, and/or to service and/or to fulfill digital and/or to manage and/or to consume media commerce products and/or services, and/or sessions, application instances, commerce, and/or subscriptions, and/or to manage digital media commerce products and/or services, and/or sessions, application instances, commerce, and/or subscriptions and/or services, for any of the subscription, and for any of the services and/or products which can be the subject of the respective digital media commerce products and/or services, and/or sessions, application instances, commerce, and/or subscriptions.

The apparatus and method of the present invention facilitates the initiation and/or creation and/or development and/or processing and/or fulfillment and/or publication and/or management and/or consumption and/or presentation of digital media commerce products and/or services, and/or sessions, application instances, commerce, and/or subscriptions in a network environment. The apparatus and method of the present invention also facilitates enabling media commerce in a digital environment sessions, application instances, commerce, and/or subscriptions which have flexibility in the initiation and/or creation and/or development and/or processing and/or fulfillment and/or publication and/or management and/or consumption and/or presentation of same as well as facilitates enabling media commerce in a digital environment sessions, application instances, commerce, and/or subscriptions which have flexibility in the length and/or the duration of the session, usage, subscription, and/or commercial engagement.

The apparatus and method of the present invention also provides a computer-implemented digital media and/or digital media commerce products and/or services processing system 10, a computer-implemented digital media and/or digital media commerce products and/or services fulfillment system 20, and a computer-implemented digital media and/or digital media commerce products and/or services management system 50, any or all of whom can perform the functions of a clearinghouse for digital media commerce. The apparatus and method of the present invention also provides notification to subscribers and/or other parties regarding subscription offers, changes and/or information regarding an event, occurrence and/or happening regarding any of the digital media commerce products and/or services, and/or sessions, application instances, commerce, and/or subscriptions and/or any of the services described herein.

In the herein-described preferred embodiment operations of the present invention, the present invention can be utilized in conjunction with digital media commerce products and/or services, and/or sessions, application instances, commerce, and/or subscriptions involving, but not limited to, content, digital content, media, digital media, data, information, digital content transaction applications, digital content transaction services, digital content computing applications, digital content computing services, digital content communications applications, digital content communications services, periodicals, files, video, audio, images, avatars, pixel content and/or digital media, clear gifs, web beacons, voice, text, signals, hyper-links, programs, applications, applets, code, scripts, alerts, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, media and/or digital media commerce products and/or services, notifications, controls, communications, and/or an embodiment of information, and/or an embodiment of control functionality, as well as the analytics associated with any of the aforementioned data and/or information, ands/or any other commercial and/or informational and/or entertainment data and/or content, (hereinafter which may be referred to collectively as “media and/or digital media commerce products and/or services” or “media and/or digital media commerce products and/or services”).

The session, usage, subscription, and/or consumption can be for conventional printed media and/or digital media commerce products and/or services, media and/or digital media commerce products and/or services in electronic form or “e-media and/or digital media commerce products and/or services”, and/or media and/or digital media commerce products and/or services in any other form. Although described as being utilized in conjunction with digital media commerce products and/or services, and/or sessions, application instances, commerce, and/or subscriptions for media and/or digital media commerce products and/or services, the preferred embodiment operations of the present invention can be utilized in conjunction with digital media commerce products and/or services, and/or sessions, application instances, commerce, and/or subscriptions regarding any good and/or service which can be the subject of commerce. In this regard, the digital media commerce products and/or services, and/or sessions, application instances, commerce, and/or subscriptions described herein can involve, but not be limited to, digital media commerce products and/or services, and/or sessions, application instances, commerce, and/or subscriptions for and/or regarding movie rentals, video rentals, movie tickets, albums, music, audio files, video files, electronic books, electronic periodicals, electronic and/or digital media, digital content, show tickets, airline tickets, bus tickets, gasoline purchases, postage stamps and/or postage, meals tickets, tickets to sporting events, tickets to entertainment events, tickets to theater performances, professional services, contracted for services, and/or any other good and/or service which can be the subject of commerce.

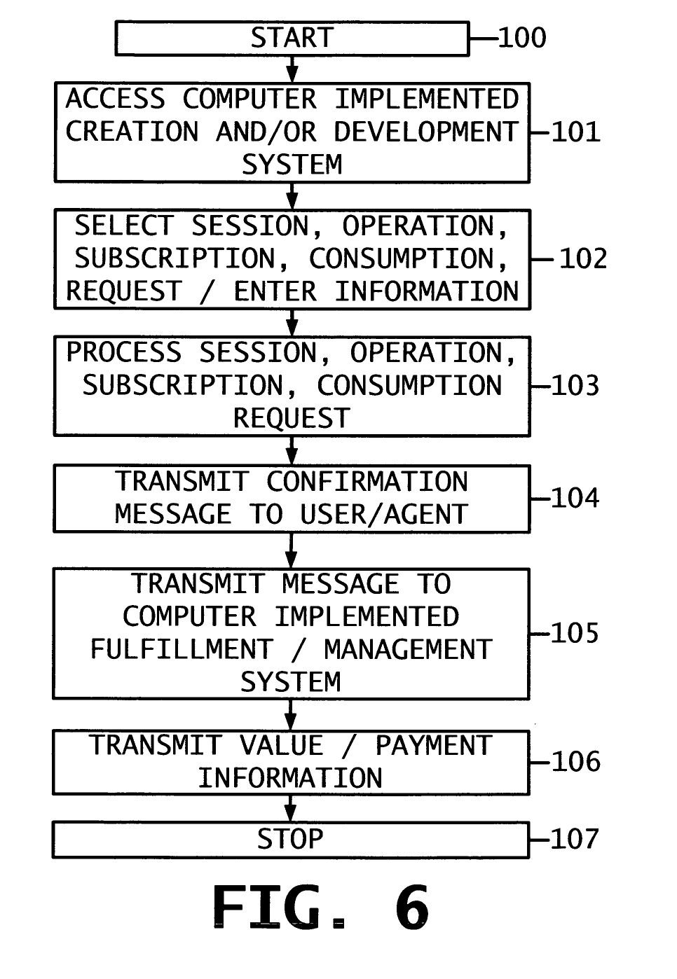

FIG. 6 illustrates a flow diagram of a preferred embodiment operation of the present invention in creating and/or initiating a session, a usage, consumption, and/or a subscription to a media and/or digital media commerce products and/or services. In a preferred embodiment, the apparatus can initiate and/or create a subscription which allows the individual user, operator, and/or subscriber to receive the digital media commerce at a computer enabled and/or network enabled media commerce facility, such as at a kiosk, billboard, display, speaker, microphone, point-of-sale device, computer, telephone, and/or similar communications and/or computing device enabling digital media commerce transmissions, a store, a theater, a stadium, or the like, thereby allowing the user and/or operator the freedom and convenience of transacting digital media commerce at any desired time and/or from any desired computer enabled and/or network enabled media commerce facility.

The apparatus can also initiate and/or create a subscription which can be a conventionally deliverable session, usage, consumption, and/or subscription which can be initiated and/or created via an on-line transaction and which allows the individual user, operator, and/or subscriber to dictate session, usage, and/or subscription parameters such, but not limited to, conditions and/or terms of agreement, payment terms, payment methods, length and/or term and/or quantities and/or periods, and/or any other parameters applicable to enabling media commerce in a digital environment.

Operation of the apparatus commences at step 100. At step 101, the user and/or operator can access the computer-implemented content and/or digital media creation and/or development system 10 via either the respective communication device 30 and/or the computer enabled and/or network enabled transaction device 40. In an alternative embodiment, the computer-implemented content and/or digital media creation and/or development system 10 can contact the user and/or operator via their communication device 30.

At step 102, the user and/or operator, the respective communication device 30 or computer enabled and/or network enabled device 40, can select the media and/or digital media commerce products and/or services or media and/or digital media commerce products and/or services which the user and/or operator wishes to use, access, operate, subscribe, and/or consume and/or receive. At step 102, the user and/or operator also enters and or selects the term of the subscription and/or the number of digital media commerce for which the user and/or operator wishes to subscribe. The user and/or operator can also, at step 102, enter or select a receipt of payment method which may include receipt of payment by credit card, charge card, debit card, direct withdrawal from checking account or savings account, cash receipt of payment at the computer enabled and/or network enabled media commerce location and/or at the location of the computer enabled and/or network enabled transaction device 40, and/or via electronic money, electronic cash, electronic check, digital money, and/or digital cash, and/or via with any authorization to receive payments towards any of the herein-described accounts, via the respective communication device 30 and/or computer enabled and/or network enabled transaction device 40. The user and/or operator may also, at step 102, enter or select to receive payment for the receiving of the digital media and/or digital media commerce products and/or services on a per tag basis, and/or on some multiple of content and/or digital media basis, and/or for some number of actions taken as a result of the receipt of the digital media and/or digital media commerce products and/or services, such as, but not limited to, making purchases, viewing content, making recommendations, responding to a media and/or digital media commerce products and/or services, forwarding a media and/or digital media commerce products and/or services, acknowledging a media and/or digital media commerce products and/or services, scanning a media and/or digital media commerce products and/or services, and/or on some basis which acknowledges their commercial relationship with the digital media creator and/or developer.

At step 102, the user and/or operator may also select the manner and/or mode by which he, she, or it, desires to effect content and/or digital media transactions. The user and/or operator may elect to effect digital media commerce transactions, such as receiving an installment of a multi-part media and/or digital media commerce products and/or services, such as in a marketing and/or political campaign, and/or the entire media and/or digital media commerce products and/or services, and thus accounting for such partial and/or full deliveries, and as well, the subscriber my effect digital media commerce delivery by utilizing an on-demand function, thus requesting the delivery of digital media and/or digital media commerce products and/or services by sending a corresponding command via communication device 30, and/or computer enabled and/or network enabled device 40, and whereby they may also utilize an access code or personal identification number (PIN) or code, by utilizing an account card having account and/or subscription information embedded in a magnetic strip or in an embedded microprocessor or micro-controller, by utilizing a credit card, a charge card, a debit card and/or any other device or entity for allowing the individual user, operator, and/or subscriber to effect a subscription transaction at the respective computer enabled and/or network enabled transaction device 40 and/or at the respective communication device 30.

At step 102, the user and/or operator can also enter and/or select any other information and/or instructions regarding the subscription, such as, for example, the number of digital media commerce desired, the length or duration of the subscription, the premise, the vehicle, the environment, the circumstances, the kiosk, billboard, display, speaker, microphone, point-of-sale device, computer, telephone, and/or similar communications and/or computing device enabling digital media commerce transmissions, the computer enabled and/or network enabled media commerce center and/or business where the user and/or operator desires or expects to receive and/or receive the digital media and/or digital media commerce products and/or services or digital media commerce of the subscription media and/or digital media commerce products and/or services, and/or the computer enabled and/or network enabled media commerce computer and/or business from which the user and/or operator desires and/or expects to receive delivery of the digital media commerce. The number of digital media commerce, the length or duration of the session, and/or subscription, and/or the servicing and/or processing and/or fulfillment services and/or conditions, can be flexible and can be changed by the individual and/or entity subscriber at any time and from any computer enabled and/or network enabled transaction device 40 and/or from any communication device 30 described herein.

At step 102, the user and/or operator may also have the various digital media and/or digital media commerce products and/or services delivery functions, subscription functions, commercial activities, and/or processes executed dynamically through the configuration of the subscription settings in the subscription account via the computer-implemented content and/or digital media creation and/or development system 10, the computer-implemented content and/or digital media processing and/or fulfillment system 20, and/or the computer-implemented content and/or digital media publication and/or management system 50, and/or the computer-implemented content and/or digital media consumption and/or presentation system 60.

In this manner, the apparatus and method of the present invention can be utilized to provide for flexible digital media commerce products and/or services, and/or sessions, application instances, commerce, and/or subscriptions and/or for flexibility in the initiation and/or creation and/or development and/or processing and/or fulfillment and/or publication and/or management and/or consumption and/or presentation and/or management of any of the digital media commerce products and/or services, and/or sessions, application instances, commerce, and/or subscriptions.

At step 103, the computer-implemented content and/or digital media creation and/or development system 10, will process the session, operation, use, and/or subscription request and/or any other information and/or instructions entered and/or elected at step 102 and create the desired subscription.

At step 104, the computer-implemented content and/or digital media creation and/or development system 10 will transmit an appropriate confirmation media and/or digital media commerce products and/or services to the user and/or operator at the respective communication device 30 and/or at the respective computer enabled and/or network enabled transaction device 40, notifying the user and/or operator of the creation and/or the initiation of the subscription. At step 105, the computer-implemented content and/or digital media creation and/or development system 10 will transmit an appropriate media and/or digital media commerce products and/or services and/or signal to the computer-implemented content and/or digital media processing and/or fulfillment system 20, and/or to the computer-implemented content and/or digital media publication and/or management system 50, to arrange for the operation execution and/or transmission of the respective request. Steps 104 and 105 may be interchanged and, therefore, can be performed in any order.

At step 106, the computer-implemented content and/or digital media creation and/or development system 10 will transmit information, and/or any appropriate account information, financial account information, communications account information, and/or subscriber and/or registrant account information, account card, smart card, and/or debit card, and/or any electronic and/or digital signals for programming any of the respective financial accounts, communications accounts, and/or subscriber and/or registrant accounts, account card, smart card, and/or debit card, with any respective value for effecting the transactions pursuant to the subscription to any one or more of the subscriber of the digital media commerce service, the digital media creator and/or developer, and/or the digital media commerce service provider, and/or agents or third-parties acting on their behalf. The respective communication devices 30 and/or computer enabled and/or network enabled transaction devices 40 can also include any appropriate device for programming and/or transferring subscription information and/or value to any of the respective financial accounts, communications accounts, and/or subscriber and/or registrant accounts, account cards, smart cards, and/or debit cards, described herein.

In any and/or all of the embodiments described herein, any of the communications which occur and/or which transpire between any of the computers and/or devices 10, 20, 30, 40, 50 and/or 60, described herein, and/or which occurs between any individual subscribers and/or operators and/or administrators of any of the computers and/or devices 10, 20, 30, 40, 50 and/or 60, can be effected by or via electronic mail (e-mail), electronic media and/or digital media commerce products and/or services transmission, SMS, electronic data transfer, electronic payment system, digital payment system, digital communications system, digital communications service, telephone media and/or digital media commerce products and/or services, voice mail media and/or digital media commerce products and/or services, pager media and/or digital media commerce products and/or services, beeper media and/or digital media commerce products and/or services, conventional mail letter or media and/or digital media commerce products and/or services, letter, telephone call, and/or any other manner and/or mode of communication.

Once step 106 is completed, the session, operation, use, application, subscription, content and/or digital media product and/or service will be activated. Thereafter, the operation of the portion of the apparatus related to the herein description of functionality will cease at step 107.

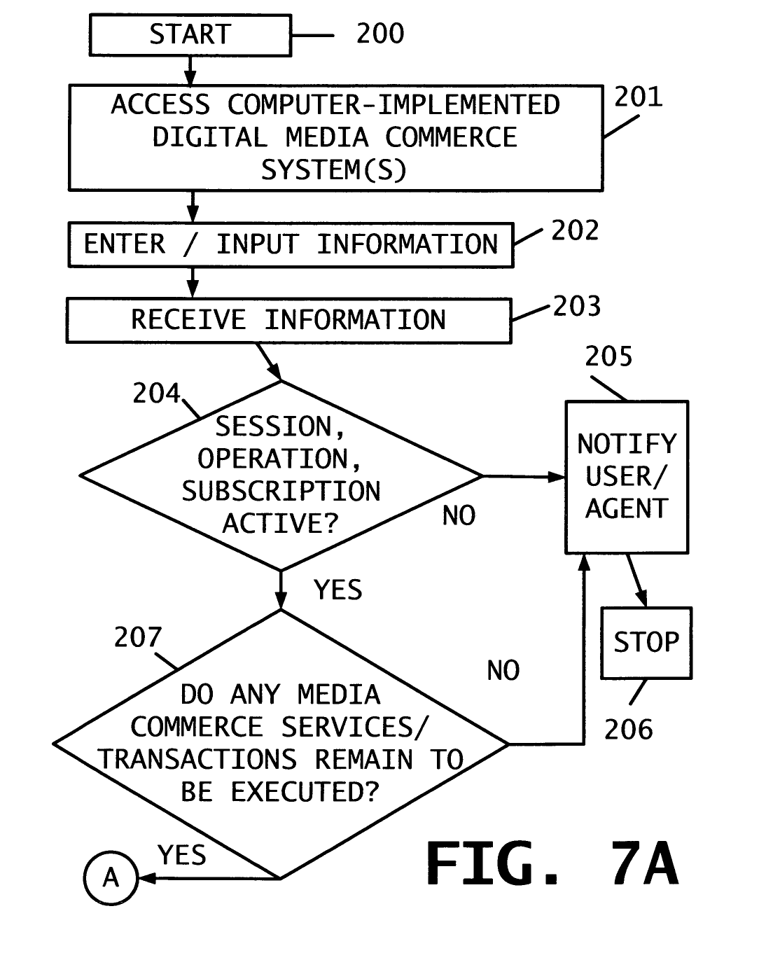

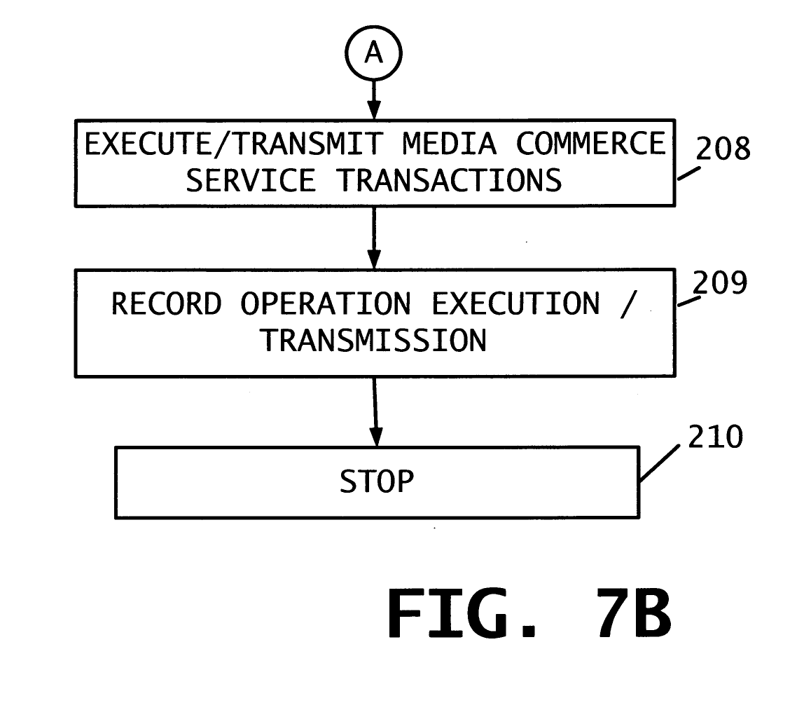

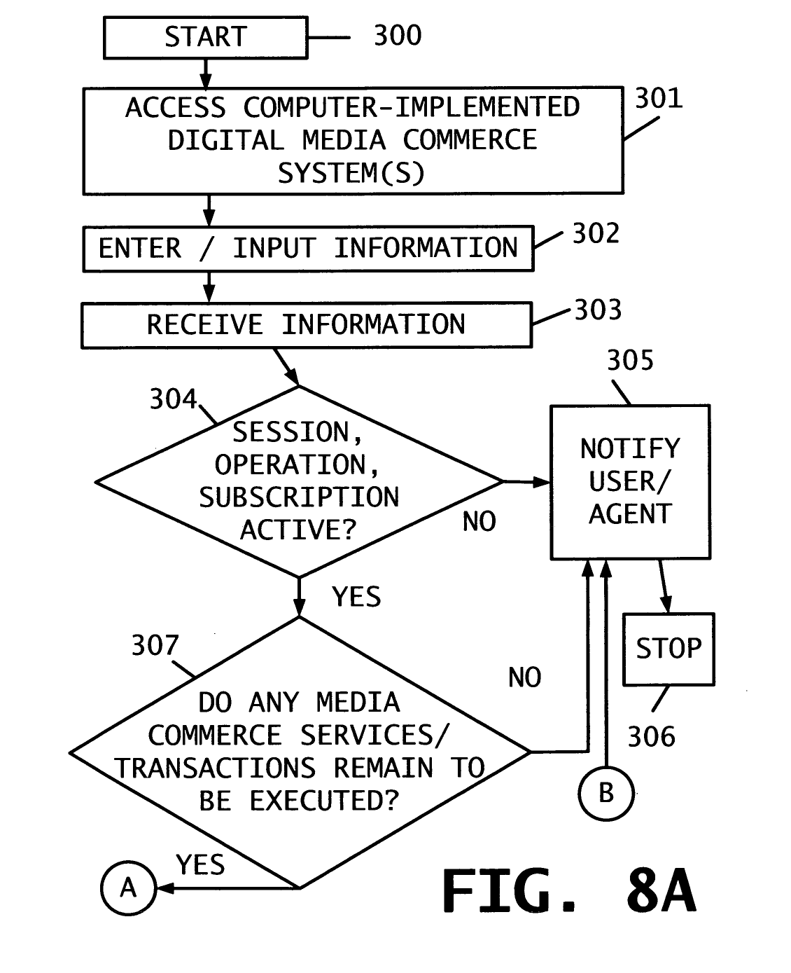

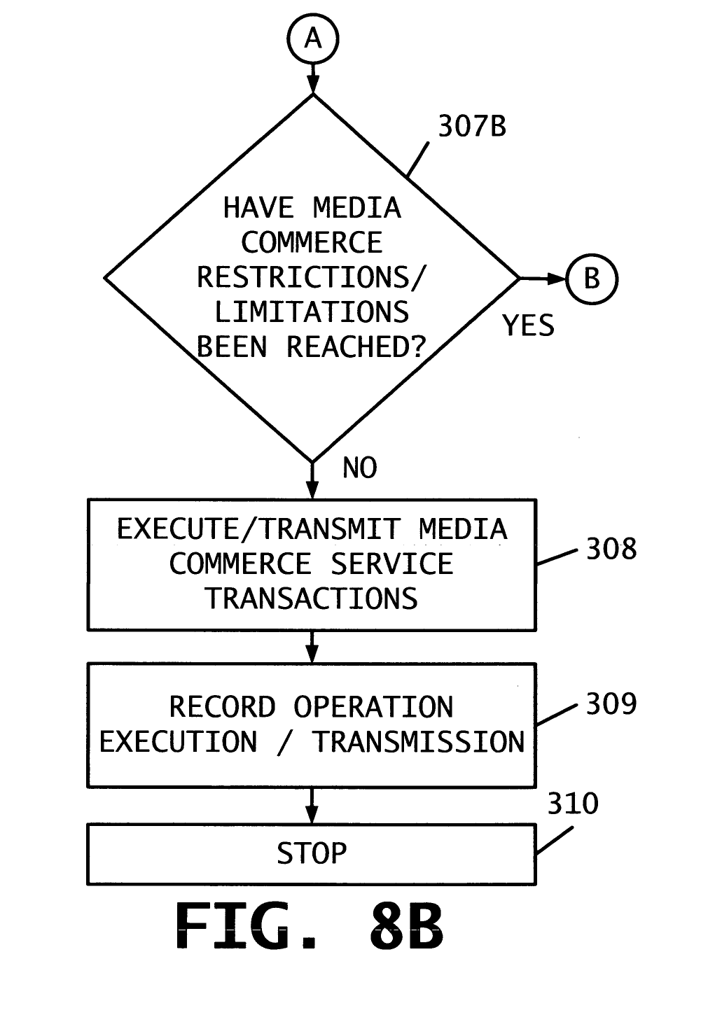

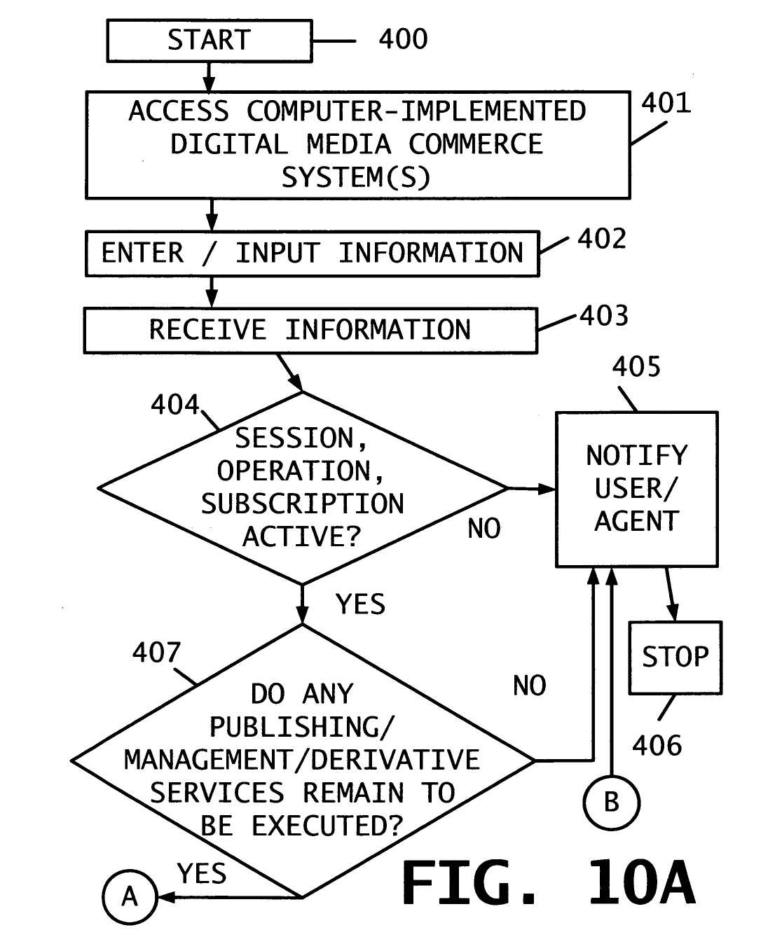

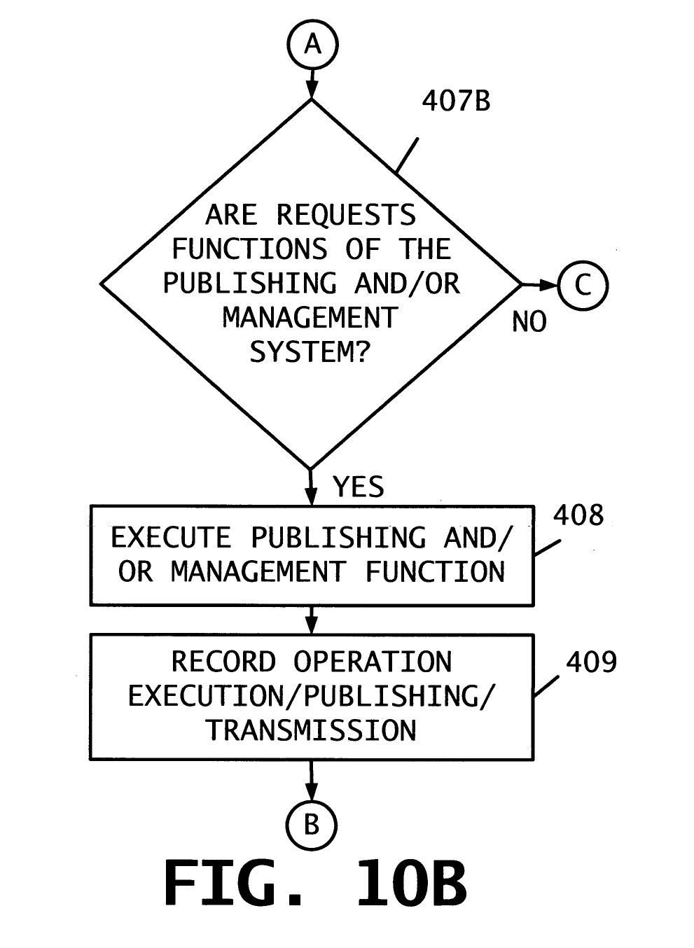

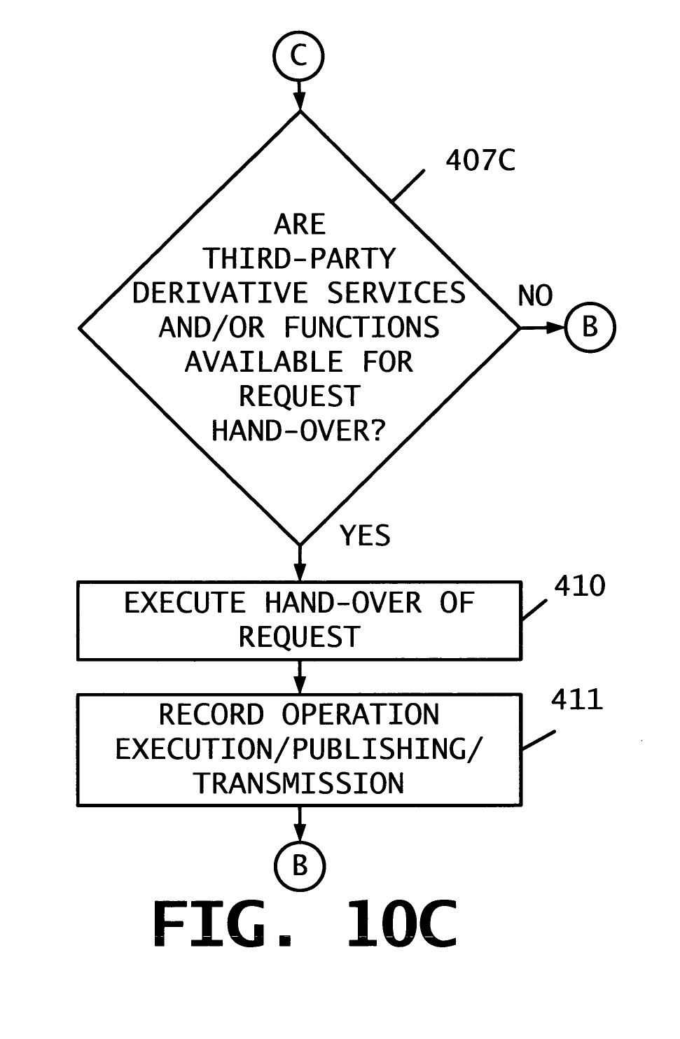

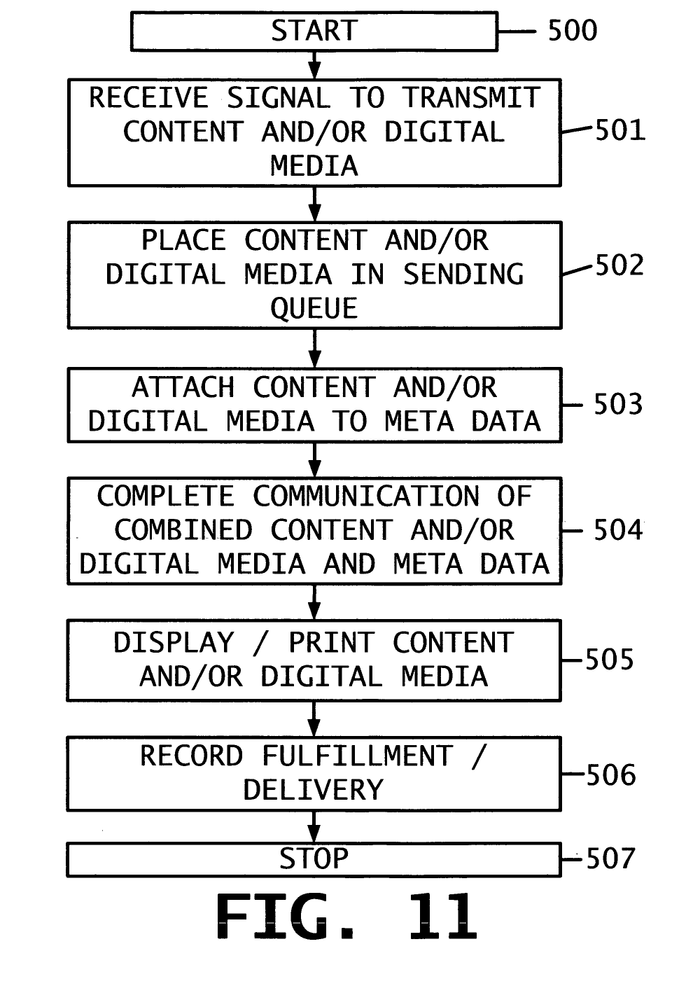

Thereafter, the user and/or operator may access the computer-implemented content and/or digital media creation and/or development system 10, such as at step 101 and/or 102, and/or the computer-implemented content and/or digital media processing and/or fulfillment system, such as at step 201 and/or 202, and/or, 301 and/or 302, and/or the computer-implemented content and/or digital media publication and/or management system, such as at step 401 and/or 402, and make changes to the session, usage, operation, subscription, creation, development, processing, fulfillment, publication, management, consumption, and/or presentation related request and/or terms, renew the session, usage, operation, subscription, creation, development, processing, fulfillment, publication, management, consumption, and/or presentation related commerce transaction and/or terms, extend the term of the session, usage, operation, subscription, creation, development, processing, fulfillment, publication, management, consumption, and/or presentation related commerce transaction and/or terms, lengthen the subscription, shorten the subscription, change and/or modify any of the conditions and/or information and/or instructions regarding the session, usage, operation, subscription, creation, development, processing, fulfillment, publication, management, consumption, and/or presentation related commerce transaction described herein, and/or entered and/or selected by the subscriber as described with reference to the description of the flow diagram of FIG. 6, FIG. 7A, FIG. 7B, FIG. 8A, FIG. 8B, FIG. 10A, FIG. 10B, FIG. 10C, and/or FIG. 11 and/or otherwise. The computer-implemented content and/or digital media creation and/or development system 10 will thereafter process the change to the session, usage, operation, subscription, creation, development, processing, fulfillment, publication, management, consumption, and/or presentation related commerce transaction, and update the session, usage, operation, subscription, creation, development, processing, fulfillment, publication, management, consumption, and/or presentation related commerce transaction data and/or information accordingly.

In this manner, the user and/or operator can renew a session, usage, operation, subscription, creation, development, processing, fulfillment, publication, management, consumption, and/or presentation related commerce transaction, extend the term of the session, usage, operation, subscription, creation, development, processing, fulfillment, publication, management, consumption, and/or presentation related commerce transaction, lengthen a session, usage, operation, subscription, creation, development, processing, fulfillment, publication, management, consumption, and/or presentation related commerce transaction, shorten a session, usage, operation, subscription, creation, development, processing, fulfillment, publication, management, consumption, and/or presentation related commerce transaction, expand the scope of the session, usage, operation, subscription, creation, development, processing, fulfillment, publication, management, consumption, and/or presentation related commerce transaction, reduce the scope of the session, usage, operation, subscription, creation, development, processing, fulfillment, publication, management, consumption, and/or presentation related commerce transaction, terminate the session, usage, operation, subscription, creation, development, processing, fulfillment, publication, management, consumption, and/or presentation related commerce transaction, alter the scope of the session, usage, operation, subscription, creation, development, processing, fulfillment, publication, management, consumption, and/or presentation related commerce transaction, change the terms of the session, usage, operation, subscription, creation, development, processing, fulfillment, publication, management, consumption, and/or presentation related commerce transaction, make, receive, and/or accept offers to expand and/or reduce, and/or alter the commercial and/or technical terms of the session, usage, operation, subscription, creation, development, processing, fulfillment, publication, management, consumption, and/or presentation related commerce transaction, interact with the system via a computer enabled and/or network enabled media commerce location, and/or computer enabled and/or network enabled device for the purpose of receiving and/or sending digital media commerce. session, usage, operation, subscription, creation, development, processing, fulfillment, publication, management, consumption, and/or presentation related commerce transaction changes may be entered and/or selected by the digital media publisher and/or manager and/or intermediary, digital media creator and/or developer, and/or digital media commerce service provider in real-time and/or otherwise, via a respective communication device 30 and/or plurality of devices, and/or via any computer enabled and/or network enabled transaction device 40.

At any time, the user and/or operator can also access any computer-implemented content and/or digital media creation and/or development system 10 and/or any computer-implemented content and/or digital media processing and/or fulfillment system 20, and computer-implemented content and/or digital media publication and/or management system 50, so as to determine the session, usage, operation, subscription, creation, development, processing, fulfillment, publication, management, consumption, and/or presentation related commerce transaction status and/or to change, alter and/or modify, any of the information, described herein and/or otherwise, which is related to, and/or regarding, the session, usage, operation, subscription, creation, development, processing, fulfillment, publication, management, consumption, and/or presentation related commerce transaction, the operation execution and/or transmission of the session, usage, operation, subscription, creation, development, processing, fulfillment, publication, management, consumption, and/or presentation related commerce transaction, the status of the session, usage, operation, subscription, creation, development, processing, fulfillment, publication, management, consumption, and/or presentation related commerce transaction, and/or the session, usage, operation, subscription, creation, development, processing, fulfillment, publication, management, consumption, and/or presentation related commerce transaction fulfillment status of the session, usage, operation, subscription, creation, development, processing, fulfillment, publication, management, consumption, and/or presentation related commerce transaction and/or the service status of the session, usage, operation, subscription, creation, development, processing, fulfillment, publication, management, consumption, and/or presentation related commerce transaction.

The respective computer-implemented content and/or digital media creation and/or development system 10 and/or the computer-implemented content and/or digital media processing and/or fulfillment system 20 and/or the computer-implemented content and/or digital media publication and/or management system 50 will thereafter process the change to the session, usage, operation, session, usage, operation, subscription, creation, development, processing, fulfillment, publication, management, consumption, and/or presentation related commerce transaction, and/or consumption commerce transaction, and update the session, usage, operation, session, usage, operation, subscription, creation, development, processing, fulfillment, publication, management, consumption, and/or presentation related commerce transaction, and/or consumption commerce transaction data and/or information accordingly.

FIGS. 7A and 7B illustrate a flow diagram of another preferred embodiment operation of the apparatus and method of the present invention in fulfilling digital media commerce products and/or services, and/or sessions, application instances, commerce, and/or session, usage, operation, subscription, creation, development, processing, fulfillment, publication, management, consumption, and/or presentation related commerce transactions and/or servicing digital media commerce products and/or services, and/or sessions, application instances, commerce, and/or session, usage, operation, subscription, creation, development, processing, fulfillment, publication, management, consumption, and/or presentation related commerce transactions. In the embodiment of FIGS. 7A and 7B, the apparatus allows the individual user, operator, and/or subscriber to receive the digital media commerce of the media and/or digital media commerce products and/or services at a computer enabled and/or network enabled media commerce facility, such as at a kiosk, billboard, display, speaker, microphone, point-of-sale device, computer, telephone, and/or similar communications and/or computing device enabling digital media commerce transmissions, a store, a theater, a stadium, or the like, thereby allowing the user and/or operator the freedom and convenience of transacting digital media commerce at any desired time and/or from any desired computer enabled and/or network enabled media commerce facility.

The operation of the present invention, as illustrated and described in FIGS. 7A and 7B, can typically be utilized once a session, usage, operation, subscription, creation, development, processing, fulfillment, publication, management, consumption, and/or presentation related commerce transaction has been initiated via the method described herein with reference to FIG. 6, as well as by any other conventional session, usage, operation, subscription, creation, development, processing, fulfillment, publication, management, consumption, and/or presentation related commerce transaction creating and/or initiation method.

In the preferred embodiment of FIGS. 7A and 7B, the apparatus of the present invention can also be utilized at the same time as, or in conjunction with, the commencement of a session, usage, operation, subscription, creation, development, processing, fulfillment, publication, management, consumption, and/or presentation related commerce transaction so as to provide for an immediate first digital media and/or digital media commerce transaction of products and/or services at the time, and or immediately following, the creation and/or commencement of the user and/or operator's session, usage, operation, subscription, creation, development, processing, fulfillment, publication, management, consumption, and/or presentation related commerce transaction. In this manner, a user, operator, and/or subscriber can, for example, go to a website, such as an online computer enabled and/or network enabled media commerce computer, request and enter into a transaction that will result in a communication and/or transaction involving media and/or digital media commerce products and/or services, have the session, usage, operation, subscription, creation, development, processing, fulfillment, publication, management, consumption, and/or presentation related commerce transaction initiated and/or created via the e-commerce enabled computer and/or network enabled transaction device 40, and conclude the online computer enabled and/or network enabled media commerce transaction with the receipt of the first digital media and/or digital media commerce products and/or services pursuant to the session, usage, operation, subscription, creation, development, processing, fulfillment, publication, management, consumption, and/or presentation related commerce transaction.

In another preferred embodiment, the operation of the apparatus of the present invention, as described herein with reference to the embodiment of FIG. 6, can be readily and easily modified so as to provide the user and/or operator with digital media and/or digital media commerce products and/or services and provide for an appropriate charging, debiting, and/or crediting, of the session, usage, operation, subscription, creation, development, processing, fulfillment, publication, management, consumption, and/or presentation related commerce transaction account, and/or associated financial accounts of the subscriber, as desired, if the commercial terms dictate that payment be made by the subscriber for the digital media and/or digital media commerce products and/or services.

The operation of the embodiment of FIGS. 7A and 7B commences at step 200. At step 201 the user, operator, and/or subscriber desiring to receive and/or access digital media and/or digital media commerce products and/or services can endeavor to access desired digital media and/or digital media commerce products and/or services by either configuring the computer-implemented content and/or digital media processing and/or fulfillment system 20 to automatically and/or dynamically execute functions on their behalf, and/or the user, operator, and/or subscriber desiring to receive and/or access digital media and/or digital media commerce products and/or services, and/or the salesperson or checkout person at the computer enabled and/or network enabled media commerce facility, can request the digital media and/or digital media commerce products and/or services by accessing the computer-implemented content and/or digital media processing and/or fulfillment system 20 via a respective communication device 30 and/or plurality of devices, and/or via any computer enabled and/or network enabled transaction device 40. Once the computer-implemented content and/or digital media processing and/or fulfillment systems 20 is accessed, session, usage, operation, subscription, creation, development, processing, fulfillment, publication, management, consumption, and/or presentation related commerce transaction account information is entered into either automatically or manually via the communication device 30, the computer enabled and/or network enabled transaction device 40, or any of the databases associated with the apparatus and/or method of the present invention 10H, 20H, 30H, 40H, 50H, and/or 60H, at step 202, by inputting same via digital information transfer, electronic information transfer, the user input device 40E, the communication device 30, and/or by scanner/reader 40B, a device and/or payment apparatus and/or payment card, and/or via a transaction apparatus utilized in conjunction with services provided by and/or with the digital media creator and/or developer and/or the digital media commerce service provider.

At step 202, any other information regarding and/or further identifying the session, usage, operation, subscription, creation, development, processing, fulfillment, publication, management, consumption, and/or presentation related commerce transaction account can also be entered and/or input. At step 203, the information entered and/or input at step 202 is transmitted to, and received by, the computer-implemented content and/or digital media processing and/or fulfillment system 20. At step 204, the computer-implemented content and/or digital media processing and/or fulfillment system 20 will process the information and determine whether the session, usage, operation, subscription, creation, development, processing, fulfillment, publication, management, consumption, and/or presentation related commerce transaction account is still active. If, at step 204, it is determined that the session, usage, operation, subscription, creation, development, processing, fulfillment, publication, management, consumption, and/or presentation related commerce transaction account is not active, the computer-implemented content and/or digital media creation and/or development system 20 will, at step 205, transmit a signal to communication device 30, and/or the computer enabled and/or network enabled transaction device 40, to provide notification of the inactive or lapsed account.

Thereafter, operation of the present invention will cease at step 206 and the user and/or operator may access the computer-implemented content and/or digital media creation and/or development system 10 so as to re-open and/or renew the session, usage, operation, subscription, creation, development, processing, fulfillment, publication, management, consumption, and/or presentation related commerce transaction. In another preferred embodiment, the computer-implemented content and/or digital media processing and/or fulfillment system 20 can transfer operation to the computer-implemented content and/or digital media creation and/or development system 10, at step 205. Thereafter, session, usage, operation, subscription, creation, development, processing, fulfillment, publication, management, consumption, and/or presentation related commerce transaction account re-opening and/or renewal can occur on-line via the communication device 30, and/or computer enabled and/or network enabled transaction device 40, and operation can proceed to step 202 to re-enter the pertinent account information. This preferred embodiment operation can facilitate a re-opening or renewal of the session, usage, operation, subscription, creation, development, processing, fulfillment, publication, management, consumption, and/or presentation related commerce transaction account in one and the same instance of receiving a media and/or digital media commerce products and/or services via communication device, and/or an informational and/or commercial transaction at a kiosk, billboard, display, speaker, microphone, point-of-sale device, computer, telephone, and/or similar communications and/or computing device enabling digital media commerce transmissions, and/or interaction between the user and/or operator and the salesperson or check-out person at a computer enabled and/or network enabled media commerce facility.

If, at step 204, it is determined that the session, usage, operation, subscription, creation, development, processing, fulfillment, publication, management, consumption, and/or presentation related commerce transaction account is still active, operation will proceed to step 207 and the computer-implemented content and/or digital media processing and/or fulfillment system 20 will determine if any digital media commerce remain to be executed within the parameters of the session, usage, operation, subscription, creation, development, processing, fulfillment, publication, management, consumption, and/or presentation related commerce transaction account. If, at step 207, it is determined that no digital media commerce remain to be executed within the parameters set forth, then operation will proceed to step 205 described above and notification of this fact will be provided to the user and/or operator via communications device 30, and/or the e-commerce computer enabled and/or network enabled device, and/or the e-commerce computer enabled and/or network enabled device, and/or the salesperson and/or checkout person via the computer enabled and/or network enabled transaction device 40.

Thereafter, operation of the apparatus will proceed as described above with operation either ceasing and/or the user and/or operator renewing the session, usage, operation, subscription, creation, development, processing, fulfillment, publication, management, consumption, and/or presentation related commerce transaction, extending the term of the session, usage, operation, subscription, creation, development, processing, fulfillment, publication, management, consumption, and/or presentation related commerce transaction, and/or purchasing additional digital media commerce and/or arranging for same.

If, at step 207, it is determined that digital media commerce remain to be executed within the parameters of the session, usage, operation, subscription, creation, development, processing, fulfillment, publication, management, consumption, and/or presentation related commerce transaction account, then operation will proceed to step 208 and the computer-implemented content and/or digital media processing and/or fulfillment system 20 will transmit a signal to the communications device 30, and/or the computer enabled and/or network enabled transaction device 40 authorizing the receipt of the digital media and/or digital media commerce products and/or services by the individual and/or entity subscriber. In the preferred embodiment, at step 208, the computer enabled and/or network enabled device 40, may generate a digital output, and/or printed receipt of the transaction, via the printer or output device 40J, and/or display device 40F, for the computer enabled and/or network enabled media commerce computer for the computer enabled and/or network enabled media commerce computer's records. In the preferred embodiment, at step 208, the computer enabled and/or network enabled device 40, will also generate a digital output and/or print a receipt of the transaction, via the printer or output device 40J, and/or display device 40F, for the user and/or operator for the user and/or operator's records.

At step 209, the computer-implemented content and/or digital media processing and/or fulfillment system 20 will record the operation execution and/or transmission of the transaction of the digital media and/or digital media commerce products and/or services delivery and/or transaction, decrease by one the number of digital media commerce remaining to be delivered on the session, usage, operation, subscription, creation, development, processing, fulfillment, publication, management, consumption, and/or presentation related commerce transaction account, in the case where a predetermined amount of digital media and/or digital media commerce products and/or services is being depleted, and/or will increase by one the number of digital media and/or digital media commerce products and/or services delivered on the session, usage, operation, subscription, creation, development, processing, fulfillment, publication, management, consumption, and/or presentation related commerce transaction account, in the case where the objective is to increase the number of delivered digital media commerce to either a predetermined amount, and dynamically calculated amount, and/or an unlimited amount, and provide all record updating for the session, usage, operation, subscription, creation, development, processing, fulfillment, publication, management, consumption, and/or presentation related commerce transaction account.

The computer-implemented content and/or digital media processing and/or fulfillment system 20, in the preferred embodiment, at step 209, will also update any and/or pertinent session, usage, operation, subscription, creation, development, processing, fulfillment, publication, management, consumption, and/or presentation related commerce transaction account records and/or information, for the session, usage, operation, subscription, creation, development, processing, fulfillment, publication, management, consumption, and/or presentation related commerce transaction account, in its database 20H as well as the corresponding records and/or information for the session, usage, operation, subscription, creation, development, processing, fulfillment, publication, management, consumption, and/or presentation related commerce transaction account which are stored in the database 10H of the computer-implemented content and/or digital media creation and/or development system 10 as well as the corresponding records and/or information for the session, usage, operation, subscription, creation, development, processing, fulfillment, publication, management, consumption, and/or presentation related commerce transaction account which are stored in the database 50H of the computer-implemented content and/or digital media publication and/or management system 50, 60H of the computer-implemented content and/or digital media consumption and/or presentation system 60. These updates to the computer-implemented content and/or digital media creation and/or development system database 10H, and the computer-implemented content and/or digital media publication and/or management system database 50H, and the computer-implemented content and/or digital media consumption and/or presentation system 60H, can be performed via transmitting an appropriate signal to the computer-implemented content and/or digital media creation and/or development systems 10 and/or systems 20, 50 and/or 60 via dynamically linked database methods and/or techniques, and/or via any other device, method and/or techniques known by those skilled in the art.

Thereafter, operation of the apparatus will cease at step 210.

In another preferred embodiment of the present invention, the apparatus and method of the present invention can provide for, and can perform processing and/or fulfillment services for, and regarding, digital media commerce products and/or services, and/or sessions, application instances, commerce, and/or session, usage, operation, subscription, creation, development, processing, fulfillment, publication, management, consumption, and/or presentation related commerce transactions which have flexibility regarding when digital media commerce can be obtained and/or skipped while still providing the user and/or operator with the value of, and/or with the number of digital media commerce products and/or services, and/or sessions, application instances, commerce, and/or session, usage, operation, subscription, creation, development, processing, fulfillment, publication, management, consumption, and/or presentation related commerce transactions for which the user and/or operator has contracted. In this manner, a user, operator, and/or subscriber who knows ahead of time that he or she may not be able to utilize digital media commerce of the media and/or digital media commerce products and/or services at certain times, can forego obtaining same and effectively lengthen the session, usage, operation, subscription, creation, development, processing, fulfillment, publication, management, consumption, and/or presentation related commerce transaction term and/or duration and/or attainment of commitment until he or she receives all digital media commerce.

For example, in one embodiment of such a flexible session, usage, operation, subscription, creation, development, processing, fulfillment, publication, management, consumption, and/or presentation related commerce transaction account, a user, operator, and/or subscriber can enter a session, usage, operation, subscription, creation, development, processing, fulfillment, publication, management, consumption, and/or presentation related commerce transaction for digital media and/or digital media commerce products and/or services to be transmitted on a weekly basis along with a SMS whereby he or she will receive a limited time offer of a discount on a digital media product that can be purchased at a particular digital media website. If the user and/or operator should be unavailable for a predetermined time from the computer enabled and/or network enabled media commerce computer, the media and/or digital media commerce products and/or services can be put queued and/or saved for delivery and/or use at a later time when the subscriber is back within the bounds designated by the limitation.

The amount and parameters of digital media and/or digital media commerce products and/or services flexibility can be dictated by each of the digital media creator and/or developers, and/or entities making associated offers.

FIGS. 8A and 8B illustrate a flow diagram of another preferred embodiment method for utilizing the apparatus of the present invention wherein the present invention is utilized to fulfill digital media commerce products and/or services, and/or sessions, application instances, commerce, and/or session, usage, operation, subscription, creation, development, processing, fulfillment, publication, management, consumption, and/or presentation related commerce transactions and/or to service digital media commerce products and/or services, and/or sessions, application instances, commerce, and/or session, usage, operation, subscription, creation, development, processing, fulfillment, publication, management, consumption, and/or presentation related commerce transactions.

In the preferred embodiment of FIGS. 8A and 8B, the apparatus of the present invention allows the individual user, operator, and/or subscriber to receive the digital media commerce on a communication device 30, and/or at an interne access device and/or computer enabled and/or network enabled device 40, of which either may be located at in a digital environment, such as a website and/or virtual premise, and/or a physical environment such as a computer enabled and/or network enabled media commerce shop, and/or a kiosk, billboard, display, speaker, microphone, point-of-sale device, computer, telephone, and/or similar communications and/or computing device enabling digital media commerce transmissions, thereby allowing the user and/or operator the freedom and convenience of transacting digital media commerce at any desired time and/or from any desired device. Further, in the embodiment of FIGS. 8A and 8B, the present invention allows the individual user, operator, and/or subscriber to receive or obtain digital media commerce products and/or services under a plethora of commercially available terms and/or communications means and/or modes as to provide maximum flexibility for the subscriber of digital media commerce and the providers of digital media commerce. In this manner, for example, a user, operator, and/or subscriber may delay, restrict, redirect, skip, miss, and/or otherwise alter the delivery of the digital media and/or digital media commerce products and/or services(s) and receive or obtain alternative, other, and/or future digital media commerce within the constraints of their session, usage, operation, subscription, creation, development, processing, fulfillment, publication, management, consumption, and/or presentation related commerce transaction agreement, and may where relevant, without forfeiting the value of the digital media and/or digital media commerce products and/or services(s).

The flexible session, usage, operation, subscription, creation, development, processing, fulfillment, publication, management, consumption, and/or presentation related commerce transaction described in conjunction with the preferred embodiment of FIGS. 8A and 8B, can provide a user, operator, and/or subscriber with greater flexibility in transacting digital media commerce products and/or services, and/or sessions, application instances, commerce, and/or session, usage, operation, subscription, creation, development, processing, fulfillment, publication, management, consumption, and/or presentation related commerce transactions as well as serve as an incentive to enter into a session, usage, operation, subscription, creation, development, processing, fulfillment, publication, management, consumption, and/or presentation related commerce transaction in the first place. The user and/or operator can also take advantage of offers, promotions, or the like, while obtaining the desired flexibility in obtaining digital media commerce. A user, operator, and/or subscriber can, as a result, obtain and enjoy the full value and/or number of digital media commerce when they are able.

It is understood, however, that flexibility can be limited. Digital media creator and/or developer may set its own limitations and/or restrictions on the flexibility associated with the delivery of the digital media and/or digital media commerce products and/or services and/or derivative offers and/or services with which it is associated. For example, a maximum time period in which the user, operator, and/or subscriber must obtain all of his or digital media commerce products and/or services, and/or sessions, and/or subscriptions or forfeit the opportunity to receive same. These terms, however, can be agreed upon by the contracting parties.

The operation of the embodiment of FIGS. 8A and 8B commences at step 300. At step 301, the user and/or operator desiring to receive and/or access digital media and/or digital media commerce products and/or services can automatically request and/or manually request the digital media and/or digital media commerce products and/or services by accessing the computer-implemented content and/or digital media processing and/or fulfillment system 20 via the communications device 30 and/or the computer enabled and/or network enabled transaction device 40. Once the computer-implemented content and/or digital media processing and/or fulfillment systems 20 is accessed, session, usage, operation, subscription, creation, development, processing, fulfillment, publication, management, consumption, and/or presentation related commerce transaction information and/or subscriber information is transmitted to the computer-implemented content and/or digital media processing and/or fulfillment system 20.

At step 302, any other information regarding and/or further identifying the session, usage, operation, subscription, creation, development, processing, fulfillment, publication, management, consumption, and/or presentation related commerce transaction account and/or request for digital media and/or digital media commerce products and/or services can also be entered via communications device input device 30D, and/or computer enabled and/or network enabled device 40E, and/or by swiping a respective account card, smart card, payment card, ticket, computer chip enabled device, or the like, and/or in the scanner/reader 40B.

At step 303, the information entered and/or input at step 302 is transmitted to, and received by, the computer-implemented content and/or digital media processing and/or fulfillment system 20. At step 304, the computer-implemented content and/or digital media processing and/or fulfillment system 20 will process the information and determine whether the session, usage, operation, subscription, creation, development, processing, fulfillment, publication, management, consumption, and/or presentation related commerce transaction account is still active. If, at step 304, it is determined that the session, usage, operation, subscription, creation, development, processing, fulfillment, publication, management, consumption, and/or presentation related commerce transaction account is not active, the computer-implemented content and/or digital media creation and/or development system 20 will, at step 305, transmit a signal to the communications device 30, and/or computer enabled and/or network enabled transaction device 40, to provide notification of the inactive or lapsed account.

Thereafter, operation of the present invention will cease at step 306 and the user and/or operator may thereafter, access the computer-implemented content and/or digital media creation and/or development system 10 so as to re-open and/or renew the session, usage, operation, subscription, creation, development, processing, fulfillment, publication, management, consumption, and/or presentation related commerce transaction. In another preferred embodiment, the computer-implemented content and/or digital media processing and/or fulfillment system 20 can transfer operation to the computer-implemented content and/or digital media creation and/or development system 10, at step 305. Thereafter, session, usage, operation, subscription, creation, development, processing, fulfillment, publication, management, consumption, and/or presentation related commerce transaction account re-opening and/or renewal can occur on-line via the communications device 30 and/or the computer enabled and/or network enabled transaction device 40 and operation can proceed to step 302 to re-enter the pertinent account information. By example, this preferred embodiment operation can facilitate a re-opening or renewal of the session, usage, operation, subscription, creation, development, processing, fulfillment, publication, management, consumption, and/or presentation related commerce transaction account in one and the same interaction between the user and/or operator and an e-commerce computer enabled and/or network enabled transaction on a website, and/or an in-person transaction at a computer enabled and/or network enabled media commerce facility.

If, at step 304, it is determined that the session, usage, operation, subscription, creation, development, processing, fulfillment, publication, management, consumption, and/or presentation related commerce transaction account is still active, operation will proceed to step 307A and the computer-implemented content and/or digital media processing and/or fulfillment system 20 will determine if any digital media commerce remain to be executed within the parameters of the session, usage, operation, subscription, creation, development, processing, fulfillment, publication, management, consumption, and/or presentation related commerce transaction account. If, at step 307A, it is determined that no digital media commerce remain to be executed within the parameters set forth, then operation will proceed to step 305 described above and notification of this fact will be provided to the user and/or operator via communication device 30, and/or the e-commerce computer enabled and/or network enabled device, and/or the e-commerce computer enabled and/or network enabled device, and/or the salesperson and/or checkout person via the computer enabled and/or network enabled transaction device 40.

Thereafter, operation of the apparatus will proceed as described above with operation either ceasing and/or the user and/or operator renewing the session, usage, operation, subscription, creation, development, processing, fulfillment, publication, management, consumption, and/or presentation related commerce transaction, extending the term of the session, usage, operation, subscription, creation, development, processing, fulfillment, publication, management, consumption, and/or presentation related commerce transaction, and/or subscribing to additional digital media commerce and/or arranging for same.

If, at step 307A, it is determined that digital media commerce remain to be executed within the parameters of the session, usage, operation, subscription, creation, development, processing, fulfillment, publication, management, consumption, and/or presentation related commerce transaction account, then operation will proceed to step 307B and the computer-implemented content and/or digital media processing and/or fulfillment system 20 will determine whether session, usage, operation, subscription, creation, development, processing, fulfillment, publication, management, consumption, and/or presentation related commerce transaction limitations and/or restrictions have been enacted and/or session, usage, operation, subscription, creation, development, processing, fulfillment, publication, management, consumption, and/or presentation related commerce transaction limitations and/or restrictions have been reached. If, at step 307B, it is determined that whether session, usage, operation, subscription, creation, development, processing, fulfillment, publication, management, consumption, and/or presentation related commerce transaction limitations and/or restrictions have been enacted and/or session, usage, operation, subscription, creation, development, processing, fulfillment, publication, management, consumption, and/or presentation related commerce transaction limitations and/or restrictions have been reached, then operation will proceed to step 305 described above and notification of this fact will be provided to the user and/or operator via communications device 30, and/or the e-commerce computer enabled and/or network enabled device, and/or the salesperson and/or checkout person via the computer enabled and/or network enabled transaction device 40. Thereafter, operation of the apparatus will proceed as described above with operation either ceasing and/or the user and/or operator renewing the session, usage, operation, subscription, creation, development, processing, fulfillment, publication, management, consumption, and/or presentation related commerce transaction, extending the term of the session, usage, operation, subscription, creation, development, processing, fulfillment, publication, management, consumption, and/or presentation related commerce transaction, and/or purchasing additional digital media commerce and/or arranging for same.

If, at step 307B, it is determined that no relevant session, usage, operation, subscription, creation, development, processing, fulfillment, publication, management, consumption, and/or presentation related commerce transaction limitations and/or restrictions have been enacted and/or that no session, usage, operation, subscription, creation, development, processing, fulfillment, publication, management, consumption, and/or presentation related commerce transaction limitations and/or restrictions have been reached, then operation will proceed to step 308 and the computer-implemented content and/or digital media processing and/or fulfillment system 20 will transmit digital media and/or digital media commerce products and/or services, or a signal to authorize, display, print, and/or by some other means produce, digital media and/or digital media commerce products and/or services, to the communications device 30, and/or the computer enabled and/or network enabled transaction device 40. In the preferred embodiment, at step 308, the communications device 30, and/or the computer enabled and/or network enabled device 40, will execute all relevant operations associated with the digital media and/or digital media commerce products and/or services, and may generate and display and/or print a record, ticket, receipt, or the like, of the transaction, via the output devices 30I and/or 40J, and/or display device 30E and/or 40F.

At step 309, the computer-implemented content and/or digital media processing and/or fulfillment system 20 will record the operation execution and/or transmission of the transaction of the digital media and/or digital media commerce products and/or services delivery and/or transaction, decrease by one the number of digital media commerce remaining to be delivered on the session, usage, operation, subscription, creation, development, processing, fulfillment, publication, management, consumption, and/or presentation related commerce transaction account, and/or increase by one the number of digital media commerce delivered on the session, usage, operation, subscription, creation, development, processing, fulfillment, publication, management, consumption, and/or presentation related commerce transaction, and/or note details of the transaction and/or associated transactions, and/or information collected during the digital media and/or digital media commerce products and/or services deliver, and/or related transaction, and provide all record updating for the session, usage, operation, subscription, creation, development, processing, fulfillment, publication, management, consumption, and/or presentation related commerce transaction account. The computer-implemented content and/or digital media processing and/or fulfillment system 20, in the preferred embodiment, at step 309, will also update any and/or pertinent session, usage, operation, subscription, creation, development, processing, fulfillment, publication, management, consumption, and/or presentation related commerce transaction account records and/or information, for the session, usage, operation, subscription, creation, development, processing, fulfillment, publication, management, consumption, and/or presentation related commerce transaction account, in its database 20H as well as the corresponding records and/or information for the session, usage, operation, subscription, creation, development, processing, fulfillment, publication, management, consumption, and/or presentation related commerce transaction account which are stored in the database 10H of the computer-implemented content and/or digital media creation and/or development system 10 as well as the corresponding records and/or information for the session, usage, operation, subscription, creation, development, processing, fulfillment, publication, management, consumption, and/or presentation related commerce transaction account which are stored in the database 50H of the computer-implemented content and/or digital media publication and/or management system 50, 60H of the computer-implemented content and/or digital media consumption and/or presentation system 60.

The above-described updates to the computer-implemented content and/or digital media creation and/or development system database 10H, the computer-implemented content and/or digital media processing and/or fulfillment system 20H, and the computer-implemented content and/or digital media publication and/or management system 50H, can be performed via transmitting an appropriate signal to the computer-implemented content and/or digital media creation and/or development system 10, computer-implemented content and/or digital media processing and/or fulfillment system 20, computer-implemented content and/or digital media publication and/or management system 50, computer-implemented content and/or digital media consumption and/or presentation system 60, and/or via dynamically linked database methods and/or techniques, and/or via any other device, method and/or techniques known by those skilled in the art.

Thereafter, operation of the apparatus will cease at step 310.

In any and/or all of the embodiments described herein, the computer-implemented content and/or digital media creation and/or development system 10 and/or the computer-implemented content and/or digital media processing and/or fulfillment system 20, and/or the computer-implemented content and/or digital media publication and/or management system 50, and/or the computer-implemented content and/or digital media consumption and/or presentation system 60, can provide processing for any number and/or type of digital media commerce products and/or services, and/or sessions, application instances, commerce, and/or session, usage, operation, subscription, creation, development, processing, fulfillment, publication, management, consumption, and/or presentation related commerce transactions. In this manner, the computer-implemented content and/or digital media creation and/or development system 10 and/or the computer-implemented content and/or digital media processing and/or fulfillment system 20 and/or the computer-implemented content and/or digital media publication and/or management system 50 and/or the computer-implemented content and/or digital media consumption and/or presentation system 60 can administer, manage, service, and/or provide processing, for any number and/or types of digital media commerce and/or digital media commerce products and/or services, and/or sessions, application instances, commerce, and/or session, usage, operation, subscription, creation, development, processing, fulfillment, publication, management, consumption, and/or presentation related commerce transactions.

In any and/or all of the embodiments described herein, the apparatus and method of the present invention can provide for digital media commerce products and/or services, and/or sessions, application instances, commerce, and/or session, usage, operation, subscription, creation, development, processing, fulfillment, publication, management, consumption, and/or presentation related commerce transactions which can be initiated and/or created and/or communicated and/or be operated upon via any communication device 30 and/or any computer enabled and/or network enabled transaction device 40. In any and/or all of the embodiments described herein, the digital media commerce products and/or services, and/or sessions, application instances, commerce, and/or session, usage, operation, subscription, creation, development, processing, fulfillment, publication, management, consumption, and/or presentation related commerce transactions can be delivered and/or serviced by any communications service, communications network, computer service, computer network, computer-implemented communications and/or computing environment, premise, vehicle, being, kiosk, billboard, display, speaker, microphone, point-of-sale device, computer, telephone, and/or similar communications and/or computing device enabling digital media commerce transmissions, computer enabled and/or network enabled media commerce and/or other facility. In this manner, for example, a user, operator, and/or subscriber may initiate a session, usage, operation, subscription, creation, development, processing, fulfillment, publication, management, consumption, and/or presentation related commerce transaction for a media and/or digital media commerce products and/or services from any location and receive the digital media commerce of the session, usage, operation, subscription, creation, development, processing, fulfillment, publication, management, consumption, and/or presentation related commerce transaction from any digital environment and/or physical computer enabled and/or network enabled media commerce facility which is a participating facility and/or a facility which utilizes the present invention and/or which utilizes an enabled communications device 30, and/or computer enabled and/or network enabled transaction device 40, thereby providing flexibility in the digital media and/or digital media commerce products and/or services receiving location.

In any and/or all of the embodiments described herein, the user and/or operator or an agent and/or other third party intermediary, can access the computer-implemented content and/or digital media creation and/or development system 10, and/or the computer-implemented content and/or digital media processing and/or fulfillment system 20, and/or the computer-implemented content and/or digital media publication and/or management system 50, and/or the computer-implemented content and/or digital media consumption and/or presentation system 60, via the communication device 30 and/or via the computer enabled and/or network enabled transaction device 40 so as to ascertain the status of an individual session, usage, operation, subscription, creation, development, processing, fulfillment, publication, management, consumption, and/or presentation related commerce transaction such as, but not limited to, whether the session, usage, operation, subscription, creation, development, processing, fulfillment, publication, management, consumption, and/or presentation related commerce transaction is active or inactive, and/or the fulfillment status of the session, usage, operation, subscription, creation, development, processing, fulfillment, publication, management, consumption, and/or presentation related commerce transaction, such as, but not limited to, the number of digital media commerce sent, and/or remaining on order, and/or any and all analytics associated with the digital media commerce and/or digital media and/or digital media commerce products and/or services, sessions, session, usage, operation, subscription, creation, development, processing, fulfillment, publication, management, consumption, and/or presentation related commerce transaction.

In any and/or all of the embodiments described herein, the digital media creator and/or developer, and/or digital media commerce service provider, and/or affiliated third party service providers, and/or an agent and/or other third party intermediary, can access the computer-implemented content and/or digital media creation and/or development system 10, and/or the computer-implemented content and/or digital media processing and/or fulfillment system 20, and/or the computer-implemented content and/or digital media publication and/or management system 50, and/or the computer-implemented content and/or digital media consumption and/or presentation system 60, via the communication device 30 and/or via the computer enabled and/or network enabled transaction device 40 so as to ascertain the status of a group of sessions, application instances, commerce, and/or session, usage, operation, subscription, creation, development, processing, fulfillment, publication, management, consumption, and/or presentation related commerce transactions, and/or a subset of a group of sessions, application instances, commerce, and/or session, usage, operation, subscription, creation, development, processing, fulfillment, publication, management, consumption, and/or presentation related commerce transactions, and/or an individual session, usage, operation, subscription, creation, development, processing, fulfillment, publication, management, consumption, and/or presentation related commerce transaction, and/or a subset of an individual session, usage, operation, subscription, creation, development, processing, fulfillment, publication, management, consumption, and/or presentation related commerce transaction such as, but not limited to, whether the session, usage, operation, subscription, creation, development, processing, fulfillment, publication, management, consumption, and/or presentation related commerce transaction(s) is active or inactive, and/or the fulfillment status of the session, usage, operation, subscription, creation, development, processing, fulfillment, publication, management, consumption, and/or presentation related commerce transaction(s), such as, but not limited to, the number of digital media commerce sent, and/or remaining on order(s), and/or any and all analytics associated with the digital media commerce and/or digital media and/or digital media commerce products and/or services, sessions, sessions, application instances, commerce, and/or session, usage, operation, subscription, creation, development, processing, fulfillment, publication, management, consumption, and/or presentation related commerce transactions.

In any and/or all of the embodiments described herein, the computer-implemented content and/or digital media creation and/or development system 10, and/or the computer-implemented content and/or digital media processing and/or fulfillment system 20, and/or the computer-implemented content and/or digital media publication and/or management system 50, and/or the computer-implemented content and/or digital media consumption and/or presentation system 60, can also notify individual subscribers, via any means, method and/or manner of communication, via the communication device 30 and/or the computer enabled and/or network enabled transaction device 40, of available digital media commerce, and/or promotions, and/or offers, and/or specials, and/or exclusives of digital media commerce, and/or products and/or services associated with digital media commerce, alerts, renewal notices, extension notices, termination notices, session, usage, operation, subscription, creation, development, processing, fulfillment, publication, management, consumption, and/or presentation related commerce transaction creation and/or initiation notices, shipment to and/or arrival of goods and services associated with the digital media and/or digital media commerce products and/or services, the session, usage, operation, subscription, creation, development, processing, fulfillment, publication, management, consumption, and/or presentation related commerce transaction digital media and/or digital media commerce products and/or services, goods and/or services at a respective computer enabled and/or network enabled media commerce facility and/or other facility associated with the digital media commerce, and/or of any other information which may be of interest to a user, operator, and/or subscriber.

In any and/or all of the embodiments described herein, the apparatus and method of the present invention can be utilized as a session, usage, operation, subscription, creation, development, processing, fulfillment, publication, management, consumption, and/or presentation related commerce transaction clearinghouse, to match individual digital media publisher and/or manager and/or intermediaries to digital media creator and/or developers, and/or offers from digital media creator and/or developers, and/or goods and/or services associated with digital media commerce, wherein information regarding any number of, and types of such expressions of interest and/or offers can be stored in the database 10H of the computer-implemented content and/or digital media creation and/or development system 10 and/or the database 20H of the computer-implemented content and/or digital media processing and/or fulfillment system 20 and/or the database 50H of the computer-implemented content and/or digital media publication and/or management system 50, and/or the database 60H of the computer-implemented content and/or digital media consumption and/or presentation system 60. Any individual digital media publisher and/or manager and/or intermediary, digital media creator and/or developer, digital media commerce service provider, and/or associated providers of goods and/or services, can access the respective computer-implemented content and/or digital media creation and/or development system 10 and/or computer-implemented content and/or digital media processing and/or fulfillment system 20 and/or the computer-implemented content and/or digital media publication and/or management system 50, and/or the computer-implemented content and/or digital media consumption and/or presentation system 60, and search for a desired digital media and/or digital media commerce products and/or services(s), offers, inquiries, digital media publisher and/or manager and/or intermediaries, digital media creator and/or developers, and/or digital media commerce service providers. Any of these entities may then apply to, inquire, offer, counter-offer, enroll in, and/or transact for the digital media and/or digital media commerce products and/or services and/or associated goods and/or services described herein.

In any and/or all of the embodiments described herein, a user, operator, and/or subscriber can input a request and/or an order for digital media and/or digital media commerce products and/or services and/or digital media commerce services, with information regarding the order being stored in the database 10H of the computer-implemented content and/or digital media creation and/or development system 10, and/or the database 20H of the computer-implemented content and/or digital media processing and/or fulfillment system 20, and/or the database 50H of the computer-implemented content and/or digital media publication and/or management system 50, and/or the database 60H of the computer-implemented content and/or digital media consumption and/or presentation system 60. The computer-implemented content and/or digital media creation and/or development system 10 and/or the computer-implemented content and/or digital media processing and/or fulfillment system 20 and/or the computer-implemented management system 50 can thereafter process the order or order and notify the subscriber via the communication device 30 and/or the computer enabled and/or network enabled transaction device 40 if and when the ordered and/or requested digital media and/or digital media commerce products and/or services and/or digital media and/or digital media commerce products and/or services service is available. The user and/or operator may be notified via any appropriate and/or available digital, electronic, and/or physical, and or other communications means, method and/or technique.

In any and/or all of the embodiments described herein, any of the computer-implemented content and/or digital media creation and/or development system 10, the computer-implemented content and/or digital media processing and/or fulfillment system 20, the computer-implemented content and/or digital media publication and/or management system 50, and/or the computer-implemented content and/or digital media consumption and/or presentation system 60, the communication device(s) 30, and/or the computer enabled and/or network enabled transaction device(s) 40, can be programmed for automatic operation, self-activation, and/or programmed operation. The computer-implemented content and/or digital media creation and/or development system 10, and/or the computer-implemented content and/or digital media processing and/or fulfillment system 20, and/or the computer-implemented content and/or digital media publication and/or management system 50, and/or the computer-implemented content and/or digital media consumption and/or presentation system 60, can be programmed to automatically generate and/or to transmit media and/or digital media commerce products and/or services and/or notices to any of the user and/or operators, computer enabled and/or network enabled media commerce computers, goods and/or services providers, or the like, regarding digital media commerce, digital media commerce products and/or services, and/or sessions, application instances, commerce, and/or session, usage, operation, subscription, creation, development, processing, fulfillment, publication, management, consumption, and/or presentation related commerce transactions, session, usage, operation, subscription, creation, development, processing, fulfillment, publication, management, consumption, and/or presentation related commerce transaction fulfillment, the availability of digital media commerce, offers related to digital media commerce products and/or services, and/or sessions, application instances, commerce, and/or session, usage, operation, subscription, creation, development, processing, fulfillment, publication, management, consumption, and/or presentation related commerce transactions, availability of digital media commerce and/or goods and/or services which are the associated with digital media commerce session, use session, time of operation, and/or session, usage, operation, subscription, creation, development, processing, fulfillment, publication, management, consumption, and/or presentation related commerce transaction.

In any and/or all of the embodiments described herein, intelligent agents, software agents, and/or mobile agents, and/or computer code, and/or computer applications, and/or applets, and/or scripts, can be utilized so as to act on behalf of any of the parties and/or any of the respective computers and/or devices described herein. Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

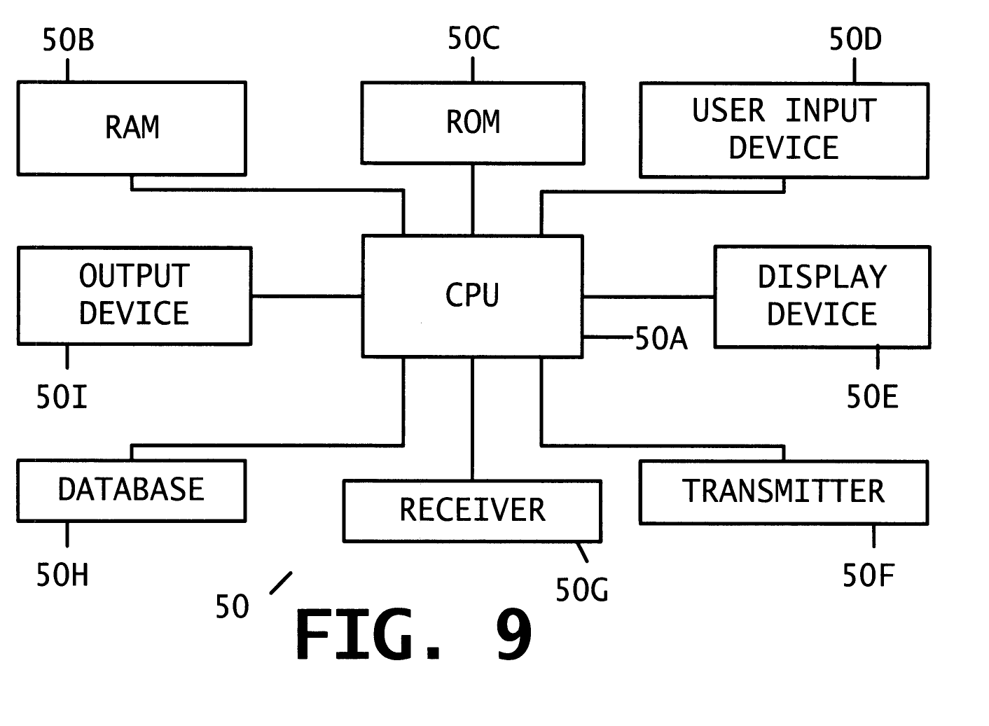

FIG. 9 illustrates the computer-implemented content and/or digital media publication and/or management system 50, in block diagram form. The computer-implemented content and/or digital media publication and/or management system 50, in the preferred embodiment, is a network computer or computer system which is utilized as a computer-implemented content and/or digital media publication and/or management system such as a server, network computer, server, network computers in a datacenter, a web server, network computer, an Internet server, network computer, an e-commerce server, network computer, a communications server, network computer, a database server, network computer, a mobile computer, and/or any similar computer or computer system.

The computer-implemented content and/or digital media publication and/or management system 50 can also be any other computer or computer system which can be utilized in any computing and/or communication network. In the preferred embodiment, the computer-implemented content and/or digital media publication and/or management system 50 includes a central processing unit or CPU 50A, which in the preferred embodiment, is a microprocessor. The CPU 50A may also be a microcomputer, a minicomputer, a macro-computer, a computer on a chip, a nano computer, a quantum computer, a website, a blog, a SMS, an instant message, a tweet, a posting, an application, an applet, a synthetic computer, a biological computer, a multi-core computer, a multi-component computer, a physical computer, a virtualized computer, a single computer, a combination of computers, a computer system, a networked computer system, and/or a mainframe computer, depending upon the application.

The computer-implemented content and/or digital media publication and/or management system 50 also includes a random access memory device(s) 50B (RAM) and a read only memory device(s) 50C (ROM), each of which is connected to the CPU 50A, a user input device 50D, for entering data and/or commands into the computer-implemented content and/or digital media publication and/or management system 50, which includes any one or more of a key pad, a keyboard, a scanner, a touch pad, a signature pad, a card reader, a magnetic strip card reader, a biometric scanner, a subscriber identity module reader, a chip reader, a signal scanner, a camera, a video camera, a microphone, a graphic image and/or video signal generator, an audio signal and/or audio image generator, a user pointing device, such as, for example, a mouse, a touch pad, and/or an audio input device and/or a video input device, or the like, if desired, which input device(s) is also connected to the CPU 50A.

The computer-implemented content and/or digital media publication and/or management system 50 also includes a display device 50E for displaying data and/or information to a user or operator.

The computer-implemented content and/or digital media publication and/or management system 50 also includes a transmitter(s) 50F, for transmitting signals and/or data and/or information to any one or more of the computer-implemented content and/or digital media publication and/or management system 50, the computer-implemented content and/or digital media processing and/or fulfillment system 20, the computer-implemented content and/or digital media publication and/or management system 50, the computer-implemented content and/or digital media consumption and/or presentation system 60, the computer enabled and/or network enabled transaction devices 40, and the communication devices 30, which may be utilized in conjunction with the present invention. The computer-implemented content and/or digital media publication and/or management system 50 also includes a receiver 50G, for receiving signals and/or data and/or information from to any one or more of the computer-implemented content and/or digital media publication and/or management system 50, the computer-implemented content and/or digital media processing and/or fulfillment system 20, the computer-implemented content and/or digital media publication and/or management system 50, the computer-implemented content and/or digital media consumption and/or presentation system 60, the computer enabled and/or network enabled transaction devices 40, and the communication devices 30, which may be utilized in conjunction with the present invention.

The computer-implemented content and/or digital media publication and/or management system 50 also includes a database 50H. The database can include data and/or information regarding digital media creator and/or developer, or entity which provides data and/or information and/or functionality which may be either attached to, embedded in, and/or associated with the digital media commerce, for which sessions, application instances, commerce, and/or session, usage, operation, subscription, creation, development, processing, fulfillment, publication, management, consumption, and/or presentation related commerce transactions are provided and/or available via the apparatus of the present invention. The database 50H can also include data and/or information regarding the services and/or products that may be provided in association with, and/or derived from, the digital media commerce services.

The database 50H can also include data and/or information regarding the subscriber, including all histories of usage, commercial terms, payments, technical, and/or communications usage in conjunction with the digital media commerce service. The database 50H can also include all data and/or information regarding the subscriber including all communications account information, financial account information, and a multitude of profiling information including, but not limited to, preferences, demographics, activity streams, behavioral targeting, data logging. digital footprint, lifelog, lifestreaming, profiling, runtime intelligence, social translucence, trace, trace evidence, genetic sequencing, psychographics, data represented in Attention Profiling Mark-up Language, subject and/or interest item information, communications, browsing histories, browsing patterns, documents, files, computational usage statistics, communications usage statistics, content created, content viewed, heard and/or read, content downloaded, applications used and/or downloaded, search queries, search results, click-through on search results, digital traces, activities, behaviors, login and logouts, visit of pages, documents accesses, items created, affiliation to groups, attention, social group, repetition, location, reputation, financial activities, investing activities, income data, spending data, consumption and/or presentation data, tax data, credit data, credit history data, reputational data, media related data, sensor discovered data, sensor recorded data, digital footprints, digital finger prints, life streams, social media linkages, social media activities, communications activities, computing activities, personal status, medical information, health information, personally identifiable information, volunteered information, collected information, rumored information, non-volunteered information, information capable of being stored in log files, information capable of being stored locally and/or or in a private and/or public cloud computing environment, information capable of being stored in databases, mined data, as well as the analytics associated with the aforementioned data and/or information, with respect to the services provided related to digital media commerce.

The database 50H can also include data and/or information regarding the services provided by the digital media commerce service provider, and/or affiliated service providers, including services previously offered, currently offered, and/or prospectively offered, content, communications, and/or commercial information regarding digital media commerce including, but not limited to, data received by and/or from the digital media publisher and/or manager and/or intermediary, data received by and/or from the digital media creator and/or developer, and/or data generated by the digital media commerce service provider through activities associated with the providing of digital media commerce services, as well as the analytics associated with any of the aforementioned data and/or information, with respect to the services provided related to digital media commerce.

The database 50H can also include data and/or information regarding the actual content and/or digital media provided and/or offered by the digital media creator and/or developers, including, but not limited to content, digital content, media, digital media, data, information, digital content transaction applications, digital content transaction services, digital content computing applications, digital content computing services, digital content communications applications, digital content communications services, periodicals, files, video, audio, images, avatars, pixel content and/or digital media, clear gifs, web beacons, voice, text, signals, hyper-links, programs, applications, applets, code, scripts, alerts, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, media and/or digital media commerce products and/or services, notifications, controls, communications, and/or an embodiment of information, and/or an embodiment of control functionality, as well as the analytics associated with any of the aforementioned data and/or information (hereinafter which may be referred to collectively as “media and/or digital media commerce products and/or services” or “media and/or digital media commerce products and/or services”), with respect to the services provided related to digital media commerce.

The database 50H also includes information regarding the digital media commerce products and/or services, and/or sessions, application instances, commerce, and/or session, usage, operation, subscription, creation, development, processing, fulfillment, publication, management, consumption, and/or presentation related commerce transactions which each subscriber has initiated, is using, is/was engaged in, and/or subscribed to, type of session, usage, operation, subscription, creation, development, processing, fulfillment, publication, management, consumption, and/or presentation related commerce transaction, session, usage, operation, subscription, creation, development, processing, fulfillment, publication, management, consumption, and/or presentation related commerce transaction length or duration, session, usage, operation, subscription, creation, development, processing, fulfillment, publication, management, consumption, and/or presentation related commerce transaction cost, session, usage, operation, subscription, creation, development, processing, fulfillment, publication, management, consumption, and/or presentation related commerce transaction renewals, session, usage, operation, subscription, creation, development, processing, fulfillment, publication, management, consumption, and/or presentation related commerce transaction extensions, digital media commerce received and/or offered, status of session, usage, operation, subscription, creation, development, processing, fulfillment, publication, management, consumption, and/or presentation related commerce transaction agreement, remaining session, usage, operation, subscription, creation, development, processing, fulfillment, publication, management, consumption, and/or presentation related commerce transaction agreement commitments, and/or any other relevant information regarding the respective digital media commerce products and/or services, and/or sessions, application instances, commerce, and/or session, usage, operation, subscription, creation, development, processing, fulfillment, publication, management, consumption, and/or presentation related commerce transactions and/or the operation execution and/or transmission of the respective digital media commerce products and/or services, and/or sessions, application instances, commerce, and/or session, usage, operation, subscription, creation, development, processing, fulfillment, publication, management, consumption, and/or presentation related commerce transactions.

The database 50H also includes information regarding the date the respective digital media commerce products and/or services, and/or sessions, application instances, commerce, and/or session, usage, operation, subscription, creation, development, processing, fulfillment, publication, management, consumption, and/or presentation related commerce transactions were ordered, became effective, date/time of the start of the session and/or session, usage, operation, subscription, creation, development, processing, fulfillment, publication, management, consumption, and/or presentation related commerce transaction, date/time of session and/or session, usage, operation, subscription, creation, development, processing, fulfillment, publication, management, consumption, and/or presentation related commerce transaction termination, computer enabled and/or network enabled media commerce computer and/or session and/or session, usage, operation, subscription, creation, development, processing, fulfillment, publication, management, consumption, and/or presentation related commerce transaction origination agent from who the session and/or session, usage, operation, subscription, creation, development, processing, fulfillment, publication, management, consumption, and/or presentation related commerce transaction originated, and the computer enabled and/or network enabled media commerce computer, goods provider, and/or services provider, session application provider, session, usage, operation, subscription, creation, development, processing, fulfillment, publication, management, consumption, and/or presentation related commerce transaction service entity, and/or service, session, and/or session, usage, operation, subscription, creation, development, processing, fulfillment, publication, management, consumption, and/or presentation related commerce transaction fulfillment entity and/or agent from whom the subscriber will obtain the respective digital media commerce products and/or services, which are be the subject of the digital media commerce products and/or services, and/or sessions, application instances, commerce, and/or session, usage, operation, subscription, creation, development, processing, fulfillment, publication, management, consumption, and/or presentation related commerce transactions. The database 50H also includes information regarding customer service agents and/or entities for providing customer services for, and/or regarding, any of the respective digital media commerce products and/or services, and/or sessions, application instances, commerce, and/or session, usage, operation, subscription, creation, development, processing, fulfillment, publication, management, consumption, and/or presentation related commerce transactions.

The database 50H may also contain any other information which may be relevant, pertinent, useful, and/or desired, for facilitating the operation of the apparatus and method of the present invention as described herein and/or as related thereto.

The database 50H, in the preferred embodiment, is a database which may include individual databases or collections of databases, with each database being designated to store any and all of the data and/or information described herein. Applicant hereby incorporates by reference herein the teachings of Basic Business Statistics Concepts and Applications, Mark L. Berenson and David M. Levine, 6.sup.th Edition, Prentice Hall 1996.

The database 50H, or collection of databases, may be updated by each of the respective individual subscribers, computer-implemented content and/or digital media publication and/or management system operator or administrator, computer-implemented content and/or digital media processing and/or fulfillment system operator or administrator, computer-implemented content and/or digital media publication and/or management system operator or administrator, computer-implemented content and/or digital media consumption and/or presentation operator or administrator, computer enabled and/or network enabled transaction device operator, communication device operator or administrator, via any of their respective computers and/or devices, and/or by any other third party, in real-time, and/or via dynamically linked database management techniques.

The data and/or information stored in the database 50H can also be updated by external sources. The database 50H will contain any and all information deemed necessary and/or desirable for providing all of the processing and/or services and/or functions described herein. Applicant hereby incorporates by reference herein the subject matter of Fundamentals of Database Systems, by Ramez Elmasri and Shamkant B. Navathe, 2.sup.nd Ed., Addison-Wesley Publishing Company, 1994.

The database 50H can also include any contact information for any of the subscribers, session, usage, operation, subscription, creation, development, processing, fulfillment, publication, management, consumption, and/or presentation related commerce transaction providers, session, usage, operation, subscription, creation, development, processing, fulfillment, publication, management, consumption, and/or presentation related commerce transaction fulfillment providers, computer enabled and/or network enabled media commerce computers, computer enabled and/or network enabled entities, or the like, such as, but not limited to, names, addresses, telephone numbers, fax numbers, e-mail addresses, URL's, websites, hyper-links, XML data, personal identification information, business identification information, SIC codes, links to third-party and/or government sponsored identification information, and/or any other contact information, for the respective party. The database 50H also includes any of the above-described contact information regarding any intermediaries, third parties, agents, and/or brokers, who utilize the apparatus of the present invention.

The database 50H can also include any other data and/or information needed and/or desired for facilitating the functions and operation of the present invention as described herein.

With reference once again to FIG. 9, the computer-implemented content and/or digital media publication and/or management system 50 also includes an output device 50I such as a printer, a presentation, a display, an audio signal, a video signal, a text signal, a graphical signal, a read-out, a presenter, a 3-dimensional printer, a router, a modem, a networking device, a fax/modem, a transmitting device, or other output device, for providing data and/or information to the operator or user of the computer-implemented content and/or digital media publication and/or management system 50 or to a third party or third party entity.

FIGS. 10A, 10B, and 10C illustrate a flow diagram of another preferred embodiment method for utilizing the apparatus of the present invention wherein the present invention is utilized to publish and/or manage digital media commerce products and/or services, and/or sessions, application instances, commerce, and/or session, usage, operation, subscription, creation, development, processing, fulfillment, publication, management, consumption, and/or presentation related commerce transactions and/or to service digital media commerce products and/or services, and/or sessions, application instances, commerce, and/or session, usage, operation, subscription, creation, development, processing, fulfillment, publication, management, consumption, and/or presentation related commerce transactions.

In the preferred embodiment of FIGS. 10A, 10B, and 10C, the apparatus of the present invention allows the individual user, operator, and/or subscriber to receive the digital media commerce on a communication device 30, and/or at an internet access device and/or computer enabled and/or network enabled device 40, of which either may be located at in a digital environment, such as a website and/or virtual premise, and/or a physical environment such as a computer enabled and/or network enabled media commerce shop, and/or a kiosk, billboard, display, speaker, microphone, point-of-sale device, computer, telephone, and/or similar communications and/or computing device enabling digital media commerce transmissions, thereby allowing the user and/or operator the freedom and convenience of transacting digital media commerce at any desired time and/or from any desired device. Further, in the embodiment of FIGS. 10A, 10B, and 10C, the present invention allows the individual user, operator, and/or subscriber to receive or obtain digital media commerce products and/or services under a plethora of commercially available terms and/or communications means and/or modes as to provide maximum flexibility for the subscriber of digital media commerce and the providers of digital media commerce. In this manner, for example, a user, operator, and/or subscriber may delay, restrict, redirect, skip, miss, and/or otherwise alter the delivery of the digital media and/or digital media commerce products and/or services(s) and receive or obtain alternative, other, and/or future digital media commerce within the constraints of their session, usage, operation, subscription, creation, development, processing, fulfillment, publication, management, consumption, and/or presentation related commerce transaction agreement, and may where relevant, without forfeiting the value of the digital media and/or digital media commerce products and/or services(s).

The flexible session, usage, operation, subscription, creation, development, processing, fulfillment, publication, management, consumption, and/or presentation related commerce transaction described in conjunction with the preferred embodiment of FIGS. 10A, 10B, and 10C, can provide a user, operator, and/or subscriber with greater flexibility in transacting digital media commerce products and/or services, and/or sessions, application instances, commerce, and/or session, usage, operation, subscription, creation, development, processing, fulfillment, publication, management, consumption, and/or presentation related commerce transactions as well as serve as an incentive to enter into a session, usage, operation, subscription, creation, development, processing, fulfillment, publication, management, consumption, and/or presentation related commerce transaction in the first place. The user and/or operator can also take advantage of offers, promotions, or the like, while obtaining the desired flexibility in obtaining digital media commerce. A user, operator, and/or subscriber can, as a result, obtain and enjoy the full value and/or number of digital media commerce when they are able.

It is understood, however, that flexibility can be limited. Digital media creator and/or developer may set its own limitations and/or restrictions on the flexibility associated with the delivery of the digital media and/or digital media commerce products and/or services and/or derivative offers and/or services with which it is associated. For example, a maximum time period in which the subscriber must obtain all of his or digital media commerce or forfeit the opportunity to receive same. These terms, however, can be agreed upon by the contracting parties.

The operation of the embodiment of FIGS. 10A, 10B, and 10C commences at step 400. At step 401, the user and/or operator desiring to have publishing and/or management functions executed related to their session, usage, operation, subscription, creation, development, processing, fulfillment, publication, management, consumption, and/or presentation related commerce transaction for digital media commerce and/or derivative services to be executed related to their session, usage, operation, subscription, creation, development, processing, fulfillment, publication, management, consumption, and/or presentation related commerce transaction for digital media commerce can automatically request and/or manually request the publication and/or management functions related to their session, usage, operation, subscription, creation, development, processing, fulfillment, publication, management, consumption, and/or presentation related commerce transaction for digital media commerce and/or derivative services related to their session, usage, operation, subscription, creation, development, processing, fulfillment, publication, management, consumption, and/or presentation related commerce transaction for digital media commerce by accessing the computer-implemented content and/or digital media publication and/or management system 50, and/or the computer-implemented content and/or digital media consumption and/or presentation system 60, via the communications device 30 and/or the computer enabled and/or network enabled transaction device 40. Once the computer-implemented content and/or digital media publication and/or management system 50, and/or the computer-implemented content and/or digital media consumption and/or presentation system 60, is accessed, requests and/or commands related to fulfillment of digital media commerce and/or session, usage, operation, subscription, creation, development, processing, fulfillment, publication, management, consumption, and/or presentation related commerce transaction information and/or subscriber information is transmitted to the computer-implemented content and/or digital media processing and/or fulfillment system 20.

At step 402, any other information regarding and/or further identifying the session, usage, operation, subscription, creation, development, processing, fulfillment, publication, management, consumption, and/or presentation related commerce transaction account and/or request for digital media and/or digital media commerce products and/or services can also be entered via communications device input device 30D, and/or computer enabled and/or network enabled device 40E, and/or by swiping a respective account card, smart card, payment card, ticket, computer chip enabled device, or the like, and/or in the scanner/reader 40B.

At step 403, the information entered and/or input at step 402 is transmitted to, and received by, the computer-implemented content and/or digital media publication and/or management system 50. At step 404, the computer-implemented content and/or digital media publication and/or management system 50 will process the information and determine whether the session, usage, operation, subscription, creation, development, processing, fulfillment, publication, management, consumption, and/or presentation related commerce transaction account is still active. If, at step 404, it is determined that the session, usage, operation, subscription, creation, development, processing, fulfillment, publication, management, consumption, and/or presentation related commerce transaction account is not active, the computer-implemented content and/or digital media creation and/or development system 20 will, at step 405, transmit a signal to the communications device 30, and/or computer enabled and/or network enabled transaction device 40, to provide notification of the inactive or lapsed account.

Thereafter, operation of the present invention will cease at step 406 and the user and/or operator may thereafter, access the computer-implemented content and/or digital media creation and/or development system 10 so as to re-open and/or renew the session, usage, operation, subscription, creation, development, processing, fulfillment, publication, management, consumption, and/or presentation related commerce transaction. In another preferred embodiment, the computer-implemented content and/or digital media publication and/or management system 50 can transfer operation to the computer-implemented content and/or digital media creation and/or development system 10, at step 405. Thereafter, session, usage, operation, subscription, creation, development, processing, fulfillment, publication, management, consumption, and/or presentation related commerce transaction account re-opening and/or renewal can occur on-line via the communications device 30 and/or the computer enabled and/or network enabled transaction device 40 and operation can proceed to step 402 to re-enter the pertinent account information. By example, this preferred embodiment operation can facilitate a re-opening or renewal of the session, usage, operation, subscription, creation, development, processing, fulfillment, publication, management, consumption, and/or presentation related commerce transaction account in one and the same interaction between the user and/or operator and an e-commerce computer enabled and/or network enabled transaction on a website, and/or an in-person transaction at a computer enabled and/or network enabled media commerce facility.

If, at step 404, it is determined that the session, usage, operation, subscription, creation, development, processing, fulfillment, publication, management, consumption, and/or presentation related commerce transaction account is still active, operation will proceed to step 407A and the computer-implemented content and/or digital media publication and/or management system 50 will determine if management functions and/or derivative services remain to be executed. If, at step 407A, it is determined that no management functions and/or derivative services remain to be executed, then operation will proceed to step 405 described above and notification of this fact will be provided to the user and/or operator via communication device 30, and/or the e-commerce computer enabled and/or network enabled device, and/or the e-commerce computer enabled and/or network enabled device, and/or the salesperson and/or checkout person via the computer enabled and/or network enabled transaction device 40.

Thereafter, operation of the apparatus will proceed as described above with operation either ceasing and/or the user and/or operator renewing the session, usage, operation, subscription, creation, development, processing, fulfillment, publication, management, consumption, and/or presentation related commerce transaction, extending the term of the session, usage, operation, subscription, creation, development, processing, fulfillment, publication, management, consumption, and/or presentation related commerce transaction, and/or subscribing to additional digital media commerce and/or arranging for same.

If, at step 407A, if it is determined that management functions and/or derivative services remain to be executed, then operation will proceed to step 407B and the computer-implemented content and/or digital media publication and/or management system 50 will determine whether or not the management functions and/or derivative services are functions and/or operations capable of being executed by the computer-implemented content and/or digital media publication and/or management system. If, at step 407B, it is determined that the management functions and/or derivative services are functions of the computer-implemented content and/or digital media publication and/or management system, then operation will proceed to step 408 and the computer-implemented content and/or digital media publication and/or management system 50 will execute a management function associated with the digital media commerce service, and/or where in the computer-implemented content and/or digital media publication and/or management system 50 may also transmit digital media and/or digital media commerce products and/or services, or a signal to authorize, display, print, and/or by some other means produce, digital media and/or digital media commerce products and/or services, to the communications device 30, and/or the computer enabled and/or network enabled transaction device 40. In the preferred embodiment, at step 408, the communications device 30, and/or the computer enabled and/or network enabled device 40, will execute all relevant operations associated with the digital media and/or digital media commerce products and/or services, and may generate and display and/or print a record, ticket, receipt, or the like, of the transaction, via the output devices 30I and/or 40J, and/or display device 30E and/or 40F.

If, at step 407B, it is determined that the management functions and/or derivative services are not functions and/or operations capable of being executed by the computer-implemented content and/or digital media publication and/or management system, then operation will proceed to step 407C. At step 407C the computer-implemented content and/or digital media publication and/or management system will determine if there are third-party derivative services and/or functions available to receive a hand-over of the request. If, at step 407C, it is determined that the management functions and/or derivative services from a third-party are available to execute the requested operation and/or function then the operation will then proceed to step 410 and the computer-implemented content and/or digital media publication and/or management system 50 will execute the hand-over to the third-party derivative service and/or function associated with the digital media commerce service, and/or where in the computer-implemented content and/or digital media publication and/or management system 50 may also transmit digital media and/or digital media commerce products and/or services, or a signal to authorize, display, print, and/or by some other means produce, digital media and/or digital media commerce products and/or services, to the communications device 30, and/or the computer enabled and/or network enabled transaction device 40. In the preferred embodiment, at step 410, the communications device 30, and/or the computer enabled and/or network enabled device 40, will execute all relevant operations associated with the digital media and/or digital media commerce products and/or services, and may generate and display and/or print a record, ticket, receipt, or the like, of the transaction, via the output devices 30I and/or 40J, and/or display device 30E and/or 40F. If, at step 407C, it is determined that no third-party derivative services and/or functions are available to receive a hand-over of the request, then operation will proceed to step 405 described above and notification of this fact will be provided to the user and/or operator via communication device 30, and/or the e-commerce computer enabled and/or network enabled device, and/or the e-commerce computer enabled and/or network enabled device, and/or the salesperson and/or checkout person via the computer enabled and/or network enabled transaction device 40.

Thereafter, operation of the apparatus will proceed as described above with operation either ceasing and/or the user and/or operator renewing the session, usage, operation, subscription, creation, development, processing, fulfillment, publication, management, consumption, and/or presentation related commerce transaction, extending the term of the session, usage, operation, subscription, creation, development, processing, fulfillment, publication, management, consumption, and/or presentation related commerce transaction, and/or subscribing to additional digital media commerce and/or arranging for same.

At step 409, the computer-implemented content and/or digital media publication and/or management system 50 will record the management of the digital media and/or digital media commerce products and/or services delivery and/or transaction, decrease by one the number of digital media commerce remaining to be delivered on the session, usage, operation, subscription, creation, development, processing, fulfillment, publication, management, consumption, and/or presentation related commerce transaction account, and/or increase by one the number of digital media commerce delivered on the session, usage, operation, subscription, creation, development, processing, fulfillment, publication, management, consumption, and/or presentation related commerce transaction, and/or note details of the transaction and/or associated transactions, and/or information collected during the digital media and/or digital media commerce products and/or services deliver, and/or related transaction, and provide all record updating for the session, usage, operation, subscription, creation, development, processing, fulfillment, publication, management, consumption, and/or presentation related commerce transaction account. The computer-implemented content and/or digital media publication and/or management system 50, in the preferred embodiment, at step 409, will also update any and/or pertinent session, usage, operation, subscription, creation, development, processing, fulfillment, publication, management, consumption, and/or presentation related commerce transaction account records and/or information, for the session, usage, operation, subscription, creation, development, processing, fulfillment, publication, management, consumption, and/or presentation related commerce transaction account, in its database 50H as well as the corresponding records and/or information for the session, usage, operation, subscription, creation, development, processing, fulfillment, publication, management, consumption, and/or presentation related commerce transaction account which are stored in the database 10H of the computer-implemented content and/or digital media creation and/or development system 10 as well as the corresponding records and/or information for the session, usage, operation, subscription, creation, development, processing, fulfillment, publication, management, consumption, and/or presentation related commerce transaction account which are stored in the database 20H of the computer-implemented content and/or digital media processing and/or fulfillment system 20.

The above-described updates to the computer-implemented content and/or digital media creation and/or development system database 10H, the computer-implemented content and/or digital media processing and/or fulfillment system 20H, and the computer-implemented content and/or digital media publication and/or management system 50H, can be performed via transmitting an appropriate signal to the computer-implemented content and/or digital media creation and/or development system 10, computer-implemented content and/or digital media processing and/or fulfillment system 20, computer-implemented content and/or digital media publication and/or management system 50, computer-implemented content and/or digital media consumption and/or presentation system 60, and/or via dynamically linked database methods and/or techniques, and/or via any other device, method and/or techniques known by those skilled in the art.

Thereafter, operation of the apparatus will cease at step 406.

FIG. 11 illustrates a flow diagram of another preferred embodiment method for utilizing the apparatus of the present invention wherein the present invention is utilized to fulfill services for digital media and/or digital media commerce products and/or services.

In the preferred embodiment of FIG. 11, the apparatus of the present invention allows the individual user, operator, and/or subscriber to receive the digital media commerce on a communication device 30, and/or at an internet access device and/or computer enabled and/or network enabled device 40, of which either may be located at in a digital environment, such as a website and/or virtual premise, and/or a physical environment such as a computer enabled and/or network enabled media commerce shop, and/or a kiosk, billboard, display, speaker, microphone, point-of-sale device, computer, telephone, and/or similar communications and/or computing device enabling digital media commerce transmissions, thereby allowing the user and/or operator the freedom and convenience of transacting digital media commerce at any desired time and/or from any desired device. Further, in the embodiment of FIG. 11, the present invention allows the individual user, operator, and/or subscriber to receive or obtain digital media commerce products and/or services under a plethora of commercially available terms and/or communications means and/or modes as to provide maximum flexibility for the subscriber of digital media commerce and the providers of digital media commerce. In this manner, for example, a user, operator, and/or subscriber may delay, restrict, redirect, skip, miss, and/or otherwise alter the delivery of the digital media and/or digital media commerce products and/or services(s) and receive or obtain alternative, other, and/or future digital media commerce within the constraints of their session, usage, operation, subscription, creation, development, processing, fulfillment, publication, management, consumption, and/or presentation related commerce transaction agreement, and may where relevant, without forfeiting the value of the digital media and/or digital media commerce products and/or services(s).

The flexible session, usage, operation, subscription, creation, development, processing, fulfillment, publication, management, consumption, and/or presentation related commerce transaction described in conjunction with the preferred embodiment of FIG. 11, can provide a user, operator, and/or subscriber with greater flexibility in transacting digital media commerce products and/or services, and/or sessions, application instances, commerce, and/or session, usage, operation, subscription, creation, development, processing, fulfillment, publication, management, consumption, and/or presentation related commerce transactions as well as serve as an incentive to enter into a session, usage, operation, subscription, creation, development, processing, fulfillment, publication, management, consumption, and/or presentation related commerce transaction in the first place. The user and/or operator can also take advantage of offers, promotions, or the like, while obtaining the desired flexibility in obtaining digital media commerce. A user, operator, and/or subscriber can, as a result, obtain and enjoy the full value and/or number of digital media commerce when they are able.

It is understood, however, that flexibility can be limited. Digital media creator and/or developer may set its own limitations and/or restrictions on the flexibility associated with the delivery of the digital media and/or digital media commerce products and/or services and/or derivative offers and/or services with which it is associated. For example, a maximum time period in which the subscriber must obtain all of his or digital media commerce or forfeit the opportunity to receive same. These terms, however, can be agreed upon by the contracting parties.

The operation of the embodiment of FIG. 11 commences at step 500. At step 501, the computer-implemented content and/or digital media creation and/or development system 10, and/or the computer-implemented content and/or digital media processing and/or fulfillment system 20, and/or the computer-implemented digital media publication and/or management system 50, and/or the computer-implemented digital media consumption and/or presentation system 60, and/or the computer-implemented content and/or digital media consumption and/or presentation system 60, receives a request to transmit digital media and/or digital media commerce products and/or services via the communications device 30 and/or the computer enabled and/or network enabled transaction device 40, and/or the computer-implemented content and/or digital media processing and/or fulfillment system 20, and/or the computer-implemented digital media publication and/or management system 50, and/or the computer-implemented digital media consumption and/or presentation system 60, and/or the computer-implemented content and/or digital media consumption and/or presentation system 60.

At step 502, the digital media and/or digital media commerce products and/or services is placed in queue, and/or may be either manually and/or automatically prioritized, and/or de-prioritized, and/or reprioritized based upon parameters set by the digital media publisher and/or manager and/or intermediary, the digital media creator and/or developer, the digital media commerce service provider, and/or any other service providers of affiliated digital media commerce services.

At step 503, the digital media and/or digital media commerce products and/or services is attached to the metadata related to the session, usage, user, subscription, product, service, and/or service provider. The commercial and/or technical terms governing the attachment may be set by any one or more of the parties to the digital media and/or digital media commerce products and/or services relationship and/or delivery and/or communication.

At step 504, the digital media and/or digital media commerce products and/or services and the metadata related to the session, usage, user, subscription, product, service, and/or service provider are transmitted to and received by the communications device 30, and/or the computer enabled and/or network enabled transaction device 40. In another preferred embodiment, one or more of the digital media and/or digital media commerce products and/or services and the metadata related to the session, usage, user, subscription, product, service, and/or service provider may already be located and/or generated and/or stored at the communications device 30, and/or the computer enabled and/or network enabled transaction device 40. In yet another preferred embodiment, a signal authorizing, de-authorizing, reauthorizing, authenticating, terminating, and/or otherwise signaling, and/or controlling, the supply, and/or generation, and/or communication, and/or display of the digital media and/or digital media commerce products and/or services along with the metadata related to the session, usage, user, subscription, product, service, and/or service provider. At step 505, the digital media and/or digital media commerce products and/or services and/or the digital media and/or digital media commerce products and/or services with the metadata related to the session, usage, user, subscription, product, service, and/or service provider are displayed and/or printed via the output devices 30I and/or 40J, and/or display device 30E and/or 40F. Step 505 may or may not be required in every use case, where not, the operation proceeds directly to step 506.

At step 506, the communications device 30, and/or the computer enabled and/or network enabled transaction device 40, and/or the computer-implemented content and/or digital media creation and/or development system 10, and/or the computer-implemented content and/or digital media processing and/or fulfillment system 20, and/or the computer-implemented digital media publication and/or management system 50, and/or the computer-implemented digital media consumption and/or presentation system 60, will record the management of the digital media and/or digital media commerce products and/or services delivery and/or transaction, decrease by one the number of digital media commerce remaining to be delivered on the session, usage, operation, subscription, creation, development, processing, fulfillment, publication, management, consumption, and/or presentation related commerce transaction account, and/or increase by one the number of digital media commerce delivered on the session, usage, operation, subscription, creation, development, processing, fulfillment, publication, management, consumption, and/or presentation related commerce transaction, and/or note details of the transaction and/or associated transactions, and/or information collected during the digital media and/or digital media commerce products and/or services deliver, and/or related transaction, and provide all record updating for the session, usage, operation, subscription, creation, development, processing, fulfillment, publication, management, consumption, and/or presentation related commerce transaction account. The computer-implemented content and/or digital media publication and/or management system 50, in the preferred embodiment, at step 506, will also update any and/or pertinent session, usage, operation, subscription, creation, development, processing, fulfillment, publication, management, consumption, and/or presentation related commerce transaction account records and/or information, for the session, usage, operation, subscription, creation, development, processing, fulfillment, publication, management, consumption, and/or presentation related commerce transaction account, in its database 50H as well as the corresponding records and/or information for the session, usage, operation, subscription, creation, development, processing, fulfillment, publication, management, consumption, and/or presentation related commerce transaction account which are stored in the database 10H of the computer-implemented content and/or digital media creation and/or development system 10, as well as the corresponding records and/or information for the session, usage, operation, subscription, creation, development, processing, fulfillment, publication, management, consumption, and/or presentation related commerce transaction account which are stored in the database 20H of the computer-implemented content and/or digital media processing and/or fulfillment system 20, as well as the corresponding records and/or information for the session, usage, operation, subscription, creation, development, processing, fulfillment, publication, management, consumption, and/or presentation related commerce transaction account which are stored in the database 50H of the computer-implemented content and/or digital media publication and/or management system 50, as well as the corresponding records and/or information for the session, usage, operation, subscription, creation, development, processing, fulfillment, publication, management, consumption, and/or presentation related commerce transaction account which are stored in the database 60H of the computer-implemented content and/or digital media consumption and/or presentation system 60, the database 30H of the communications device 30, and/or the database 40I of the computer enabled and/or network enabled transaction device 40.

The above-described updates to the computer-implemented content and/or digital media creation and/or development system database 10H, the computer-implemented content and/or digital media processing and/or fulfillment system 20H, and the computer-implemented content and/or digital media publication and/or management system 50H, and the computer-implemented content and/or digital media consumption and/or presentation system 60H, the communications device system 30H, and/or the computer enabled and/or network enabled system 40I, can be performed via transmitting an appropriate signal to the computer-implemented content and/or digital media creation and/or development system 10, computer-implemented content and/or digital media processing and/or fulfillment system 20, computer-implemented content and/or digital media publication and/or management system 50, computer-implemented content and/or digital media consumption and/or presentation system 60, the communications device 30, and the computer enabled and/or network enabled device 40, and/or via dynamically linked database methods and/or techniques, and/or via any other device, method and/or techniques known by those skilled in the art.

Thereafter, operation of the apparatus will cease at step 507.

In any and/or all of the embodiments described herein, the computer-implemented content and/or digital media creation and/or development system 10, and/or the computer-implemented content and/or digital media processing and/or fulfillment system 20, and/or the computer-implemented content and/or digital media publication and/or management system 50, and/or the computer-implemented content and/or digital media consumption and/or presentation system 60, can provide processing for any number and/or type of digital media commerce products and/or services, and/or sessions, application instances, commerce, and/or session, usage, operation, subscription, creation, development, processing, fulfillment, publication, management, consumption, and/or presentation related commerce transactions. In this manner, the computer-implemented content and/or digital media creation and/or development system 10, and/or the computer-implemented content and/or digital media processing and/or fulfillment system 20, and/or the computer-implemented content and/or digital media publication and/or management system 50, and/or the computer-implemented content and/or digital media publication and/or management system can administer, manage, service, and/or provide processing, for any number and/or types of digital media commerce and/or digital media commerce products and/or services, and/or sessions, application instances, commerce, and/or session, usage, operation, subscription, creation, development, processing, fulfillment, publication, management, consumption, and/or presentation related commerce transactions.

In any and/or all of the embodiments described herein, the apparatus and method of the present invention can provide for digital media commerce products and/or services, and/or sessions, application instances, commerce, and/or session, usage, operation, subscription, creation, development, processing, fulfillment, publication, management, consumption, and/or presentation related commerce transactions which can be initiated and/or created and/or communicated and/or be operated upon via any communication device 30 and/or any computer enabled and/or network enabled transaction device 40. In any and/or all of the embodiments described herein, the digital media commerce products and/or services, and/or sessions, application instances, commerce, and/or session, usage, operation, subscription, creation, development, processing, fulfillment, publication, management, consumption, and/or presentation related commerce transactions can be delivered and/or serviced by any communications service, communications network, computer service, computer network, computer-implemented communications and/or computing environment, premise, vehicle, being, kiosk, billboard, display, speaker, microphone, point-of-sale device, computer, telephone, and/or similar communications and/or computing device enabling digital media commerce transmissions, computer enabled and/or network enabled media commerce and/or other facility. In this manner, for example, a user, operator, and/or subscriber may initiate a session, usage, operation, subscription, creation, development, processing, fulfillment, publication, management, consumption, and/or presentation related commerce transaction for a media and/or digital media commerce products and/or services from any location and receive the digital media commerce of the session, usage, operation, subscription, creation, development, processing, fulfillment, publication, management, consumption, and/or presentation related commerce transaction from any digital environment and/or physical computer enabled and/or network enabled media commerce facility which is a participating facility and/or a facility which utilizes the present invention and/or which utilizes an enabled communications device 30, and/or computer enabled and/or network enabled transaction device 40, thereby providing flexibility in the digital media and/or digital media commerce products and/or services receiving location.

In any and/or all of the embodiments described herein, the user and/or operator or an agent and/or other third party intermediary, can access the computer-implemented content and/or digital media creation and/or development system 10, and/or the computer-implemented content and/or digital media processing and/or fulfillment system 20, and/or the computer-implemented content and/or digital media publication and/or management system 50, and/or the computer-implemented content and/or digital media consumption and/or presentation system 60, via the communication device 30 and/or via the computer enabled and/or network enabled transaction device 40 so as to ascertain the status of an individual session, usage, operation, subscription, creation, development, processing, fulfillment, publication, management, consumption, and/or presentation related commerce transaction such as, but not limited to, whether the session, usage, operation, subscription, creation, development, processing, fulfillment, publication, management, consumption, and/or presentation related commerce transaction is active or inactive, and/or the management status of the session, usage, operation, subscription, creation, development, processing, fulfillment, publication, management, consumption, and/or presentation related commerce transaction, such as, but not limited to, the number of digital media commerce sent, and/or remaining on order, and/or any and all analytics associated with the digital media commerce and/or digital media and/or digital media commerce products and/or services, sessions, session, usage, operation, subscription, creation, development, processing, fulfillment, publication, management, consumption, and/or presentation related commerce transaction.

In any and/or all of the embodiments described herein, the digital media creator and/or developer, and/or digital media commerce service provider, and/or affiliated third party service providers, and/or an agent and/or other third party intermediary, can access the computer-implemented content and/or digital media creation and/or development system 10, and/or the computer-implemented content and/or digital media processing and/or fulfillment system 20, and/or the computer-implemented content and/or digital media publication and/or management system 50, and/or the computer-implemented content and/or digital media publication and/or management system 50, and/or the computer-implemented content and/or digital media consumption and/or presentation system 60, via the communication device 30 and/or via the computer enabled and/or network enabled transaction device 40 so as to ascertain the status of a group of sessions, application instances, commerce, and/or session, usage, operation, subscription, creation, development, processing, fulfillment, publication, management, consumption, and/or presentation related commerce transactions, and/or a subset of a group of sessions, application instances, commerce, and/or session, usage, operation, subscription, creation, development, processing, fulfillment, publication, management, consumption, and/or presentation related commerce transactions, and/or an individual session, usage, operation, subscription, creation, development, processing, fulfillment, publication, management, consumption, and/or presentation related commerce transaction, and/or a subset of an individual session, usage, operation, subscription, creation, development, processing, fulfillment, publication, management, consumption, and/or presentation related commerce transaction such as, but not limited to, whether the session, usage, operation, subscription, creation, development, processing, fulfillment, publication, management, consumption, and/or presentation related commerce transaction(s) is active or inactive, and/or the management status of the session, usage, operation, subscription, creation, development, processing, fulfillment, publication, management, consumption, and/or presentation related commerce transaction(s), such as, but not limited to, the number of digital media commerce sent, and/or remaining on order(s), and/or any and all analytics associated with the digital media commerce and/or digital media and/or digital media commerce products and/or services, sessions, sessions, application instances, commerce, and/or session, usage, operation, subscription, creation, development, processing, fulfillment, publication, management, consumption, and/or presentation related commerce transactions.

In any and/or all of the embodiments described herein, the computer-implemented content and/or digital media creation and/or development system 10, and/or the computer-implemented content and/or digital media processing and/or fulfillment system 20, and/or the computer-implemented content and/or digital media publication and/or management system 50, and/or the computer-implemented content and/or digital media consumption and/or presentation system 60, can also notify individual subscribers, via any means, method and/or manner of communication, via the communication device 30 and/or the computer enabled and/or network enabled transaction device 40, of available digital media commerce, and/or promotions, and/or offers, and/or specials, and/or exclusives of digital media commerce, and/or products and/or services associated with digital media commerce, alerts, renewal notices, extension notices, termination notices, session, usage, operation, subscription, creation, development, processing, fulfillment, publication, management, consumption, and/or presentation related commerce transaction creation and/or initiation notices, shipment to and/or arrival of goods and services associated with the digital media and/or digital media commerce products and/or services, the session, usage, operation, subscription, creation, development, processing, fulfillment, publication, management, consumption, and/or presentation related commerce transaction digital media and/or digital media commerce products and/or services, goods and/or services at a respective computer enabled and/or network enabled media commerce facility and/or other facility associated with the digital media commerce, and/or of any other information which may be of interest to a user, operator, and/or subscriber.

In any and/or all of the embodiments described herein, the apparatus and method of the present invention can be utilized as a session, usage, operation, subscription, creation, development, processing, fulfillment, publication, management, consumption, and/or presentation related commerce transaction clearinghouse, to match individual digital media publisher and/or manager and/or intermediaries to digital media creator and/or developers, and/or offers from digital media creator and/or developers, and/or goods and/or services associated with digital media commerce, wherein information regarding any number of, and types of such expressions of interest and/or offers can be stored in the database 10H of the computer-implemented content and/or digital media creation and/or development system 10 and/or the database 20H of the computer-implemented content and/or digital media processing and/or fulfillment system 20 and/or the database 50H of the computer-implemented content and/or digital media publication and/or management system 50, and/or the database 60H of the computer-implemented content and/or digital media consumption and/or presentation system 60. Any individual digital media publisher and/or manager and/or intermediary, digital media creator and/or developer, digital media commerce service provider, and/or associated providers of goods and/or services, can access the respective the computer-implemented content and/or digital media creation and/or development system 10, and/or the computer-implemented content and/or digital media processing and/or fulfillment system 20, and/or the computer-implemented content and/or digital media publication and/or management system 50, and/or the computer-implemented content and/or digital media consumption and/or presentation system 60, and search for a desired digital media and/or digital media commerce products and/or services(s), offers, inquiries, digital media publisher and/or manager and/or intermediaries, digital media creator and/or developers, and/or digital media commerce service providers. Any of these entities may then apply to, inquire, offer, counter-offer, enroll in, and/or transact for the digital media and/or digital media commerce products and/or services and/or associated goods and/or services described herein.

In any and/or all of the embodiments described herein, a user, operator, and/or subscriber can input a request and/or an order for digital media and/or digital media commerce products and/or services and/or digital media commerce services, with information regarding the order being stored in the database 10H of the computer-implemented content and/or digital media creation and/or development system 10, and/or the database 20H of the computer-implemented content and/or digital media processing and/or fulfillment system 20, and/or the database 50H of the computer-implemented content and/or digital media publication and/or management system 50, and/or the database 60H of the computer-implemented content and/or digital media consumption and/or presentation system 60. The computer-implemented content and/or digital media creation and/or development system 10, and/or the computer-implemented content and/or digital media processing and/or fulfillment system 20, and/or the computer-implemented content and/or digital media publication and/or management system 50, and/or the computer-implemented content and/or digital media consumption and/or presentation system 60, can thereafter process the order or order and notify the subscriber via the communication device 30 and/or the computer enabled and/or network enabled transaction device 40 if and when the ordered and/or requested digital media and/or digital media commerce products and/or services and/or digital media and/or digital media commerce products and/or services service is available. The user and/or operator may be notified via any appropriate and/or available digital, electronic, and/or physical, and or other communications means, method and/or technique.

In any and/or all of the embodiments described herein, any of the computer-implemented content and/or digital media creation and/or development system 10, the computer-implemented content and/or digital media processing and/or fulfillment system 20, the computer-implemented content and/or digital media publication and/or management system 50, and/or the computer-implemented content and/or digital media consumption and/or presentation system 60, the communication device(s) 30, and/or the computer enabled and/or network enabled transaction device(s) 40, can be programmed for automatic operation, self-activation, and/or programmed operation. The computer-implemented content and/or digital media creation and/or development system 10, and/or the computer-implemented content and/or digital media processing and/or fulfillment system 20, and/or the computer-implemented content and/or digital media publication and/or management system 50, and/or the computer-implemented content and/or digital media consumption and/or presentation system 60, can be programmed to automatically generate and/or to transmit media and/or digital media commerce products and/or services and/or notices to any of the user and/or operators, computer enabled and/or network enabled media commerce computers, goods and/or services providers, or the like, regarding digital media commerce, digital media commerce products and/or services, and/or sessions, application instances, commerce, and/or session, usage, operation, subscription, creation, development, processing, fulfillment, publication, management, consumption, and/or presentation related commerce transactions, session, usage, operation, subscription, creation, development, processing, fulfillment, publication, management, consumption, and/or presentation related commerce transaction management, the availability of digital media commerce, offers related to digital media commerce products and/or services, and/or sessions, application instances, commerce, and/or session, usage, operation, subscription, creation, development, processing, fulfillment, publication, management, consumption, and/or presentation related commerce transactions, availability of digital media commerce and/or goods and/or services which are the associated with digital media commerce session, use session, time of operation, and/or session, usage, operation, subscription, creation, development, processing, fulfillment, publication, management, consumption, and/or presentation related commerce transaction.

In any and/or all of the embodiments described herein, intelligent agents, software agents, and/or mobile agents, and/or computer code, and/or computer applications, and/or applets, and/or scripts, can be utilized so as to act on behalf of any of the parties and/or any of the respective computers and/or devices described herein. Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

The present invention provides an apparatus and method for enabling media commerce in a digital environment processing and/or digital media commerce processing and/or fulfillment services, and/or digital media commerce management, and/or digital media commerce related services.

The present invention provides an apparatus and a method wherein all parties benefit. Elective media and/or digital media commerce products and/or services subscribers can obtain the value of information, data, content, offers, promotions, services, or the like associated with digital media commerce. Elective media and/or digital media commerce products and/or services providers and affiliated goods and/or services providers can have the benefit and value of access a highly target and interested audience for relevant information, data, content, offers, promotions, services, or the like associated with digital media commerce. Elective media and/or digital media commerce products and/or services service providers and affiliated goods and/or services providers can have the benefit and value derived from creating an improved means for more effectively and efficiently connecting parties to one another for the purposes of communication, information, commerce, and public safety.

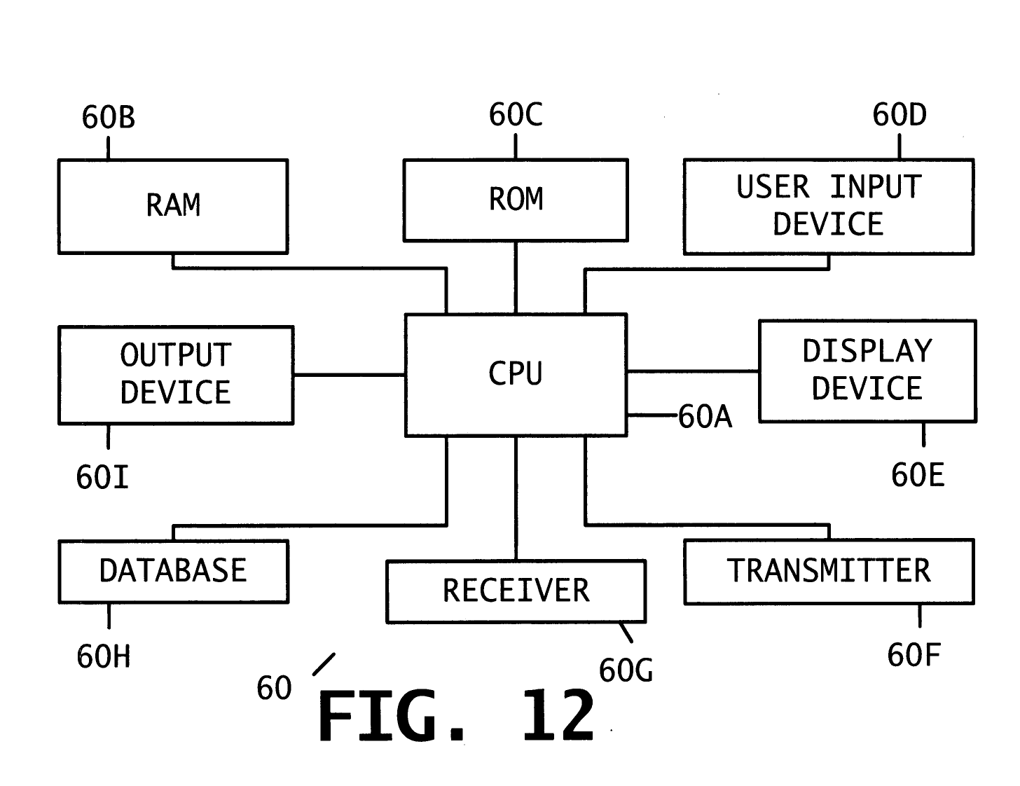

FIG. 12 illustrates the computer-implemented content and/or digital media consumption and/or presentation system 60, in block diagram form. The computer-implemented content and/or digital media consumption and/or presentation system 60, in the preferred embodiment, is a network computer or computer system which is utilized as a computer-implemented content and/or digital media creation and/or development system such as a server, network computer, server, network computers in a datacenter, a web server, network computer, an Internet server, network computer, an e-commerce server, network computer, a communications server, network computer, a database server, network computer, a mobile computer, and/or any similar computer or computer system.

The computer-implemented content and/or digital media consumption and/or presentation system 60 can also be any other computer or computer system which can be utilized in any computing and/or communication network. In the preferred embodiment, the computer-implemented content and/or digital media consumption and/or presentation system 60 includes a central processing unit or CPU 60A, which in the preferred embodiment, is a microprocessor. The CPU 60A may also be a microcomputer, a minicomputer, a macro-computer, a computer on a chip, a nano computer, a quantum computer, a website, a blog, a SMS, an instant message, a tweet, a posting, an application, an applet, a synthetic computer, a biological computer, a multi-core computer, a multi-component computer, a physical computer, a virtualized computer, a single computer, a combination of computers, a computer system, a networked computer system, and/or a mainframe computer, depending upon the application.

The computer-implemented content and/or digital media consumption and/or presentation system 60 also includes a random access memory device(s) 60B (RAM) and a read only memory device(s) 60C (ROM), each of which is connected to the CPU 60A, a user input device 60D, for entering data and/or commands into the computer-implemented content and/or digital media consumption and/or presentation system 60, which includes any one or more of a key pad, a keyboard, a scanner, a touch pad, a signature pad, a card reader, a magnetic strip card reader, a biometric scanner, a subscriber identity module reader, a chip reader, a signal scanner, a camera, a video camera, a microphone, a graphic image and/or video signal generator, an audio signal and/or audio image generator, a user pointing device, such as, for example, a mouse, a touch pad, and/or an audio input device and/or a video input device, or the like, if desired, which input device(s) is also connected to the CPU 60A.

The computer-implemented content and/or digital media consumption and/or presentation system 60 also includes a display device 60E for displaying data and/or information to a user or operator.

The computer-implemented content and/or digital media consumption and/or presentation system 60 also includes a transmitter(s) 60F, for transmitting signals and/or data and/or information to any one or more of the computer-implemented content and/or digital media creation and/or development system 10, the computer-implemented content and/or digital media processing and/or fulfillment system 20, the computer-implemented content and/or digital media consumption and/or presentation system 50, the computer-implemented content and/or digital media consumption and/or presentation system 60, the computer enabled and/or network enabled transaction devices 40, and the communication devices 30, which may be utilized in conjunction with the present invention. The computer-implemented content and/or digital media consumption and/or presentation system 60 also includes a receiver 60G, for receiving signals and/or data and/or information from to any one or more of the computer-implemented content and/or digital media creation and/or development system 10, the computer-implemented content and/or digital media processing and/or fulfillment system 20, the computer-implemented content and/or digital media consumption and/or presentation system 50, the computer-implemented content and/or digital media consumption and/or presentation system 60, the computer enabled and/or network enabled transaction devices 40, and the communication devices 30, which may be utilized in conjunction with the present invention.

The computer-implemented content and/or digital media consumption and/or presentation system 60 also includes a database 60H. The database can include data and/or information regarding digital media creator and/or developer, or entity which provides data and/or information and/or functionality which may be either attached to, embedded in, and/or associated with the digital media commerce, for which sessions, application instances, commerce, and/or subscriptions are provided and/or available via the apparatus of the present invention. The database 60H can also include data and/or information regarding the services and/or products that may be provided in association with, and/or derived from, the digital media commerce services.

The database 60H can also include data and/or information regarding the entity and/or individual user and/or subscriber, including all histories of usage, commercial terms, payments, technical, and/or communications usage in conjunction with the digital media commerce service. The database 60H can also include all data and/or information regarding the entity and/or individual user and/or subscriber including all communications account information, financial account information, and a multitude of profiling information including, but not limited to, preferences, demographics, activity streams, behavioral targeting, data logging. digital footprint, lifelog, lifestreaming, profiling, runtime intelligence, social translucence, trace, trace evidence, genetic sequencing, psychographics, data represented in Attention Profiling Mark-up Language, subject and/or interest item information, communications, browsing histories, browsing patterns, documents, files, computational usage statistics, communications usage statistics, content created, content viewed, heard and/or read, content downloaded, applications used and/or downloaded, search queries, search results, click-through on search results, digital traces, activities, behaviors, login and logouts, visit of pages, documents accesses, items created, affiliation to groups, attention, social group, repetition, location, reputation, financial activities, investing activities, income data, spending data, consumption and/or presentation data, tax data, credit data, credit history data, reputational data, media related data, sensor discovered data, sensor recorded data, digital footprints, digital finger prints, life streams, social media linkages, social media activities, communications activities, computing activities, personal status, medical information, health information, personally identifiable information, volunteered information, collected information, rumored information, non-volunteered information, information capable of being stored in log files, information capable of being stored locally and/or or in a private and/or public cloud computing environment, information capable of being stored in databases, mined data, as well as the analytics associated with the aforementioned data and/or information, with respect to the services provided related to digital media commerce.

The database 60H can also include data and/or information regarding the services provided by the digital media commerce service provider, and/or affiliated service providers, including services previously offered, currently offered, and/or prospectively offered, content, communications, and/or commercial information regarding digital media commerce including, but not limited to, data received by and/or from the digital media publisher and/or manager and/or intermediary, data received by and/or from the digital media creator and/or developer, and/or data generated by the digital media commerce service provider through activities associated with the providing of digital media commerce services, as well as the analytics associated with any of the aforementioned data and/or information, with respect to the services provided related to digital media commerce.

The database 60H can also include data and/or information regarding the actual content and/or digital media provided and/or offered by the digital media creator and/or developers, including, but not limited to content, digital content, media, digital media, data, information, digital content transaction applications, digital content transaction services, digital content computing applications, digital content computing services, digital content communications applications, digital content communications services, periodicals, files, video, audio, images, avatars, pixel content and/or digital media, clear gifs, web beacons, voice, text, signals, hyper-links, programs, applications, applets, code, scripts, alerts, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, media and/or digital media commerce products and/or services, notifications, controls, communications, and/or an embodiment of information, and/or an embodiment of control functionality, as well as the analytics associated with any of the aforementioned data and/or information (hereinafter which may be referred to collectively as “media and/or digital media commerce products and/or services” or “media and/or digital media commerce products and/or services”), with respect to the services provided related to digital media commerce.

The database 60H also includes information regarding the digital media commerce products and/or services, and/or sessions, application instances, commerce, and/or subscriptions which each entity and/or individual user and/or subscriber has initiated, is using, is/was engaged in, and/or subscribed to, type of subscription, subscription length or duration, subscription cost, subscription renewals, subscription extensions, digital media commerce received and/or offered, status of subscription agreement, remaining subscription agreement commitments, and/or any other relevant information regarding the respective digital media commerce products and/or services, and/or sessions, application instances, commerce, and/or subscriptions and/or the operation execution and/or transmission of the respective digital media commerce products and/or services, and/or sessions, application instances, commerce, and/or subscriptions.

The database 60H also includes information regarding the date the respective digital media commerce products and/or services, and/or sessions, application instances, commerce, and/or subscriptions were ordered, became effective, date/time of the start of the session and/or subscription, date/time of session and/or subscription termination, computer enabled and/or network enabled media commerce computer and/or session and/or subscription origination agent from who the session and/or subscription originated, and the computer enabled and/or network enabled media commerce computer, goods provider, and/or services provider, session application provider, subscription service entity, and/or service, session, and/or subscription fulfillment entity and/or agent from whom the entity and/or individual user and/or subscriber will obtain the respective digital media commerce products and/or services, which are be the subject of the digital media commerce products and/or services, and/or sessions, application instances, commerce, and/or subscriptions. The database 60H also includes information regarding customer service agents and/or entities for providing customer services for, and/or regarding, any of the respective digital media commerce products and/or services, and/or sessions, application instances, commerce, and/or subscriptions.

The database 60H may also contain any other information which may be relevant, pertinent, useful, and/or desired, for facilitating the operation of the apparatus and method of the present invention as described herein and/or as related thereto.

The database 60H, in the preferred embodiment, is a database which may include individual databases or collections of databases, with each database being designated to store any and all of the data and/or information described herein. Applicant hereby incorporates by reference herein the teachings of Basic Business Statistics Concepts and Applications, Mark L. Berenson and David M. Levine, 6.sup.th Edition, Prentice Hall 1996.

The database 60H, or collection of databases, may be updated by each of the respective individual entity and/or individual user and/or subscribers, computer-implemented content and/or digital media creation and/or development system operator or administrator, computer-implemented content and/or digital media processing and/or fulfillment system operator or administrator, computer-implemented content and/or digital media publication and/or management system operator or administrator, computer-implemented content and/or digital media consumption and/or presentation operator or administrator, computer enabled and/or network enabled transaction device operator, communication device operator or administrator, via any of their respective computers and/or devices, and/or by any other third party, in real-time, and/or via dynamically linked database management techniques.

The data and/or information stored in the database 60H can also be updated by external sources. The database 60H will contain any and all information deemed necessary and/or desirable for providing all of the processing and/or services and/or functions described herein. Applicant hereby incorporates by reference herein the subject matter of Fundamentals of Database Systems, by Ramez Elmasri and Shamkant B. Navathe, 2.sup.nd Ed., Addison-Wesley Publishing Company, 1994.

The database 60H can also include any contact information for any of the entities and/or individual users and/or subscribers, content providers, digital media providers, application providers, content and/or digital media product and/or service providers, subscription providers, subscription fulfillment providers, computer enabled and/or network enabled media commerce computers, computer enabled and/or network enabled entities, or the like, such as, but not limited to, names, addresses, telephone numbers, fax numbers, e-mail addresses, URL's, websites, hyper-links, XML data, personal identification information, business identification information, SIC codes, links to third-party and/or government sponsored identification information, and/or any other contact information, for the respective party. The database 60H also includes any of the above-described contact information regarding any intermediaries, third parties, agents, and/or brokers, who utilize the apparatus of the present invention.

The database 60H can also include any other data and/or information needed and/or desired for facilitating the functions and operation of the present invention as described herein.

With reference once again to FIG. 2, the computer-implemented content and/or digital media consumption and/or presentation system 60 also includes an output device 60I such as a printer, a presentation, a display, an audio signal, a video signal, a text signal, a graphical signal, a read-out, a presenter, a 3-dimensional printer, a router, a modem, a networking device, a fax/modem, a transmitting device, or other output device, for providing data and/or information to the operator or user of the computer-implemented content and/or digital media consumption and/or presentation system 60 or to a third party or third party entity.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. A computer-implemented method, comprising: receiving a request to receive, at a device or devices associated with or used by an individual, a set of individuals, a machine, a set of machines, digital media and/or digital media commerce products and/or services consisting of any one or more of content, digital content, media, digital media, data, information, digital content transaction applications, digital content transaction services, digital content computing applications, digital content computing services, digital content communications applications, digital content communications services, periodicals, files, video, audio, images, avatars, pixel content and/or digital media, clear gifs, web beacons, voice, text, signals, hyper-links, programs, applications, applets, code, scripts, alerts, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, media and/or digital media commerce products and/or services, notifications, controls, communications, or an embodiment of information, or an embodiment of control functionality; processing information regarding the request with a processing device, wherein the processing device determines whether the session, usage, operation, subscription, creation, development, processing, fulfillment, publication, management, consumption, and/or presentation related commerce transaction is active or not active or determines whether any digital media and/or digital media commerce products and/or services or digital media commerce of the one or more of the content, digital content, media, digital media, data, information, digital content transaction applications, digital content transaction services, digital content computing applications, digital content computing services, digital content communications applications, digital content communications services, periodicals, files, video, audio, images, avatars, pixel content and/or digital media, clear gifs, web beacons, voice, text, signals, hyper-links, programs, applications, applets, code, scripts, alerts, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, media and/or digital media commerce products and/or services, notifications, controls, communications, or an embodiment of information, or an embodiment of control functionality remain to be fulfilled pursuant to the session, usage, operation, subscription, creation, development, processing, fulfillment, publication, management, consumption, and/or presentation related commerce transaction; and transmitting in response to the request, and in conjunction with a second communication, one or more of content, digital content, media, digital media, data, information, digital content transaction applications, digital content transaction services, digital content computing applications, digital content computing services, digital content communications applications, digital content communications services, periodicals, files, video, audio, images, avatars, pixel content and/or digital media, clear gifs, web beacons, voice, text, signals, hyper-links, programs, applications, applets, code, scripts, alerts, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, media and/or digital media commerce products and/or services, notifications, controls, communications, or an embodiment of information, or an embodiment of control functionality.

2. The computer-implemented method of claim 1, wherein the request, the metadata related to the session, usage, user, subscription, product, service, and/or service provider, and/or the digital media and/or digital media commerce products and/or services is transmitted on or over the Internet, World Wide Web, Semantic Web, telecommunication networks, computing networks, terrestrial networks, undersea networks, mobile networks, satellite networks, radio networks, digital communication networks, broadband communication networks, internets and/or intranets, mesh networks, closed circuit networks, open networks, optical networks, neural networks, and/or similarly employable communications and/or computer networks.

3. The computer-implemented method of claim 1, wherein the request or the metadata related to the session, usage, user, subscription, product, service, and/or service provider or the digital media and/or digital media commerce products and/or services is transmitted on or over or a supra-global network, global network, trans-national network, national network, wide area network, metropolitan area network, local area network, personal area network, inter-being network, intra-being network, human-to-machine network, machine-to-machine network, human-to-non-human network, and/or any other suitable communication network or system.

4. The computer-implemented method of claim 1, further comprising: processing information for establishing session, usage, operation, subscription, creation, development, processing, fulfillment, publication, management, consumption, and/or presentation related commerce transaction agreement to enable one or more of further creation, development, processing, fulfillment, publication, management, consumption, and/or presentation digital media commerce services.

5. The computer-implemented method of claim 1, further comprising: processing information for one or more of augmenting, increasing, decreasing, supplementing, lengthening, shortening, extending, cancelling, terminating, or otherwise changing the parameters governing the commercial and technical aspects of the session, usage, operation, subscription, creation, development, processing, fulfillment, publication, management, consumption, and/or presentation related commerce transaction agreement.

6. The computer-implemented method of claim 1, further comprising: processing information for creating or initiating the session, usage, operation, subscription, creation, development, processing, fulfillment, publication, management, consumption, and/or presentation related commerce transaction.

7. The computer-implemented method of claim 1, wherein the request for the digital media and/or digital media commerce products and/or services, the digital media and/or digital media commerce products and/or services, the communication in conjunction with the digital media and/or digital media commerce products and/or services, or data regarding the digital media and/or digital media commerce products and/or services is encrypted.

8. The computer-implemented method of claim 1, wherein the device or devices associated with or being used by the digital media publisher and/or manager and/or intermediary contains decryption software or codes.

9. The computer-implemented method of claim 1, comprising: transmitting the digital media and/or digital media commerce products and/or services or data or information regarding the digital media and/or digital media commerce products and/or services via a communications network, or a computing network directly to the digital media publisher and/or manager and/or intermediary.

10. The computer-implemented method of claim 1, comprising: transmitting the digital media and/or digital media commerce products and/or services or data or information regarding the digital media and/or digital media commerce products and/or services via a communications network, or a computing network to the digital media publisher and/or manager and/or intermediary in conjunction with any one or more of a communications service, commercial service, public welfare service, or computing service provided by a third-party.

11. The computer-implemented method of claim 1, comprising: generating a notification to the requestor of approval, rejection, a query, or an offer pursuant to the requested digital media and/or digital media commerce products and/or services, and/or inventory status, pricing status, availability status.

12. The computer-implemented method of claim 1, comprising: processing the inclusion of a programming input, such as a live feed, which can be connected or linked with the computer-implemented system and which can transmit live content and/or digital media to the computer-implemented system for digital media commerce to be executed in conjunction with communication devices, computing devices, and/or transaction devices.

13. The computer-implemented method of claim 1, comprising: accessing a ratings computer which is connected to or linked with the computer-implemented system; storing, wherein the ratings computer can include a database which stores information regarding various ratings and viewership information for various pieces of content and/or media which may be subject to commerce in a digital environment; transmitting, wherein ratings information can be transmitted to the ratings computer from a ratings provider communication device and/or from the computer-implemented system, and may be utilized by any ratings reporting service, organization, agency, station, network, service provider, and/or search provider.

14. The computer-implemented method of claim 1, comprising: enabling and/or processing requests of an advertisement/marketing computer which is connected to or linked with the computer-implemented system; storing, wherein the advertisement/marketing computer can include a database which stores advertisements, commercials, links, hyperlinks, video, audio, banners, buttons, clips, URL's content and/or digital media, frames, logos, icons, surveys, questionnaires, market research tools, promotions, offers, and/or other marketing content, code, and/or related promotional and/or research functionality; transmitting, wherein the information described herein can be transmitted to/from the advertisement/marketing provider communication device which can be connected to and/or linked with the advertisement/marketing computer and/or the transmitted to/from the computer-implemented system; connecting, wherein the advertising/marketing computer can be connected to or linked with the other devices and/or systems via any communication network described herein.

15. The computer-implemented method of claim 1, comprising: enabling and/or processing a request to access a print publishing computer which is connected to or linked with the computer-implemented system; storing, wherein the print publishing computer can include a database which stores content and/or digital media, advertisements, images, text, commercials, links, hyperlinks, video, audio, banners, buttons, clips, URL's content and/or digital media, frames, logos, icons, surveys, questionnaires, market research tools, promotions, offers, and/or other print publishing content, code, and/or related promotional and/or functionality which is suitable for either physical printing, such as but not limited to paper printing, and/or digital printing, such as but not limited to digital billboards; transmitting, wherein the information described herein is stored in the database of the print publishing computer and can be transmitted to/from the print publishing provider communication device which can be connected to and/or linked with the print publishing computer and/or the transmitted to/from the computer-implemented system; connecting, wherein the print publishing computer can be connected to or linked with the other devices and/or systems via any communication network described herein.

16. The computer-implemented method of claim 1, comprising: processing a request to receive a real-time and/or immediate alert can also be provided to a user as a function of the computer-implemented system; processing, wherein the described alert feature can be used to process and provide information about content and/or digital media availability, and/or information concerning the commercial transaction related to content and/or digital media.

17. The computer-implemented method of claim 1, comprising: processing a request to enable either dynamically, and/or manually, assemble the content and/or digital media which the user would like to consume as a computational function of the computer-implemented system; processing, wherein the personal assemblage of content and/or digital media may be processed to contain any single or multitude of types or elements of content, digital media, advertisements, ratings, and the like, as described herein; displaying and/or processing for consumption and/or presentation, wherein the personal assemblage of content and/or digital media may be consumed in any single or multitude of communications, computing, display, and/or print elements described herein; storing, where in the information comprising the personal assemblage of content and/or digital media described herein can be stored in the database of a device associated with the user, and/or in the database of the computer-implemented system; transmitting, wherein the personal assemblage may likewise be transmitted to/from the various communication devices described herein and in conjunction with any of the communication network described herein.

18. The computer-implemented method of claim 1, comprising: processing a request to enable an advertiser, such as a vendor of any product, service, and/or good, or an agent thereof, or a third-party acting on behalf of a advertisers and vendors to purchase, in an on-line and/or in a real-time environment, to place an advertisement placement where that advertisement, and/or offering, may be inserted into the content and/or digital media pursuant to the terms identified by the parties with a commercial interest in the content and/or digital media.

19. The computer-implemented method of claim 1, comprising: processing a request to attach and/or access descriptive and/or identifying meta-data regarding the content and/or digital media which may be linked to, embedded into, and/or attached to the actual content and/or digital media asset.

20. The computer-implemented method of claim 1, comprising: processing, establishing, and/or accessing usage parameters, such as but not limited to, metering which may be used to provide the content and/or digital media transacting parties with a value measurement related to usage of content and/or digital media for the purpose of establishing rights and costs, wherein such usage parameters may be linked to, embedded into, and/or attached to the actual content and/or digital media asset, and/or an account related to the buying, selling, usage, and/or licensing transaction for the content and/or digital media.

21. The computer-implemented method of claim 1, comprising: processing a session request, and/or registration and/or session, usage, operation, subscription, creation, development, processing, fulfillment, publication, management, consumption, and/or presentation related commerce transaction to digital media commerce service.

22. The computer-implemented method of claim 1, comprising: processing the communications associated with the request to one or more of the requestor, and/or a third party media commerce entity, and further wherein the processor facilitates the search, matches a buy and sell offers, and facilitates a transaction associated with the request to receive digital media and/or digital media commerce products and/or services and/or digital media commerce.

23. The computer-implemented method of claim 1, comprising: transmitting the digital media and/or digital media commerce products and/or services or data or information regarding the digital media and/or digital media commerce products and/or services via a communications network, or a computing network to the digital media publisher and/or manager and/or intermediary in conjunction with a client-device used for communications, computing, entertainment, transaction processing, digitally displaying, printing, or for providing video, audio, text, signals, or data.

24. The computer-implemented method of claim 1, comprising: transmitting the digital media and/or digital media commerce products and/or services or data or information regarding the digital media and/or digital media commerce products and/or services via a communications network, or a computing network to the digital media publisher and/or manager and/or intermediary in one or more of an online, virtual, digital, or physical environment.

25. The computer-implemented method of claim 1, wherein the request contains at least one of an access code, an identification code, a personal identification number or code, and information obtained from a computer chip, a microprocessor, a magnetic strip, a biometric scan, an image scan, or from an account card.

26. The computer-implemented method of claim 1, further comprising: processing information for one or more of managing, controlling, monitoring, policy setting, operations management of the digital media and/or digital media commerce products and/or services or the digital media and/or digital media commerce products and/or services, sessions, session, usage, operation, subscription, creation, development, processing, fulfillment, publication, management, consumption, and/or presentation related commerce transaction or the digital media commerce services.

27. The computer-implemented method of claim 1, further comprising: processing as such executed by intelligent agents or software agents or algorithms or mobile agents or scripts or code on behalf of any of the parties to the digital media commerce services or devices utilized by any of the parties to the digital media commerce services.

28. The computer-implemented method of claim 1, further comprising: processing data or information regarding delivery, technological parameters, or the commercial parameters of the digital media and/or digital media commerce products and/or services or the digital media and/or digital media commerce products and/or services, sessions, session, usage, operation, subscription, creation, development, processing, fulfillment, publication, management, consumption, and/or presentation related commerce transaction or the digital media commerce services.

29. The computer-implemented method of claim 1, further comprising: storing one or more of digital media commerce, or content, digital content, media, digital media, data, information, digital content transaction applications, digital content transaction services, digital content computing applications, digital content computing services, digital content communications applications, digital content communications services, periodicals, files, video, audio, images, avatars, pixel content and/or digital media, clear gifs, web beacons, voice, text, signals, hyper-links, programs, applications, applets, code, scripts, alerts, signals, warnings, prompts, requests, advertisements, offers, solicitations, promotions, confirmations, tickets, receipts, content, digital content associated with or comprising digital media commerce.

30. The computer-implemented method of claim 1, further comprising: storing communications to which the digital media and/or digital media commerce products and/or services may be affixed or combined.

31. The computer-implemented method of claim 1, further comprising: storing functional commands or instructions or for control of the digital media and/or digital media commerce products and/or services or digital media and/or digital media commerce products and/or services, sessions, session, usage, operation, subscription, creation, development, processing, fulfillment, publication, management, consumption, and/or presentation related commerce transaction or digital media and/or digital media commerce products and/or services service.

32. The computer-implemented method of claim 1, further comprising: storing functional commands or instructions or data for management of the digital media and/or digital media commerce products and/or services or digital media and/or digital media commerce products and/or services, sessions, session, usage, operation, subscription, creation, development, processing, fulfillment, publication, management, consumption, and/or presentation related commerce transaction or digital media and/or digital media commerce products and/or services service.

33. The computer-implemented method of claim 1, further comprising: storing data or information regarding a device or devices associated with or used by an individual or by a set of individuals or by a machine or by a set of machines to transmit or receive digital media commerce or regarding digital media and/or digital media commerce products and/or services, sessions, session, usage, operation, subscription, creation, development, processing, fulfillment, publication, management, consumption, and/or presentation related commerce transactions or digital media and/or digital media commerce products and/or services.

34. The computer-implemented method of claim 1, further comprising: storing account information of one or more of a commercial, communications, financial, contextual, informational, historical, transactional, analytical, or technical nature of one or more of the digital media publisher and/or manager and/or intermediary, the digital media creator and/or developer, or the digital media commerce service provider, so as to facilitate the processing or fulfillment or management of the digital media and/or digital media commerce products and/or services.

35. The computer-implemented method of claim 1, wherein the session, usage, operation, subscription, creation, development, processing, fulfillment, publication, management, consumption, and/or presentation related commerce transaction is flexible allowing for augmenting session, usage, operation, subscription, creation, development, processing, fulfillment, publication, management, consumption, and/or presentation related commerce transaction parameters related to one or more of a commercial, communications, financial, contextual, informational, historical, transactional, analytical, or technical nature.

36. The computer-implemented method of claim 1, wherein the session, usage, operation, subscription, creation, development, processing, fulfillment, publication, management, consumption, and/or presentation related commerce transaction is flexible allowing for one or more of manually, dynamically, or automatically augmenting session, usage, operation, subscription, creation, development, processing, fulfillment, publication, management, consumption, and/or presentation related commerce transaction parameters related to one or more of a commercial, communications, financial, contextual, informational, historical, transactional, analytical, or technical nature.

37. The computer-implemented method of claim 1, wherein the session, usage, operation, subscription, creation, development, processing, fulfillment, publication, management, consumption, and/or presentation related commerce transaction is for one or more of a specified number of digital media commerce or for a specified time period or for a specified value or for a specified event or for a specified activity or for a specified transaction, and further wherein one or more of the digital media commerce can be skipped or foregone in or during the specified time period while allowing a subscriber to be able to maintain or control the quantity or frequency or terms of the remaining digital media commerce.

38. The computer-implemented method of claim 1, wherein the request for a session, usage, operation, subscription, creation, development, processing, fulfillment, publication, management, consumption, and/or presentation related commerce transaction contains one or more of an access code, a password, a personal identification number, personally identifying code, a personally identifying metric, a biometric, an account identifying code, an account identifying metric, code, an Internet Protocol address, a device identifying code, a device identifying metric, email address, uniform resource locator, telephone number, mobile telephone number, vector, coordinates, digital contact address, digital contact information, digital place of receipt, unique identifying information, avatar identification, representative identification, third-party identification related to session, usage, operation, subscription, creation, development, processing, fulfillment, publication, management, consumption, and/or presentation related commerce transaction, third-party identification related to subscriber, agent identification, postal contact, and information obtained from a magnetic strip of an account card or from a microprocessor of an account card or from a subscriber identity module card or an electronic account previously associated with the subscriber.

39. The computer-implemented method of claim 1, further comprising: processing search related information regarding one or more of desired or suitable digital media and/or digital media commerce products and/or services, digital media and/or digital media commerce products and/or services, digital media and/or digital media commerce products and/or services associated services and/or goods, and/or one or more of offers of a commercial, communications, financial, contextual, informational, historical, transactional, analytical, or technical nature.

40. The computer-implemented method of claim 1, further comprising: processing the pairing of offers and requests or requests for digital media commerce, or digital media and/or digital media commerce products and/or services as a result of a search as made by any of the prospective parties to the digital media commerce services, wherein the pairing may be one or more of automated or specifically requested in conjunction with the search activity.

41. The computer-implemented method of claim 1, further comprising: processing bidding information for parties to the digital media commerce, or digital media and/or digital media commerce products and/or services, or affiliated services, allowing for making provisional offers based upon parameters set by an offering party which can be accepted, or to which a counter offers may be made, and if parties should reach an agreement; processing a transaction based upon a completed agreement resulting from the bidding process.

42. The computer-implemented method of claim 1, further comprising: processing payment information for settlement of one or more of accepted offers for transacting digital media commerce, digital media and/or digital media commerce products and/or services, or digital media and/or digital media commerce products and/or services affiliated services and/or goods.

43. The computer-implemented method of claim 1, further comprising: determining that the session, and/or the session, usage, operation, subscription, creation, development, processing, fulfillment, publication, management, consumption, and/or presentation related commerce transaction, and/or the registration is not active; and processing information for re-opening or renewing the session, usage, operation, subscription, creation, development, processing, fulfillment, publication, management, consumption, and/or presentation related commerce transaction.

44. The computer-implemented method of claim 1, further comprising: generating a notification in response to the session, and/or the session, usage, operation, subscription, creation, development, processing, fulfillment, publication, management, consumption, and/or presentation related commerce transaction, and/or the registration request of one or more of a registration notification, a rejection notification, a query for additional information, and/or information regarding the availability of one or more of digital media commerce, digital media and/or digital media commerce products and/or services, or digital media and/or digital media commerce products and/or services affiliated services and/or goods.

45. The computer-implemented method of claim 1, further comprising: generating a notification in response to a processing action.

46. The computer-implemented method of claim 1, further comprising a: processing one or more of a request to register, subscribe, communicate, combine and/or attach digital media and/or digital media commerce products and/or services to a communication, search, pair bids and acceptances, purchase, sell, offer to purchase, offer to sell; processor for processing one or more of a transaction or communication; transmitting a notification of one or more of the processing action, processing activity, communication, or transaction.

47. The computer-implemented method of claim 1, wherein the processor whether the party accessing the processor is authorized, authenticated, whether to accept, reject, further qualify, and/or to facilitate digital media commerce related service.

48. The computer-implemented method of claim 1, further comprising: generating a second communication, wherein the metadata related to the session, usage, user, subscription, product, service, and/or service provider contains information regarding at least one of an availability of a session, usage, operation, subscription, creation, development, processing, fulfillment, publication, management, consumption, and/or presentation related commerce transaction, digital media and/or digital media commerce products and/or services, a promotion regarding digital media and/or digital media commerce products and/or services, or digital media commerce service; and transmitting the metadata related to the session, usage, user, subscription, product, service, and/or service provider to a communications device or computer enabled and/or network enabled device associated with or utilize by the subscriber, wherein if the metadata related to the session, usage, user, subscription, product, service, and/or service provider is transmitted to the communication device or computer enabled and/or network enabled device utilized in conjunction with one or more of the Internet, the World Wide Web, a wireless communication network, or a terrestrial communication network.

49. The computer-implemented method of claim 1, further comprising: receiving a second request to receive, transact, communicate, or execute one or more of digital media and/or digital media commerce products and/or services, digital media commerce service, digital media commerce management or control function, or an of digital media commerce associated service and/or good; and processing information regarding the second request; determining whether the second session, usage, operation, subscription, creation, development, processing, fulfillment, publication, management, consumption, and/or presentation related commerce transaction is active or not active or determining whether any digital media commerce related services or goods remain to be fulfilled pursuant to the second request; and transmitting a second communication in response to the second request, wherein the metadata related to the session, usage, user, subscription, product, service, and/or service provider contains information regarding any one or more of an authorization, authentication, denial, of the second request, and further wherein the metadata related to the session, usage, user, subscription, product, service, and/or service provider is transmitted to a communication device and/or an internet access device and/or computer enabled and/or network enabled device being utilized by the subscriber or party to the digital media commerce services.

50. The computer-implemented method of claim 1, further comprising: receiving a second request to receive digital media and/or digital media commerce products and/or services related good and/or service, or tickets, or coupon, or postage, or commercial item, pursuant to the digital media and/or digital media commerce products and/or services, sessions, session, usage, operation, subscription, creation, development, processing, fulfillment, publication, management, consumption, and/or presentation related commerce transaction; and processing information regarding the second request; determining whether the second session, usage, operation, subscription, creation, development, processing, fulfillment, publication, management, consumption, and/or presentation related commerce transaction is active or not active or determining whether any digital media commerce related services or goods remain to be fulfilled pursuant to the second request; and transmitting a second communication in response to the second request, wherein the metadata related to the session, usage, user, subscription, product, service, and/or service provider contains information regarding any one or more of an authorization, authentication, denial, of the second request, and further wherein the metadata related to the session, usage, user, subscription, product, service, and/or service provider is transmitted to a communication device and/or an internet access device and/or computer enabled and/or network enabled device being utilized by the subscriber or party to the digital media commerce services.

51. The computer-implemented method of claim 50, wherein the second request is a request for one or more of a ticket or tickets to an entertainment event, entertainment venue, sporting event, commercial event, commercial venue, educational event, education venue, or multiple events or venues.

52. The computer-implemented method of claim 50, further comprising: processing information regarding a changing of the parameters for one or more of the transmission or consumption and/or presentation of the digital media and/or digital media commerce products and/or services, digital media commerce services, or digital media commerce associated services and/or goods.

53. The computer-implemented method, comprising: processing a request to create or initiate a session, usage, operation, subscription, creation, development, processing, fulfillment, publication, management, consumption, and/or presentation related commerce transaction which allows for one or more of digital media commerce, digital media commerce services, digital media commerce associated services and/or goods, to be received at a communications device or computer enabled and/or network enabled device associated with a subscriber, wherein the request is transmitted from one or more of a communications device, a transaction device, or from an internet access device and/or computer enabled and/or network enabled device associated with or being used by the subscriber, or a provider of services and/or goods to the subscriber, wherein the request contains information regarding digital media commerce related service, wherein one or more of the digital media commerce, digital media commerce services, or digital media commerce associated services and/or goods can be skipped or foregone in or during the specified time period while ensuring that a subscriber is able to continue with the session, usage, operation, subscription, creation, development, processing, fulfillment, publication, management, consumption, and/or presentation related commerce transaction or receive all of the specified number of digital media commerce, or related digital media and/or digital media commerce products and/or services, or digital media and/or digital media commerce products and/or services associated services and/or goods at the initially intended or alternative communications device, transaction device, or computer enabled and/or network enabled device, wherein the request is processed by a processing device; creating or initiating a session, usage, operation, subscription, creation, development, processing, fulfillment, publication, management, consumption, and/or presentation related commerce transaction in response to the request; and transmitting a notification to the communications device, or the transaction device, or the computer enabled and/or network enabled device associated with or being used by the subscriber, or a provider of services and/or goods to the subscriber, wherein the media and/or digital media commerce products and/or services contains information regarding the session, usage, operation, subscription, creation, development, processing, fulfillment, publication, management, consumption, and/or presentation related commerce transaction which was created or initiated.

54. The computer-implemented method of claim 53, wherein at least one of the request and the digital media and/or digital media commerce products and/or services, or digital media and/or digital media commerce products and/or services, or digital media and/or digital media commerce products and/or services associate services and/or goods is transmitted to the communication device or computer enabled and/or network enabled device utilized in conjunction with one or more of the Internet, the World Wide Web, a wireless communication network, or a terrestrial communication network.

55. The computer-implemented method of claim 53, further comprising: processing information for one or more of renewing, extending, cancelling, or termination the session, usage, operation, subscription, creation, development, processing, fulfillment, publication, management, consumption, and/or presentation related commerce transaction.

56. The computer-implemented method of claim 53, further comprising: processing information for one or more of a search for the session, usage, operation, subscription, creation, development, processing, fulfillment, publication, management, consumption, and/or presentation related commerce transaction, digital media and/or digital media commerce products and/or services, digital media and/or digital media commerce products and/or services service, digital media and/or digital media commerce products and/or services associated service and/or good.

57. The computer-implemented method of claim 53, further comprising: generating a second communication in response to the request to initiate or create a session, usage, operation, subscription, creation, development, processing, fulfillment, publication, management, consumption, and/or presentation related commerce transaction for one or more of digital media and/or digital media commerce products and/or services, digital media and/or digital media commerce products and/or services service, digital media and/or digital media commerce products and/or services associated service and/or good; and transmitting the metadata related to the session, usage, user, subscription, product, service, and/or service provider to one or more of a communication device, transaction device, or computer enabled and/or network enabled device associated with or used by or in service of the subscriber.

58. The computer-implemented method of claim 57, wherein the request, the metadata related to the session, usage, user, subscription, product, service, and/or service provider, and/or the digital media and/or digital media commerce products and/or services is transmitted on or over the Internet, World Wide Web, Semantic Web, telecommunication networks, computing networks, terrestrial networks, undersea networks, mobile networks, satellite networks, radio networks, digital communication networks, broadband communication networks, internets and/or intranets, mesh networks, closed circuit networks, open networks, optical networks, neural networks, and/or similarly employable communications and/or computer networks.

59. A computer-implemented method comprising: inputting or entering information regarding a request to receive a session, usage, operation, subscription, creation, development, processing, fulfillment, publication, management, consumption, and/or presentation related commerce transaction for one or more of digital media and/or digital media commerce products and/or services, digital media and/or digital media commerce products and/or services service, digital media and/or digital media commerce products and/or services associated service and/or good; transmitting the information regarding the request; receiving the request, wherein the processing device receives the request; processing the request to receive one or more of digital media commerce, digital media commerce services, digital media commerce associated services and/or goods; wherein the processor determines whether the request is one or more of affiliated with a session, usage, operation, subscription, creation, development, processing, fulfillment, publication, management, consumption, and/or presentation related commerce transaction, whether the session, usage, operation, subscription, creation, development, processing, fulfillment, publication, management, consumption, and/or presentation related commerce transaction is active, whether the requestor is authorized, whether the requestor is authenticated, or whether there remain any unfulfilled digital media commerce, digital media and/or digital media commerce products and/or services related services, or digital media and/or digital media commerce products and/or services associated services and/or goods to be transmitted; transmitting a notification to a communications device or computer enabled and/or network enabled device associated with or being utilized by or in the service of the subscriber, wherein the notification can be one or more of an approval, authorization, denial, offer for renewal; providing and/or displaying the transmitted notification.

60. A computer-implemented method comprising: receiving a request to one or more of initiate a session, usage, operation, subscription, creation, development, processing, fulfillment, publication, management, consumption, and/or presentation related commerce transaction, or receive one or more of digital media and/or digital media commerce products and/or services, digital media and/or digital media commerce products and/or services service, digital media and/or digital media commerce products and/or services associated service and/or good; transmitting the information regarding the request; receiving the request, wherein the processing device receives the request; processing the request to receive one or more of digital media commerce, digital media commerce services, digital media commerce associated services and/or goods; wherein the processor determines whether the request is one or more of affiliated with a session, usage, operation, subscription, creation, development, processing, fulfillment, publication, management, consumption, and/or presentation related commerce transaction, whether the session, usage, operation, subscription, creation, development, processing, fulfillment, publication, management, consumption, and/or presentation related commerce transaction is active, whether the requestor is authorized, whether the requestor is authenticated, or whether there remain any unfulfilled digital media commerce, digital media and/or digital media commerce products and/or services related services, or digital media and/or digital media commerce products and/or services associated services and/or goods to be transmitted; transmitting a second communication, wherein the metadata related to the session, usage, user, subscription, product, service, and/or service provider may contain or be connected to digital media and/or digital media commerce products and/or services, digital media and/or digital media commerce products and/or services service, or digital media and/or digital media commerce products and/or services associated service and/or good; providing and/or displaying one or more of the transmitted notification or the second media and/or digital media commerce products and/or services.

61. A computer-implemented method comprising: processing a request to establish or create a session, usage, operation, subscription, creation, development, processing, fulfillment, publication, management, consumption, and/or presentation related commerce transaction for receiving one or more of digital media commerce, digital media commerce services, digital media commerce associated services and/or goods; wherein the processor determines whether the request is compliant; establishing or creating a session, usage, operation, subscription, creation, development, processing, fulfillment, publication, management, consumption, and/or presentation related commerce transaction; transmitting a second communication, wherein the metadata related to the session, usage, user, subscription, product, service, and/or service provider may contain or be connected to digital media and/or digital media commerce products and/or services, digital media and/or digital media commerce products and/or services service, or digital media and/or digital media commerce products and/or services associated service and/or good, wherein the metadata related to the session, usage, user, subscription, product, service, and/or service provider is transmitted to and received by one or more of a communications device, a transaction device, or an internet access device and/or computer enabled and/or network enabled device associated with or being used by or in the service of the subscriber or a provider of services and/or goods to a subscriber; providing and/or displaying one or more of the transmitted notification or the second media and/or digital media commerce products and/or services.

62. A computer-implemented method comprising: processing a request to one or more of establish a session, usage, operation, subscription, creation, development, processing, fulfillment, publication, management, consumption, and/or presentation related commerce transaction, or receive one or more of digital media commerce, digital media commerce services, digital media commerce associated services and/or goods; wherein the processor determines whether the request is one or more of affiliated with a session, usage, operation, subscription, creation, development, processing, fulfillment, publication, management, consumption, and/or presentation related commerce transaction, whether the session, usage, operation, subscription, creation, development, processing, fulfillment, publication, management, consumption, and/or presentation related commerce transaction is active, whether the requestor is authorized, whether the requestor is authenticated, or whether there remain any unfulfilled digital media commerce, digital media and/or digital media commerce products and/or services related services, or digital media and/or digital media commerce products and/or services associated services and/or goods to be transmitted; transmitting a second communication, wherein the metadata related to the session, usage, user, subscription, product, service, and/or service provider may contain or be connected to digital media and/or digital media commerce products and/or services, digital media and/or digital media commerce products and/or services service, or digital media and/or digital media commerce products and/or services associated service and/or good, wherein the metadata related to the session, usage, user, subscription, product, service, and/or service provider is transmitted to and received by one or more of a communications device, a transaction device, or an internet access device and/or computer enabled and/or network enabled device associated with or being used by or in the service of the subscriber or a provider of services and/or goods to a subscriber; providing and/or displaying one or more of the transmitted notification or the second media and/or digital media commerce products and/or services.

63. A computer-implemented apparatus, comprising: a receiver, wherein the receiver receives a request to receive, at a device or devices associated with or used by an individual, a set of individuals, a machine, a set of machines, digital media and/or digital media commerce products and/or services consisting of any one or more of content, digital content, media, digital media, data, information, digital content transaction applications, digital content transaction services, digital content computing applications, digital content computing services, digital content communications applications, digital content communications services, periodicals, files, video, audio, images, avatars, pixel content and/or digital media, clear gifs, web beacons, voice, text, signals, hyper-links, programs, applications, applets, code, scripts, alerts, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, media and/or digital media commerce products and/or services, notifications, controls, communications, or an embodiment of information, or an embodiment of control functionality; a processor, wherein the processor processes information regarding the request with a processor, wherein the processing device, wherein the a processor, wherein the processing device determines whether the session, usage, operation, subscription, creation, development, processing, fulfillment, publication, management, consumption, and/or presentation related commerce transaction is active or not active or determines whether any digital media and/or digital media commerce products and/or services or digital media commerce of the one or more of the content, digital content, media, digital media, data, information, digital content transaction applications, digital content transaction services, digital content computing applications, digital content computing services, digital content communications applications, digital content communications services, periodicals, files, video, audio, images, avatars, pixel content and/or digital media, clear gifs, web beacons, voice, text, signals, hyper-links, programs, applications, applets, code, scripts, alerts, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, media and/or digital media commerce products and/or services, notifications, controls, communications, or an embodiment of information, or an embodiment of control functionality remain to be fulfilled pursuant to the session, usage, operation, subscription, creation, development, processing, fulfillment, publication, management, consumption, and/or presentation related commerce transaction; and a transmitter, wherein the transmitter transmits in response to the request, and in conjunction with a second communication, one or more of content, digital content, media, digital media, data, information, digital content transaction applications, digital content transaction services, digital content computing applications, digital content computing services, digital content communications applications, digital content communications services, periodicals, files, video, audio, images, avatars, pixel content and/or digital media, clear gifs, web beacons, voice, text, signals, hyper-links, programs, applications, applets, code, scripts, alerts, signals, warnings, prompts, requests, restrictions, limitations, monitoring functions, management operations, advertisements, offers, solicitations, promotions, confirmations, tickets, receipts, content, digital content, activations, authorizations, authentications, rules, policies, practices, aggregated information, implementations, dissolutions, disallowances, touches, tastes, smells, movements, actions, reactions, media and/or digital media commerce products and/or services, notifications, controls, communications, or an embodiment of information, or an embodiment of control functionality.

64. The computer-implemented apparatus, comprising: a processor, wherein the processor processes a request to create or initiate a session, usage, operation, subscription, creation, development, processing, fulfillment, publication, management, consumption, and/or presentation related commerce transaction which allows for one or more of digital media commerce, digital media commerce services, digital media commerce associated services and/or goods, to be received at a communications device or computer enabled and/or network enabled device associated with a subscriber, wherein the request is transmitted from one or more of a communications device, a transaction device, or from an internet access device and/or computer enabled and/or network enabled device associated with or being used by the subscriber, or a provider of services and/or goods to the subscriber, wherein the request contains information regarding digital media commerce related service, wherein one or more of the digital media commerce, digital media commerce services, or digital media commerce associated services and/or goods can be skipped or foregone in or during the specified time period while ensuring that a subscriber is able to continue with the session, usage, operation, subscription, creation, development, processing, fulfillment, publication, management, consumption, and/or presentation related commerce transaction or receive all of the specified number of digital media commerce, or related digital media and/or digital media commerce products and/or services, or digital media and/or digital media commerce products and/or services associated services and/or goods at the initially intended or alternative communications device, transaction device, or computer enabled and/or network enabled device, wherein the request is processed by a a processor, wherein the processor processes device; creating or initiating a session, usage, operation, subscription, creation, development, processing, fulfillment, publication, management, consumption, and/or presentation related commerce transaction in response to the request; and a transmitter, wherein the transmitter transmits a notification to the communications device, or the transaction device, or the computer enabled and/or network enabled device associated with or being used by the subscriber, or a provider of services and/or goods to the subscriber, wherein the media and/or digital media commerce products and/or services contains information regarding the session, usage, operation, subscription, creation, development, processing, fulfillment, publication, management, consumption, and/or presentation related commerce transaction which was created or initiated.

65. A computer-implemented apparatus comprising: inputting or entering information regarding a request to receive a session, usage, operation, subscription, creation, development, processing, fulfillment, publication, management, consumption, and/or presentation related commerce transaction for one or more of digital media and/or digital media commerce products and/or services, digital media and/or digital media commerce products and/or services service, digital media and/or digital media commerce products and/or services associated service and/or good; a transmitter, wherein the transmitter transmits the information regarding the request; a receiver, wherein the receiver receives the request, wherein the a processor, wherein the processing device receives the request; a processor, wherein the processor processes the request to receive one or more of digital media commerce, digital media commerce services, digital media commerce associated services and/or goods; wherein the processor determines whether the request is one or more of affiliated with a session, usage, operation, subscription, creation, development, processing, fulfillment, publication, management, consumption, and/or presentation related commerce transaction, whether the session, usage, operation, subscription, creation, development, processing, fulfillment, publication, management, consumption, and/or presentation related commerce transaction is active, whether the requestor is authorized, whether the requestor is authenticated, or whether there remain any unfulfilled digital media commerce, digital media and/or digital media commerce products and/or services related services, or digital media and/or digital media commerce products and/or services associated services and/or goods to be transmitted; a transmitter, wherein the transmitter transmits a notification to a communications device or computer enabled and/or network enabled device associated with or being utilized by or in the service of the subscriber, wherein the notification can be one or more of an approval, authorization, denial, offer for renewal; providing and/or displaying the transmitted notification.

66. A computer-implemented apparatus comprising: a receiver, wherein the receiver receives a request to one or more of initiate a session, usage, operation, subscription, creation, development, processing, fulfillment, publication, management, consumption, and/or presentation related commerce transaction, or receive one or more of digital media and/or digital media commerce products and/or services, digital media and/or digital media commerce products and/or services service, digital media and/or digital media commerce products and/or services associated service and/or good; a transmitter, wherein the transmitter transmits the information regarding the request; a receiver, wherein the receiver receives the request, wherein the a processor, wherein the processing device receives the request; a processor, wherein the processor processes the request to receive one or more of digital media commerce, digital media commerce services, digital media commerce associated services and/or goods; wherein the processor determines whether the request is one or more of affiliated with a session, usage, operation, subscription, creation, development, processing, fulfillment, publication, management, consumption, and/or presentation related commerce transaction, whether the session, usage, operation, subscription, creation, development, processing, fulfillment, publication, management, consumption, and/or presentation related commerce transaction is active, whether the requestor is authorized, whether the requestor is authenticated, or whether there remain any unfulfilled digital media commerce, digital media and/or digital media commerce products and/or services related services, or digital media and/or digital media commerce products and/or services associated services and/or goods to be transmitted; a transmitter, wherein the transmitter transmits a second communication, wherein the metadata related to the session, usage, user, subscription, product, service, and/or service provider may contain or be connected to digital media and/or digital media commerce products and/or services, digital media and/or digital media commerce products and/or services service, or digital media and/or digital media commerce products and/or services associated service and/or good; providing and/or displaying one or more of the transmitted notification or the second media and/or digital media commerce products and/or services.

67. A computer-implemented apparatus comprising: a processor, wherein the processor processes a request to establish or create a session, usage, operation, subscription, creation, development, processing, fulfillment, publication, management, consumption, and/or presentation related commerce transaction for a receiver, wherein the receiver receives one or more of digital media commerce, digital media commerce services, digital media commerce associated services and/or goods; wherein the processor determines whether the request is compliant; establishing or creating a session, usage, operation, subscription, creation, development, processing, fulfillment, publication, management, consumption, and/or presentation related commerce transaction; a transmitter, wherein the transmitter transmits a second communication, wherein the metadata related to the session, usage, user, subscription, product, service, and/or service provider may contain or be connected to digital media and/or digital media commerce products and/or services, digital media and/or digital media commerce products and/or services service, or digital media and/or digital media commerce products and/or services associated service and/or good, wherein the metadata related to the session, usage, user, subscription, product, service, and/or service provider is transmitted to and received by one or more of a communications device, a transaction device, or an internet access device and/or computer enabled and/or network enabled device associated with or being used by or in the service of the subscriber or a provider of services and/or goods to a subscriber; providing and/or displaying one or more of the transmitted notification or the second media and/or digital media commerce products and/or services.

68. A computer-implemented apparatus comprising: a processor, wherein the processor processes a request to one or more of establish a session, usage, operation, subscription, creation, development, processing, fulfillment, publication, management, consumption, and/or presentation related commerce transaction, or receive one or more of digital media commerce, digital media commerce services, digital media commerce associated services and/or goods; wherein the processor determines whether the request is one or more of affiliated with a session, usage, operation, subscription, creation, development, processing, fulfillment, publication, management, consumption, and/or presentation related commerce transaction, whether the session, usage, operation, subscription, creation, development, processing, fulfillment, publication, management, consumption, and/or presentation related commerce transaction is active, whether the requestor is authorized, whether the requestor is authenticated, or whether there remain any unfulfilled digital media commerce, digital media and/or digital media commerce products and/or services related services, or digital media and/or digital media commerce products and/or services associated services and/or goods to be transmitted; a transmitter, wherein the transmitter transmits a second communication, wherein the metadata related to the session, usage, user, subscription, product, service, and/or service provider may contain or be connected to digital media and/or digital media commerce products and/or services, digital media and/or digital media commerce products and/or services service, or digital media and/or digital media commerce products and/or services associated service and/or good, wherein the metadata related to the session, usage, user, subscription, product, service, and/or service provider is transmitted to and received by one or more of a communications device, a transaction device, or an internet access device and/or computer enabled and/or network enabled device associated with or being used by or in the service of the subscriber or a provider of services and/or goods to a subscriber; providing and/or displaying one or more of the transmitted notification or the second media and/or digital media commerce products and/or services.
